(19) United States
(12) Patent Application Publication
(10) Pub. No.: US 2024/0155608 A1
(43) Pub. Date: May 9, 2024

(54) METHOD AND APPARATUS FOR INFORMATION TRANSMISSION AND RECEPTION IN SATELLITE COMMUNICATIONS SYSTEM

(71) Applicant: SAMSUNG ELECTRONICS CO., LTD., Suwon-si (KR)

(72) Inventors: Sungjin PARK, Suwon-si (KR); Youngbum KIM, Suwon-si (KR); Younsun KIM, Suwon-si (KR); Hyunseok RYU, Suwon-si (KR); Junyung YI, Suwon-si (KR)

(21) Appl. No.: 18/476,187

(22) Filed: Sep. 27, 2023

(30) Foreign Application Priority Data
Sep. 29, 2022 (KR) 10-2022-0124377
Nov. 30, 2022 (KR) 10-2022-0164189

(51) Int. Cl. H04W 72/1273; H04L 1/1812; H04W 72/232

(52) U.S. Cl. CPC H04W 72/1273; H04L 1/1812; H04W 72/232

(57) ABSTRACT

The disclosure relates to a 5G or 6G communication system for supporting a higher data transmission rate. A method performed by a terminal in a wireless communication system is provided. The method includes receiving, from a base station, configuration information on a set of one or more numbers for a PUCCH repetition; receiving, from the base station, DCI scheduling a PDSCH; receiving, from the base station, the PDSCH based on the DCI; determining a plurality of slots for the PUCCH repetition based on the configuration information in case that the set of one or more numbers comprises a single value or based on the configuration information and the DCI in case that the set of one or more numbers comprises more than one value; and transmitting, to the base station, a PUCCH including HARQ-ACK information for the PDSCH over the determined plurality of slots.

### CROSS-REFERENCE TO RELATED APPLICATIONS

This application is based on and claims priority under 35 U.S.C. § 119 to Korean Patent Application No. 10-2022-0124377 filed on Sep. 29, 2022, and Korean Patent Application No. 10-2022-0164189 filed on Nov. 30, 2022, in the Korean Intellectual Property Office, the disclosure of which is herein incorporated by reference in its entirety.

### BACKGROUND

### 1. Field

This disclosure relates to communication systems, and particularly to methods for transmitting and receiving control information in a satellite communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to optimize non-public networks.

On the other hand, as satellite launch costs have decreased dramatically in the late 2010s and 2020s, the number of operators seeking to provide communication services through satellites is increasing. Accordingly, satellite networks are emerging as a next-generation network system that complements existing terrestrial networks. Satellite networks cannot yet provide a user experience comparable to that of terrestrial networks, but their advantage is that they may provide communication services in areas where it is difficult to establish a terrestrial network or in disaster situation, and as explained earlier, economic feasibility has been secured due to the recent rapid decrease in satellite launch costs. Additionally, several companies and 3GPP standards organizations are also promoting direct communication between smartphones and satellites.

The above information is presented as background information only to assist with an understanding of the disclosure. No determination has been made, and no assertion is made, as to whether any of the above might be applicable as prior art with regard to the disclosure.

### SUMMARY

The disclosure intends to provide an apparatus and method that may effectively provide services in a wireless communication system such as a satellite communication system.

In an embodiment, a method performed by a terminal in a wireless communication system is provided. The method includes receiving, from a base station, configuration information on a set of one or more numbers for a physical uplink control channel (PUCCH) repetition; receiving, from the base station, downlink control information (DCI) scheduling a physical downlink shared channel (PDSCH); receiving, from the base station, the PDSCH based on the DCI; determining a plurality of slots for the PUCCH repetition based on the configuration information in case that the set of one or more numbers comprises a single value or based on the configuration information and the DCI in case that the set of one or more numbers comprises more than one value; and transmitting, to the base station, a PUCCH including hybrid automatic repeat request-acknowledgement (HARQ-ACK) information for the PDSCH over the determined plurality of slots.

In an embodiment, a method performed by a base station in a wireless communication system is provided. The method includes transmitting configuration information on a set of one or more numbers for a PUCCH repetition; transmitting, to a terminal, DCI scheduling a PDSCH; transmitting, to the terminal, the PDSCH according to the DCI; and receiving, from the terminal, a PUCCH including HARQ-ACK information for the PDSCH over a plurality of slots for the PUCCH repetition according to the configuration information in case that the set of one or more numbers comprises a single value or according to the configuration information and the DCI in case that the set of one or more numbers comprises more than one value.

In an embodiment, a terminal in a wireless communication system is provided. The terminal includes a transceiver and a controller, The controller is configured to receive, from a base station via the transceiver, configuration information on a set of one or more numbers for a PUCCH repetition, receive, from the base station via the transceiver, DCI scheduling a PDSCH, receive, from the base station via the transceiver, the PDSCH based on the DCI, determine a plurality of slots for the PUCCH repetition based on the configuration information in case that the set of one or more numbers comprises a single value or based on the configuration information and the DCI in case that the set of one or more numbers comprises more than one value, and transmit, to the base station via the transceiver, a PUCCH including HARQ-ACK information for the PDSCH over the determined plurality of slots.

In an embodiment, a base station in a wireless communication system is provided. The base station includes a transceiver and a controller. The controller is configured to transmit, via the transceiver, configuration information on a set of one or more numbers for a PUCCH repetition, transmit, to a terminal via the transceiver, DCI scheduling a PDSCH, transmit, to the terminal via the transceiver, the PDSCH according to the DCI, and receive, from the terminal via the transceiver, a PUCCH including HARQ-ACK information for the PDSCH over a plurality of slots for the PUCCH repetition according to the configuration information in case that the set of one or more numbers comprises a single value or according to the configuration information and the DCI in case that the set of one or more numbers comprises more than one value.

According to an embodiment of the disclosure, a service may be effectively provided in a wireless communication system such as a satellite communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the basic structure of a time-frequency domain, which is a radio resource area in which the data or control channel is transmitted in the downlink or uplink in an NR system according to an embodiment of the present disclosure;

FIG. 2 illustrates synchronization signals (SS) and physical broadcasting channels (PBCH) of the NR system mapped in the frequency and time domain according to an embodiment of the present disclosure;

FIG. 3 illustrates symbols through which SS/PBCH blocks may be transmitted according to subcarrier spacing according to an embodiment of the present disclosure;

FIG. 4 illustrates an example of a control resource set (CORESET) in which a downlink control channel is transmitted in a 5G wireless communication system according to an embodiment of the present disclosure;

FIG. 5 illustrates an example of a message transmitted from the MAC layer to the physical layer in the downlink in a communication system according to an embodiment of the present disclosure;

FIG. 6 illustrates an example of a message transmitted from the MAC layer to the physical layer in the uplink in a communication system according to an embodiment of the present disclosure;

FIG. 7 illustrates an example of a process in which one transport block (TB) is divided into several code blocks (CB) and a CRC is added according to an embodiment of the present disclosure;

FIG. 8 illustrates the processing time of a terminal according to timing advance when the terminal receives a first signal and transmits a second signal in response to the first signal in a 5G or NR system according to an embodiment of the present disclosure;

FIG. 9 illustrates an example of scheduling and transmitting data (e.g., TB) according to a slot, receiving HARQ-ACK feedback for the data, and performing retransmission according to the feedback, according to an embodiment of the present disclosure;

FIG. 10 illustrates an example of a communication system using a satellite according to an embodiment of the present disclosure;

FIG. 11 illustrates the Earth orbital period of a communication satellite according to the altitude or height of the satellite according to an embodiment of the present disclosure;

FIG. 12 illustrates satellite-to-terminal direct communication according to an embodiment of the present disclosure;

FIG. 13 illustrates a utilization scenario of satellite-to-terminal direct communication according to an embodiment of the present disclosure;

FIG. 14 illustrates an example of calculating an expected data throughput in the uplink when a LEO satellite at an altitude of 1200 km and a terminal on the ground perform direct communication according to an embodiment of the present disclosure;

FIG. 15 illustrates an example of calculating an expected data throughput in the uplink when a GEO satellite at an altitude of 35,786 km and a terminal on the ground perform direct communication according to an embodiment of the present disclosure;

FIG. 16 illustrates path loss values according to a path loss model between a terminal and a satellite, and path loss according to a path loss model between a terminal and a terrestrial network communication base station according to an embodiment of the present disclosure;

FIG. 17 illustrates the altitude and location of a satellite, and a formula and result for calculating the amount of Doppler shift experienced by a signal transmitted from a satellite depending on the location of the terminal user on the ground when the signal is received by the ground user, according to an embodiment of the present disclosure;

FIG. 18 illustrates the speed of a satellite calculated from the altitude of the satellite according to an embodiment of the present disclosure;

FIG. 19 illustrates the Doppler shift experienced by different terminals within one beam transmitted from a satellite to the ground according to an embodiment of the present disclosure;

FIG. 20 illustrates the difference in Doppler shift occurring within one beam depending on the location of a satellite determined from the altitude angle according to an embodiment of the present disclosure;

FIG. 21 illustrates the delay time from a terminal to a satellite and the round-trip delay time between the terminal-satellite-base station according to the location of the satellite determined according to the altitude angle according to an embodiment of the present disclosure;

FIG. 22 illustrates the maximum difference value of the round-trip delay time that varies depending on the user's location within one beam according to an embodiment of the present disclosure;

FIG. 23 illustrates an example of the information structure of RAR according to an embodiment of the present disclosure;

FIG. 24 illustrates an example of the relationship between PRACH preamble configuration resources and RAR reception time in an LTE system according to an embodiment of the present disclosure;

FIG. 25 illustrates an example of the relationship between PRACH preamble configuration resources and RAR reception time in a 5G NR system according to an embodiment of the present disclosure;

FIG. 26 illustrates an example of the timing of a downlink frame and an uplink frame of a terminal according to an embodiment of the present disclosure;

FIG. 27 illustrates an example of continuous movement of a satellite in a terminal located on or on the ground of the Earth as the satellite orbits around the Earth in a satellite orbit according to an embodiment of the present disclosure;

FIG. 28 illustrates an example of the structure of an artificial satellite according to an embodiment of the present disclosure;

FIG. 29 illustrates an example of a process in which a terminal determines an N_{TA} from initial access according to an embodiment of the present disclosure;

FIG. 30 illustrates an example of a process in which a terminal determines N_{TA}, N_{TA,UE-specific}, and N_{TA,common} from initial access, according to an embodiment of the present disclosure;

FIG. 31 illustrates another example of an operation process of a terminal in a communication system according to an embodiment of the present disclosure;

FIG. 32 illustrates another example of the operation process of a terminal in a communication system according to an embodiment of the present disclosure;

FIG. 33 illustrates an example of a base station operation for reporting the TA value of a terminal according to an embodiment of the present disclosure;

FIG. 34 illustrates an example of a terminal operation for reporting the TA value of a terminal according to an embodiment of the present disclosure;

FIG. 35 illustrates an example of the difference in propagation delay time between a terrestrial network and a satellite network according to an embodiment of the present disclosure;

FIG. 36 illustrates a flowchart for a terminal to access a satellite network according to an embodiment of the present disclosure;

FIG. 37 illustrates an initial access process according to an embodiment of the present disclosure;

FIG. 38 illustrates a flowchart illustrating an operation in which a terminal performs repeated PUCCH transmission including HARQ-ACK information for message 4 PDSCH according to an embodiment of the present disclosure;

FIG. 39 illustrates the internal structure of a terminal according to an embodiment of the present disclosure;

FIG. 40 illustrates the internal structure of a satellite according to an embodiment of the present disclosure;

FIG. 41 illustrates the internal structure of a base station according to an embodiment of the present disclosure; and

FIG. 42 illustrates various frequency hopping methods according to an embodiment of the present disclosure.

### DETAILED DESCRIPTION

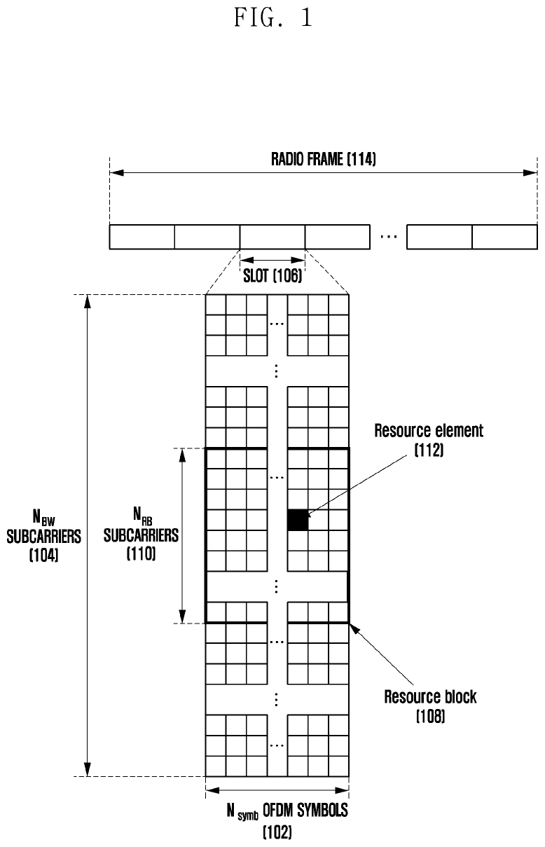

FIGS. 1 through 42, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

New radio (NR) access technology, which is a new 5G communication technology, is being designed to allow various services to be freely multiplexed in time and frequency resources, and accordingly, waveform/numerology, etc. and reference signals may be dynamically or freely allocated depending on the needs of the service. In order to provide optimal services to terminals in wireless communication, optimized data transmission through measurement of channel quality and interference amount is important, and accordingly, accurate measurement of channel status is essential. However, unlike 4G communications, where channel and interference characteristics do not change significantly depending on frequency resources, in the case of 5G channels, channel and interference characteristics vary greatly depending on the service, so a subset support at the frequency resource group (FRG) level is needed to divide and measure the channel and interference characteristics. On the other hand, in the NR system, the types of services supported may be divided into categories such as enhanced mobile broadband (eMBB), massive machine type communications (mMTC), and ultra-reliable and low-latency communications (URLLC). The eMBB may be a service that aims for high-speed transmission of high-capacity data, the mMTC may be a service that aims to minimize terminal power and access of multiple terminals, and URLLC may be a service that aims for high reliability and low delay. Different requirements may apply depending on the type of service applied to the terminal.

In this way, multiple services may be provided to users in a communication system, and a method to provide each service that matches its characteristics within the same time period and a device using the same are required to provide such multiple services to users.

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services. Furthermore, as 5th generation wireless communication systems, 5G or new radio (NR) standards are under development.

As a typical example of the broadband wireless communication system, the NR system employs an orthogonal frequency division multiplexing (OFDM) scheme in a downlink (DL) and an uplink (UL). More specifically, the NR system employs a cyclic-prefix OFDM (CP-OFDM) scheme in a downlink and employs two schemes, that is, the CP-OFDM scheme and discrete Fourier transform spreading (DFT-S-OFDM) scheme in an uplink. The uplink indicates a radio link through which a user equipment (UE) or a mobile station (MS) transmits data or control signals to a base station (BS) or (gNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

The NR system employs a hybrid automatic repeat request (HARQ) scheme in which, when decoding is unsuccessful at the initial transmission, the corresponding data is retransmitted in a physical layer. In the HARQ scheme, when a receiver fails to accurately decode data, the receiver transmits information (negative acknowledgement: NACK) informing a transmitter of the unsuccessful decoding and thus the transmitter may retransmit the corresponding data in the physical layer. The receiver may increase data reception performance by combining the data retransmitted by the transmitter with the data the decoding of which has previously failed. Also, when the receiver accurately decodes data, the receiver transmits information (acknowledgement: ACK) informing the transmitter of the successful decoding and thus the transmitter may transmit new data.

According to an embodiment of the disclosure, when a terminal attempts to connect to a base station through a satellite, a long delay time occurs for radio waves to arrive due to the long distances of hundreds of km, thousands of km, or more between the terminal and the satellite, and between the satellite and the base station on the ground. The delay time between the terminal, satellite, and base station is much longer than in a situation where the terminal and base station communicate directly in a terrestrial network. In addition, the delay time between the terminal, satellite, and base station changes with time because the satellite is constantly moving.

Accordingly, when the terminal transmits and receives signals to and from the base station through the satellite, the disclosure provides a method and device in which the base station indicates a time offset and the terminal corrects the time offset based on the time-varying delay time that occurs depending on the long distance to the satellite and the movement of the satellite. In addition, the terminal may calculate a portion of the time offset based on the satellite and its own location and time information, and provides a method and device for applying the calculated portion of the time offset and reporting the same to the base station.

That is, according to an embodiment of the disclosure, when the terminal transmits and receives signals to and from the base station through the satellite, correction for time offset may be necessary due to the long distance between the terminal and the satellite. Accordingly, the disclosure provides a method and a device in which the base station indicates the terminal time offset information, the terminal calculates and applies a portion of the timing advance, the terminal reports the timing advance information to the base station, and the terminal corrects the time offset using the information indicated by the base station.

As described above, by using the disclosure, a terminal may access to a base station through a satellite, the base station indicates the terminal a time offset, and the terminal calculates and corrects the time offset, thereby effectively exchanging signals between the base station and the terminal.

FIG. 1 illustrates the basic structure of a time-frequency domain, which is a radio resource area in which the data or control channel is transmitted in the downlink or uplink in an NR system according to an embodiment of the present disclosure.

In FIG. 1, the horizontal axis represents time domain and the vertical axis represents frequency domain. The minimum transmission unit in the time domain is an OFDM symbol, and Nsymb OFDM symbols 102 are gathered to configure one slot 106. The length of the subframe may be defined as 1.0 ms, and the radio frame 114 may be defined as 10 ms. The minimum transmission unit in the frequency domain is a subcarrier, and the bandwidth of the entire system transmission bandwidth consists of a total of NBW subcarriers 104. One frame may be defined as 10 ms. One subframe may be defined as 1 ms, and thus one frame may consist of a total of 10 subframes. One slot may be defined as 14 OFDM symbols (i.e., the number of symbols per one slot (N_{symb}^{slot})=14). One subframe may consist of one or a plurality of slots, and the number of slots per one subframe may vary according to μ which is a configuration value for the subcarrier spacing. When μ=0, one subframe may consist of one slot, and when μ=1, one subframe may subframe, consist of two slots. That is, the number of slots (Nₛₗₒₜ^{subframe,μ}) per one subframe may vary according to the configuration value μ for the subcarrier spacing, and accordingly, the number of slots (Nₛₗₒₜ^{frame,μ}) per one frame may vary. The NNₛₗₒₜ^{subframe,μ} and Nₛₗₒₜ^{frame,μ} according to each subcarrier spacing configuration may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The terminal before a radio resource control (RRC) connection may receive the initial bandwidth part (initial BWP) for initial access from the base station through a master information block (MIB). More specifically, in the initial access, the terminal may receive configuration information on a control resource set (CORESET) and a search space through which a physical downlink control channel (PDCCH) for receiving system information (remaining system information; RMSI or system information block 1; may correspond to SIB) required for initial access may be transmitted through the MIB. The control resource set and search space configured through the MIB may each be regarded as identifier (ID) 0. The base station may notify the terminal of configuration information such as frequency allocation information, time allocation information, and numerology for control resource set #0 through the MIB. In addition, the base station may notify the terminal of configuration information on the monitoring period and occasion for control resource set #0, that is, configuration information on search space #0, through the MIB. The terminal may regard the frequency area configured as control resource set #0 obtained from the MIB as the initial bandwidth part for initial access. In this case, the identifier (ID) of the initial bandwidth part may be regarded as 0.

MIB may include information such as Table 2 below. Of course, this is not limited to the examples below.

TABLE 2

```
-- ASN1START
-- TAG-MIB-START
MIB ::=  SEQUENCE {
  systemFrameNumber  BIT STRING (SIZE (6)),
  subCarrierSpacingCommon  ENUMERATED {scs15or60, scs30or120},
  ssb-SubcarrierOffset  INTEGER (0..15),
  dmrs-TypeA-Position  ENUMERATED {pos2, pos3},
  pdcch-ConfigSIB1 PDCCH-ConfigSIB1,
  cellBarred ENUMERATED {barred, notBarred},
  intraFreqReselection ENUMERATED {allowed, notAllowed},
  spare  BIT STRING (SIZE (1))
}
-- TAG-MIB-STOP
-- ASN1STOP
```

The description of the MIB field is as follows.
cellBarred:

Value barred means that the cell is barred, as defined in TS 38.304.
dmrs-TypeA-Position:

Position of (first) DM-RS for downlink (see TS 38.211) and uplink (see TS 38.211).
intraFreqReselection:

Controls cell selection/reselection to intra-frequency cells when the highest ranked cell is barred, or treated as barred by the UE, as specified in TS 38.304.
pdcch-ConfigSIB1:

Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1 (see TS 38.213).
ssb-SubcarrierOffset:

Corresponds to kSSB (see TS 38.213), which is the frequency domain offset between SSB and the overall resource block grid in number of subcarriers. (See TS 38.211).

The value range of this field may be extended by an additional most significant bit encoded within PBCH as specified in TS 38.213.

This field may indicate that this cell does not provide SIB1 and that there is hence no CORESET #0 configured in MIB (see TS 38.213). In this case, the field pdcch-ConfigSIB1 may indicate the frequency positions where the UE may (not) find a SS/PBCH with a control resource set and search space for SIB1 (see TS 38.213).
subCarrierSpacingCommon:

Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 kHz.
systemFrameNumber:

The 6 most significant bits (MSB) of the 10-bit system frame number (SFN). The 4 LSB of the SFN are conveyed in the PBCH transport block as part of channel coding (i.e., outside the MIB encoding), as defined TS 38.212.

In a method of configuring the bandwidth part, terminals before RRC connection may receive configuration information on the initial bandwidth part through MIB in the initial access. To be more specific, the terminal may receive configuration of a control resource set for the downlink control channel through which downlink control information (DCI) for scheduling the SIB may be transmitted from the MIB of the physical broadcast channel (PBCH). In this case, the bandwidth of the control resource set configured as MIB may be considered as the initial bandwidth part, and through the configured initial bandwidth part, the terminal may receive the physical downlink shared channel (PDSCH) through which the SIB is transmitted. In addition to receiving SIB, the initial bandwidth part may be used for other system information (OSI), paging, and random access.

When one or more bandwidth parts are configured for the terminal, the base station may indicate the terminal to change the bandwidth part by using the bandwidth part indicator field in the DCI.

The basic unit of resources in the time-frequency domain is a resource element (RE) 112, which may be expressed as an OFDM symbol index and a subcarrier index. A resource block (RB) (or physical resource block; PRB) 108 is defined as NRB consecutive subcarriers 110 in the frequency domain. In general, the minimum transmission unit of data may be a RB unit. In an NR system, Nsymb=14 and NRB=12, and NBW may be proportional to the bandwidth of the system transmission band. The data rate may be increased in proportion to the number of RBs scheduled to the terminal.

In an NR system, in the case of an FDD system that operates by dividing downlink and uplink by frequency, the downlink transmission bandwidth and uplink transmission bandwidth may be different from each other. The channel bandwidth represents the RF bandwidth corresponding to the system transmission bandwidth. Tables 3 and 4 illustrate some of the correspondence between system transmission bandwidth, subcarrier spacing, and channel bandwidth defined in the NR system at the frequency range 1 (FR 1) lower than 6 GHz and the frequency range (FR 2) higher than 6 GHz, respectively. For example, an NR system with a 100 MHz channel bandwidth with a 30 kHz subcarrier width has a transmission bandwidth of 273 RBs. In the following, N/A may be a bandwidth-subcarrier combination not supported by the NR system.

TABLE 3

| SCS | 5 MHz | 10 MHz | 15 MHz | 20 MHz | 25 MHz | 30 MHz | 40 MHz | 50 MHz | 60 MHz | 80 MHz | 90 MHz | 100 MHz |
|---|---|---|---|---|---|---|---|---|---|---|---|---|
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

TABLE 4

| | Channel bandwidth BW_{Channel} [MHz] | | | | |
|---|---|---|---|---|---|
| | Subcarrier | | | | |
| | Spacing | 50 MHz | 100 MHz | 200 MHz | 400 MHz |
| Transmission | 60 kHz | 66 | 132 | 264 | N/A |
| bandwidth | 120 kHz | 32 | 66 | 132 | 264 |
| configuration | | | | | |
| N_{RB} | | | | | |

In an NR system, the frequency range may be divided into FR1 and FR2 and defined as illustrated in Table 5 below.

TABLE 5

| Frequency range designation | Corresponding frequency range |
|---|---|
| FR1 | 450 MHz-7125 MHz |
| FR2 | 24250 MHz-52600 MHz |

Of course, the ranges of FR1 and FR2 above may be changed and applied differently. As an example, the frequency range of FR1 may be changed and applied from 450 MHz to 6,000 MHz.

Next, the synchronization signal (SS)/PBCH block in 5G will be described.

The SS/PBCH block may refer to a physical layer channel block composed of PSS (primary SS, primary synchronization signal), SSS (secondary SS, sub-synchronization signal), and PBCH. Specifically, they are as follows.
PSS: a signal that serves as a standard for downlink time/frequency synchronization and may provide some information on the cell ID.
SSS: a signal that serves as a standard for downlink time/frequency synchronization and may provide the remaining cell ID information not provided by PSS. In addition, it may serve as a reference signal for demodulation of PBCH.
PBCH: may provide essential system information necessary for transmitting and receiving data channels and control channels of the terminal. The essential system information may include search space-related control information indicating radio resource mapping information of the control channel, scheduling control information for a separate data channel transmitting system information, etc.
SS/PBCH block: SS/PBCH block may be composed of a combination of PSS, SSS, and PBCH. One or more SS/PBCH blocks may be transmitted within 5 ms, and each transmitted SS/PBCH block may be distinguished by an index.

The terminal may detect the PSS and the SSS in the initial access and decode the PBCH. The terminal may obtain the MIB from the PBCH and receive configuration of control resource set #0 (this may correspond to a control resource set where the control resource set index is 0) through the MIB. The terminal may perform monitoring on control resource set #0 assuming that the selected SS/PBCH block and the demodulation reference signal (DMRS) transmitted in the control resource set #0 are QCLed (quasi co-located). The terminal may receive system information through downlink control information transmitted from the control resource set #0. The terminal may obtain random access channel (RACH)-related configuration information necessary for initial access from the received system information. The terminal may transmit physical RACH (PRACH) to the base station in consideration of the SS/PBCH index selected, and the base station receiving the PRACH may obtain information on the SS/PBCH block index selected by the terminal. Through this process, the base station may know which block the terminal has selected among each SS/PBCH block and monitor control resource set #0 associated with the selected block.

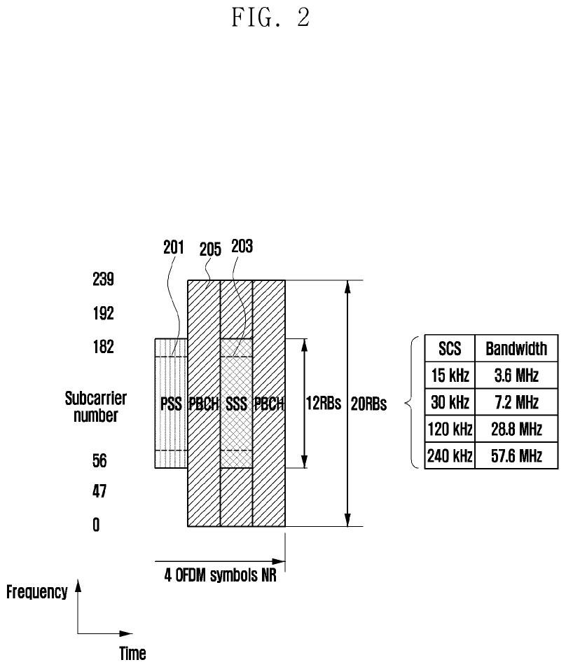

FIG. 2 illustrates synchronization signals (SS) and physical broadcasting channels (PBCH) of the NR system mapped in the frequency and time domain according to an embodiment of the present disclosure.

The primary synchronization signal (PSS) 201, the secondary synchronization signal (SSS) 203, and the PBCH are mapped over 4 OFDM symbols, the PSS and SSS are mapped to 12 RBs, and the PBCH is mapped to 20 RBs. The table in FIG. 2 illustrates how the frequency range of 20 RBs changes depending on the subcarrier spacing (SCS). The resource area where the PSS, SSS, and PBCH are transmitted may be called an SS/PBCH block. In addition, the SS/PBCH block may be referred to as a synchronization signal block (SSB).

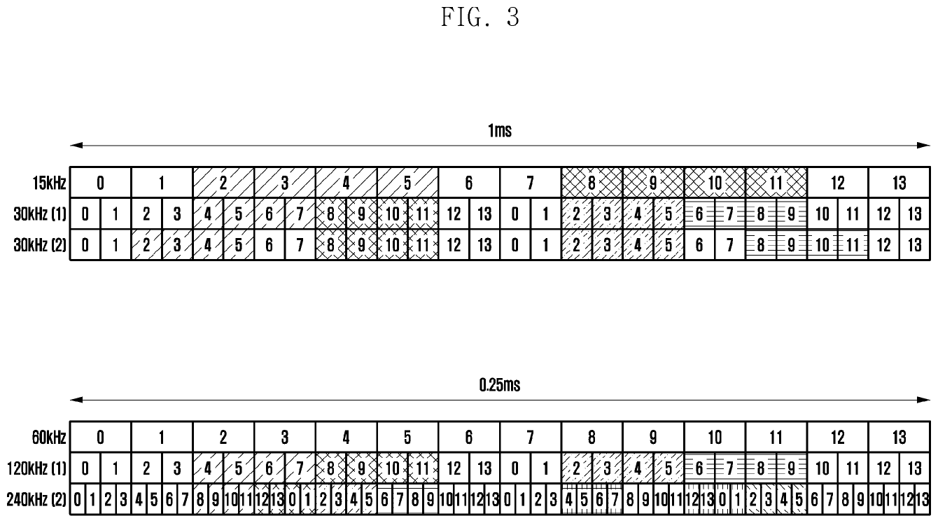

FIG. 3 illustrates symbols through which SS/PBCH blocks may be transmitted according to subcarrier spacing according to an embodiment of the present disclosure.

Referring to FIG. 3, the subcarrier spacing may be configured to 15 kHz, 30 kHz, 120 kHz, 240 kHz, etc., and the location of the symbol where the SS/PBCH block (or SSB) may be located may be determined according to each subcarrier spacing. FIG. 3 illustrates the location of symbols where the SSB may be transmitted according to subcarrier spacing in symbols within 1 ms, and the SSB does not always have to be transmitted in the area illustrated in FIG. 3. The location where the SSB is transmitted may be configured for the terminal through system information or dedicated signaling.

In the following, the downlink control channel in the 5G communication system will be described in more detail with reference to the drawings.

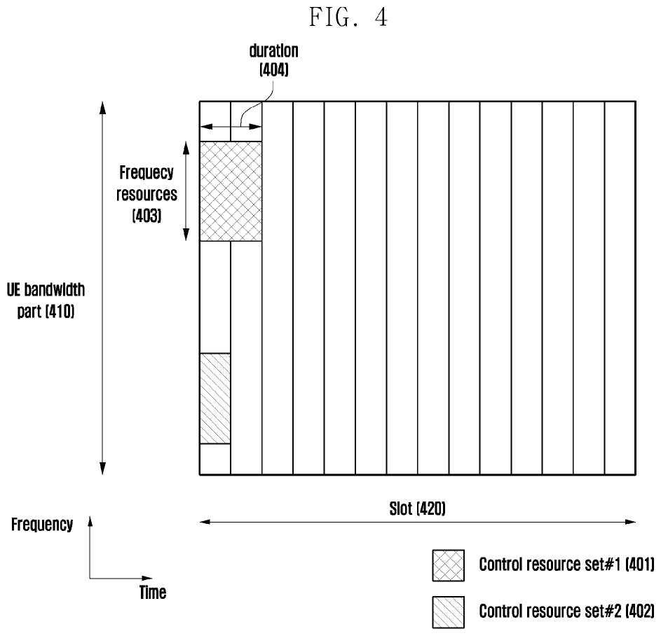

FIG. 4 illustrates an example of a control resource set (CORESET) in which a downlink control channel is transmitted in a 5G wireless communication system according to an embodiment of the present disclosure.

FIG. 4 illustrates an example in which a UE bandwidth part 410 is configured on the frequency axis and two control areas (control resource set #1 (401), control resource set #2 (402)) are configured within one slot 420 on the time axis. The control resource sets 391 and 402 may be configured to a specific frequency resource 403 within the entire UE bandwidth part 410 on the frequency axis. One or more OFDM symbols may be configured on the time axis, and may be defined as the control resource set duration, 404. Referring to the example illustrated in FIG. 4, control resource set #1 (401) is configured to a control resource set duration of two symbols, and control resource set #2 (402) is configured to a control resource set duration of one symbol.

The control resource set in the above-described 5G system may be configured by the base station to the terminal through higher layer signaling (e.g., system information, MIB, RRC signaling). Configuring a control resource set to a terminal may refer to providing information such as a control resource set identifier (Identity), frequency location of the control resource set, and symbol length of the control resource set. For example, the higher layer signaling may include the information in Table 6 below. Of course, it is not limited to the examples below.

TABLE 6

```
ControlResourceSet ::=  SEQUENCE {
      -- Corresponds to L1 parameter ‘CORESET-ID’
      controlResourceSetId
      ControlResourceSetId,
  (control resource set identity)
      frequencyDomainResources  BIT  STRING
(SIZE (45)),
  (resource allocation information in frequency domain)
      duration
      INTEGER (1..maxCoReSetDuration),
  (resource allocation information in time domain)
      cce-REG-MappingType
      CHOICE {
  (CCE-to-REG mapping type)
              interleaved
              SEQUENCE {
                      reg-BundleSize
              ENUMERATED {n2, n3, n6},
  (REG bundle size)
                      precoderGranularity
              ENUMERATED {sameAsREG-bundle, allContiguousRBs},
                      interleaverSize
              ENUMERATED {n2, n3, n6}
                      (interleaver size)
                      shiftIndex
                      INTEGER(0..maxNrofPhysicalResourceBlocks-1)
                                                          OPTIONAL
              (interleaver shift)
  },
      nonInterleaved NULL
      },
      tci-StatesPDCCH
      SEQUENCE(SIZE (1..maxNrofTCI-StatesPDCCH)) OF TCI-StateId
                            OPTIONAL,
  (QCL configuration information)
      tci-PresentInDCI ENUMERATED
{enabled}
                                          OPTIONAL,  -- Need S
}
```

In Table 6, the tci-StatesPDCCH (simply name transmission configuration indication (TCI) state) configuration information may include information on one or more SS/PBCH block indexes or channel state information reference signal (CSI-RS) indexes in a QCL relationship with the DMRS transmitted in the corresponding control resource set.

Next, downlink control information (DCI) in a 5G system will be described in detail.

In the 5G system, scheduling information for uplink shared channel (or physical uplink shared channel, PUSCH) or downlink shared channel (or physical downlink shared channel, PDSCH) is transmitted from the base station to the terminal through DCI. The terminal may monitor the DCI format for fallback and the DCI format for non-fallback for PUSCH or PDSCH. The fallback DCI format may consist of fixed fields predefined between the base station and the terminal, and the non-fallback DCI format may include configurable fields. In addition, there are various formats of DCI, and each format may indicate whether each format is DCI for power control or DCI for notifying a slot format indicator (SFI).

DCI may be transmitted via PDCCH, a physical downlink control channel, through channel coding and modulation processes. A cyclic redundancy check (CRC) is attached to the DCI message payload, and the CRC may be scrambled with a radio network temporary identifier (RNTI) corresponding to the identity of the terminal. Different RNTIs may be used according to the purpose of the DCI message, for example, UE-specific data transmission, a power control command, or a random access response. That is, the RNTI is not explicitly transmitted, but is included in the CRC calculation process and transmitted. Upon receiving the DCI message transmitted over the PDCCH, the terminal identifies the CRC by using the allocated RNTI, and if the CRC identification result is correct, the terminal may recognize that the received DCI message has been transmitted to the terminal. The PDCCH may be mapped and transmitted in a control resource set (CORESET) configured for the terminal.

For example, DCI scheduling a PDSCH for system information (SI) may be scrambled with SI-RNTI. DCI scheduling a PDSCH for a random access response (RAR) message may be scrambled with an RA-RNTI. DCI scheduling a PDSCH for a paging message may be scrambled with a P-RNTI. DCI notifying a slot format indicator (SFI) may be scrambled with an SFI-RNTI. DCI notifying a transmit power control (TPC) may be scrambled with TPC-RNTI. DCI scheduling UE-specific PDSCH or PUSCH may be scrambled with cell RNTI (C-RNTI). Of course, the types of RNTI are not limited to the above examples.

DCI format 0_0 may be used as a fallback DCI for scheduling PUSCH, and in this case, CRC may be scrambled with C-RNTI. DCI format 0_0 in which CRC is scrambled with C-RNTI may include, for example, information as illustrated below. Of course, this is not limited to the examples below.

TABLE 7
Identifier for DCI formats - [1] bit
Frequency domain resource assignment -[┌log₂(N_{RB}^{UL, BWP}(N_{RB}^{UL, BWP} +
1)/2)┐] bits
Time domain resource assignment - X bits
Frequency hopping flag - 1 bit.
Modulation and coding scheme - 5 bits
New data indicator - 1 bit
Redundancy version - 2 bits
HARQ process number - 4 bits
TPC (transmit power control) command for scheduled PUSCH - [2] bits
UL (uplink)/SUL (supplementary UL) indicator - 0 or 1 bit

DCI format 0_1 may be used as a non-fallback DCI for scheduling PUSCH, and in this case, CRC may be scrambled with C-RNTI. DCI format 0_1 in which CRC is scrambled with C-RNTI may include, for example, information as illustrated below. Of course, this is not limited to the examples below.

```
TABLE 8
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} +
    1)/2)┐ bits
  Time domain resource assignment -1, 2, 3, or 4 bits
  VRB (virtual resource block)-to-PRB (physical resource block)
mapping - 0 or 1 bit, only for resource allocation type 1.
    0 bit if only resource allocation type 0 is configured;
    1 bit otherwise.
  Frequency hopping flag - 0 or 1 bit, only for resource
  allocation type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
    1 bit for semi-static HARQ-ACK codebook;
    2 bits for dynamic HARQ-ACK codebook with single
HARQ-ACK codebook.
  2nd downlink assignment index - 0 or 2 bits
    2 bits for dynamic HARQ-ACK codebook with two
HARQ-ACK sub-codebooks;
    0 bit otherwise.
  TPC command for scheduled PUSCH - 2 bits
  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
    transmission;
    ┌log₂(N_{SRS})┐ bits for codebook based PUSCH
    transmission.
  Precoding information and number of layers -up to 6 bits
  Antenna ports - up to 5 bits
  SRS request - 2 bits
  CSI (channel state information) request - 0, 1, 2, 3, 4, 5,
  or 6 bits
  CBG (code block group) transmission information - 0, 2, 4, 6,
  or 8 bits
  PTRS (phase tracking reference signal)-DMRS (demodulation
reference signal) association - 0 or 2 bits.
  beta offset indicator - 0 or 2 bits
  DMRS (demodulation reference signal) sequence
initialization - 0 or 1 bit
```

DCI format 1_0 may be used as a fallback DCI for scheduling PDSCH, and in this case, CRC may be scrambled with C-RNTI. DCI format 1_0 in which CRC is scrambled with C-RNTI may include, for example, information as illustrated below. Of course, this is not limited to the examples below.

TABLE 9
Identifier for DCI formats - [1] bit
Frequency domain resource assignment [┌log₂(N_{RB}^{DL, BWP}(N_{RB}^{DL, BWP} +
1)/2)┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH (physical uplink control channel, PUCCH) resource indicator -
3 bits
PDSCH-to-HARQ feedback timing indicator - [3] bits

DCI format 1_1 may be used as a non-fallback DCI for scheduling PDSCH, and in this case, CRC may be scrambled with C-RNTI. DCI format 1_1 in which CRC is scrambled with C-RNTI may include, for example, information as illustrated below. Of course, this is not limited to the examples below.

```
TABLE 10
  Carrier indicator - 0 or 3 bits
  Identifier for DCI formats - [1] bits
  Bandwidth part indicator - 0, 1 or 2 bits
  Frequency domain resource assignment
    For resource allocation type 0, ┌N_{RB}^{DL, BWP}/P┐ bits
    For resource allocation type 1, ┌log₂(N_{RB}^{DL, BWP}(N_{RB}^{DL, BWP} +
    1)/2)┐
  Time domain resource assignment −1, 2, 3, or 4 bits
  VRB-to-PRB mapping - 0 or 1 bit, only for resource allocation type 1.
    0 bit if only resource allocation type 0 is configured;
    1 bit otherwise.
  PRB (physical resource block) bundling size indicator - 0 or 1 bit
  Rate matching indicator - 0, 1, or 2 bits
  ZP CSI-RS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

As an example, each control information included in DCI format 1_1, which is scheduling control information (DL grant) for downlink data, may include the following information. Of course, this is not limited to the examples below.
Carrier indicator: indicates on which carrier data scheduled by DCI is transmitted—0 or 3 bits.
Identifier for DCI formats: indicates the DCI format, and is specifically an indicator that distinguishes whether the DCI is for downlink or uplink.—[1] bits.
Bandwidth part indicator: indicates when there is a change in the bandwidth part—0, 1 or 2 bits.
Frequency domain resource assignment: resource assignment information indicating frequency domain resource assignment, and the resources expressed vary depending on whether the resource assignment type is 0 or 1.
Time domain resource assignment: resource assignment information indicating time domain resource assignment may indicate higher layer signaling or configuration of a predetermined PDSCH time domain resource assignment list—1, 2, 3, or 4 bits.
VRB-to-PRB mapping: indicates the mapping relationship between virtual resource block (VRB) and physical resource block (PRB)—0 or 1 bit.
PRB bundling size indicator: indicates the physical resource block bundling size assuming the same precoding is applied—0 or 1 bit.
Rate matching indicator: indicates which rate match group is applied among the rate match groups configured as the higher layer applied to the PDSCH—0, 1, or 2 bits.
ZP CSI-RS trigger: triggers the zero power channel status information reference signal—0, 1, or 2 bits.
Configuration information related to transport block (TB): indicates modulation and coding scheme (MCS), new data indicator (NDI), and redundancy version (RV) for one or two TBs.
Modulation and coding scheme (MCS): indicates the modulation scheme and coding rate used for data transmission. That is, it is possible to indicate a coding rate value that may provide TBS and channel coding information along with information on whether the value is QPSK, 16QAM, 64QAM, or 256QAM.
New data indicator: indicates whether it is HARQ initial transmission or retransmission.
Redundancy version: indicates the redundancy version of HARQ.
HARQ process number: indicates the HARQ process number applied to PDSCH—4 bits.
Downlink assignment index: index for generating a dynamic HARQ-ACK codebook when reporting HARQ-ACK for PDSCH—0 or 2 or 4 bits.
TPC command for scheduled PUCCH: power control information applied to PUCCH for HARQ-ACK reporting for PDSCH—2 bits.
PUCCH resource indicator: information indicating the resource of PUCCH for HARQ-ACK reporting on PDSCH—3 bits.
PDSCH-to-HARQ_feedback timing indicator: configuration information on which slot the PUCCH for HARQ-ACK reporting for PDSCH is transmitted—3 bits.
Antenna ports: information indicating the antenna port of the PDSCH DMRS and the DMRS CDM group where the PDSCH is not transmitted—4, 5 or 6 bits.
Transmission configuration indication: information indicating beam-related information of PDSCH—0 or 3 bits.
SRS request: information requesting SRS transmission—2 bits.
CBG transmission information: when code block group-based retransmission is configured, information indicating which code block group (CBG) corresponding data is transmitted through PDSCH—0, 2, 4, 6, or 8 bits.
CBG flushing out information: information indicating whether the code block group previously received by the terminal may be used for HARQ combining—0 or 1 bit.
DMRS sequence initialization: indicates DMRS sequence initialization parameters—1 bit.

In the following, a time domain resource allocation method for data channels in a 5G communication system will be described.

Downlink data may be transmitted on PDSCH, a physical channel for downlink data transmission. Uplink data may be transmitted on PUSCH, a physical channel for uplink data transmission. PDSCH may be transmitted after the control channel transmission period, and scheduling information such as specific mapping location and modulation method in the frequency domain is determined based on DCI transmitted through the PDCCH.

The base station may configure a table for time domain resource allocation information on the physical downlink shared channel (PDSCH) and the physical uplink shared channel (PUSCH) through higher layer signaling (e.g., RRC signaling) to the terminal. A table consisting of a maximum of 16 (maxNrofDL-Allocations) entries may be configured for the PDSCH, and a table consisting of a maximum of 16 (maxNrofUL-Allocations) entries may be configured for the PUSCH. The time domain resource allocation information may include, for example, PDCCH-to-PDSCH slot timing (corresponds to the time interval in slot units between the time when the PDCCH is received and the time when the PDSCH scheduled by the received PDCCH is transmitted, denoted by K0) or PDCCH-to-PUSCH slot timing (corresponds to the time interval in slot units between the time when the PDCCH is received and the time when the PUSCH scheduled by the received PDCCH is transmitted, denoted by K2), information on the location and length of a start symbol in which a PDSCH or PUSCH is scheduled in the slot, mapping type of PDSCH or PUSCH, etc. For example, information such as the Tables 11 and 12 below may be notified from the base station to the terminal. Of course, this is not limited to the examples below.

TABLE 11

```
PDSCH-TimeDomainResourceAllocationList  ::=  SEQUENCE (SIZE(1..maxNrofDL-
Allocations)) OF PDSCH-TimeDomainResourceAllocation
PDSCH-TimeDomainResourceAllocation ::=  SEQUENCE {
    k0  INTEGER(0..32)  OPTIONAL, -- Need S
    (PDCCH-to-PDSCH timing, slot unit)
    mappingType  ENUMERATED {typeA, typeB},
    (PDSCH mapping type)
    startSymbol AndLength  INTEGER (0..127)
    (start symbol and length of PDSCH)
}
```

TABLE 12

```
PUSCH-TimeDomainResourceAllocationList ::=  SEQUENCE
(SIZE(1..maxNrofUL-Allocations)) OF PUSCH-
TimeDomainResourceAllocation
PUSCH-TimeDomainResourceAllocation ::=  SEQUENCE {
    k2  INTEGER(0..32) OPTIONAL, -- Need S
    (PDCCH-to-PUSCH timing, slot unit)
    mappingType  ENUMERATED {typeA, typeB},
    (PUSCH mapping type)
    startSymbolAndLength  INTEGER (0..127)
    (start symbol and length of PUSCH)
}
```

The base station may notify the terminal of one of the entries in the table for the time domain resource allocation information through L1 signaling (e.g., DCI) (for example, the base station may indicate with the “time domain resource allocation” field in DCI. The terminal may obtain time domain resource allocation information on the PDSCH or PUSCH based on the DCI received from the base station.

According to an embodiment of the disclosure, time domain resource assignment may be delivered by information on the slot in which the PDSCH/PUSCH are transmitted, the start symbol location S in the slot, and the number of symbols L to which the PDSCH/PUSCH are mapped. In the above, S may be a relative position from the start of the slot, L may be the number of consecutive symbols, and S and L may be determined from the start and length indicator value (SLIV) defined as Equation 1 below.

if (L−1)≤7 then

SLIV=14·(L−1)+S

else

SLIV=14·(14−L+1)+(14−1−S)

where 0<L≤14−S Equation 1

In the NR system, PDSCH mapping types are defined as type A and type B. In PDSCH mapping type A, the first of the DMRS symbols is located in the second or third OFDM symbol of the slot. In PDSCH mapping type B, the first symbol among the DMRS symbols of the first OFDM symbol in the time domain resources allocated through PUSCH transmission is located.

The base station notifies the terminal of the modulation method applied to the PDSCH to be transmitted and the size of the data to be transmitted (transport block size (TBS)) through the modulation coding scheme (MCS) among the control information that constitutes DCI. According to one embodiment of the disclosure, the MCS may be composed of 5 bits or more or less bits. TBS may correspond to the size before channel coding for error correction is applied to the data (transport block, TB) that the base station wants to transmit.

In the disclosure, a transport block (TB) may include a medium access control (MAC) header, a MAC control element, one or more MAC service data units (SDU), and padding bits. Alternatively, TB may refer to a unit of data delivered from the MAC layer to the physical layer or a MAC protocol data unit (PDU).

The modulation methods supported by the NR system are quadrature phase shift keying (QPSK), quadrature amplitude modulation (16QAM), 64QAM, and 256QAM, with each modulation order (Qm) corresponding to 2, 4, 6, and 8. That is, for QPSK modulation, 2 bits per symbol may be transmitted, for 16QAM modulation, 4 bits per symbol, for 64QAM modulation, 6 bits per symbol, and for 256QAM modulation, 8 bits per symbol may be transmitted.

The terms physical channel and signal in the NR system may be used to describe the method and device provided in an embodiment of the disclosure. However, the content of the disclosure may also be applied to wireless communication systems other than NR systems.

In the disclosure, downlink (DL) refers to a wireless transmission path of a signal transmitted from a base station to a terminal, and uplink (UL) refers to a wireless transmission path of a signal transmitted from a terminal to a base station.

In the disclosure, the conventional terms of physical channel and signal may be used interchangeably with data or control signals. For example, the PDSCH is a physical channel through which data is transmitted, but in the disclosure, the PDSCH may be referred to as data.

Hereinafter, in the disclosure, higher signaling is a signal transmission method in which signals are transmitted from the base station to the terminal by using the downlink data channel of the physical layer, or from the terminal to the base station by using the uplink data channel of the physical layer, and may also be referred to as RRC signaling or MAC control element (MAC CE).

According to an embodiment of the disclosure, timing advance (TA) may be transmitted through a MAC control element (CE), for example, timing advance command MAC CE, or absolute timing advance command MAC CE.

On the other hand, a message from the MAC layer transmitted to the physical layer, for example, a MAC PDU, may include one or more MAC sub-PDUs. Each MAC sub-PDU may include one of the following. Of course, this is not limited to the examples below:
MAC subheader only (including padding);
MAC subheader and MAC SDU;
MAC subheader and MAC CE; and/or
MAC subheader and padding.

MAC SDUs may have variable sizes, and each MAC subheader may correspond to a MAC SDU, MAC CE, or padding.

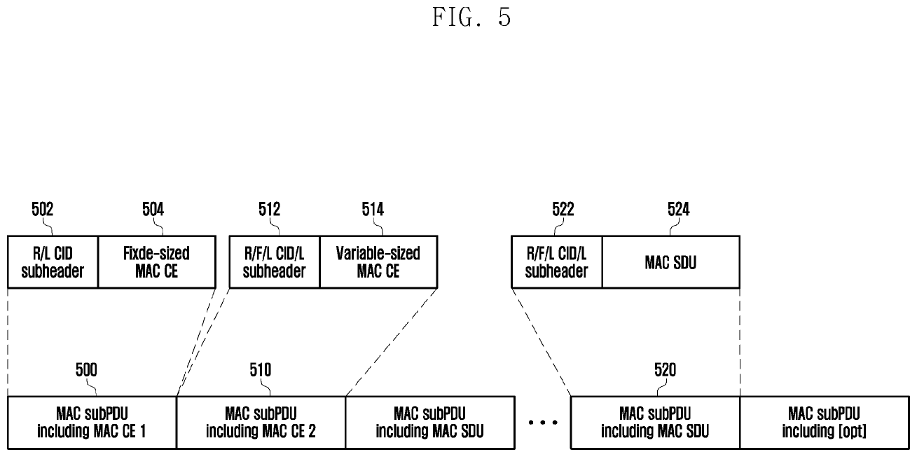

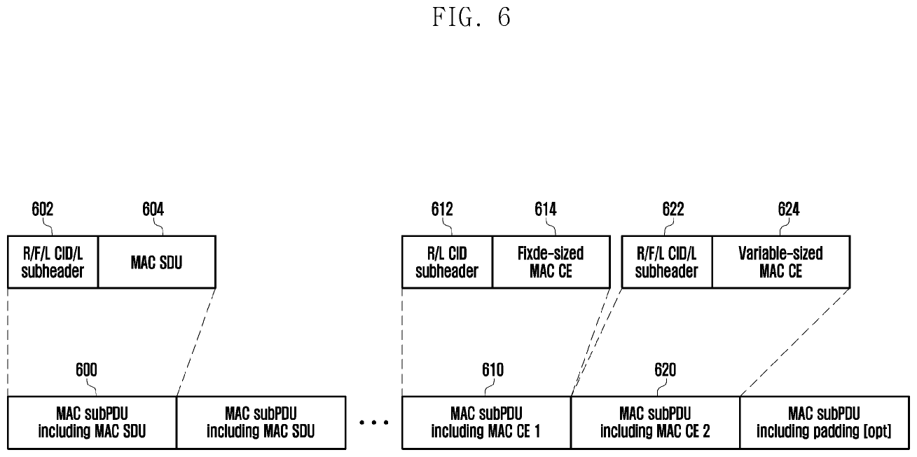

On the other hand, a message from the MAC layer transmitted to the physical layer, for example, the MAC PDU, may be configured as illustrated in FIGS. 5 and 6 for downlink and uplink, respectively.

First, with reference to FIG. 5, an example of a message transmitted from the MAC layer to the physical layer in the downlink in a communication system according to various embodiments of the disclosure will be described.

FIG. 5 illustrates an example of a message transmitted from the MAC layer to the physical layer in the downlink in a communication system according to an embodiment of the present disclosure.

Referring to FIG. 5, an example of a message transmitted from the MAC layer to the physical layer in the downlink may be a downlink MAC PDU (DL MAC PDU). In FIG. 5, a MAC sub-PDU 500 including a MAC CE 1 may include an R/LCID subheader 502 and a fixed-sized MAC CE 504, and a MAC sub-PDU 510 including a MAC CE 2 may include an R/F/LCID/L subheader 512 and a variable-sized MAC CE 514. In addition, a MAC sub-PDU 520 including a MAC SDU may include an R/F/LCID/L subheader 522 and a MAC SDU 524.

In FIG. 5, the LCID represents a logical channel ID field, and the LCID field indicates an instance of the corresponding MAC SDU or the type or padding of the corresponding MAC CE, which is described in detail in Tables 13 and 14 below. Here, Table 13 below illustrates LCID values for DL-SCH, and Table 14 illustrates LCID values for UL-SCH.

TABLE 13

| Codepoint/ | |
|---|---|
| Index | LCID values |
| 0 | CCCH |
| 1-32 | Identity of the logical channel |
| 33 | Extended logical channel ID field (two-octet eLCID field) |
| 34 | Extended logical channel ID field (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 14

| Codepoint | Index | LCID values |
|---|---|---|
| 0 to 244 | 64 to 308 | Reserved |
| 245 | 309 | Serving Cell Set based SRS Spatial Relation |
| | | Indication |
| 246 | 310 | PUSCH Pathloss Reference RS Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States Activation/Deactivation |
| | | for UE-specific PDSCH |
| 251 | 315 | Duplication RLC Activation/Deactivation |
| 252 | 316 | Absolute Timing Advance Command |
| 253 | 317 | SP Positioning SRS Activation/Deactivation |
| 254 | 318 | Provided Guard Symbols |
| 255 | 319 | Timing Delta |

There is one LCID field for each MAC subheader, and the size of the LCID field is 6 bits. When the LCID field is configured to “34,” for example, there is one additional octet in the MAC subheader including the eLCID field, and the octet follows the octet including the LCID field. When the LCID field is configured to “33,” for example, there are two additional octets in the MAC subheader including the eLCID field, and the two octets follow the octet including the LCID field.

In addition, the eLCID represents an extended logical channel ID field and indicates the logical channel instance of the corresponding MAC SDU or the type of the corresponding MAC CE. The size of the eLCID field is 8 bits or 16 bits.

In addition, L represents the length field, and the length field indicates the length of the corresponding MAC SDU or variable-size MAC CE. There is one length field per MAC subheader, excluding subheaders corresponding to MAC SDUs including fixed-size MAC CEs, padding, or UL common control channel (CCCH). The size of the length field is indicated by the F field.

In addition, F represents the format field, and indicates the size of the length field. There is one F field per each MAC subheader, excluding MAC SDUs including fixed MAC CEs, padding, and UL CCCH. The size of the F field is 1 bit, and for example, the value of 0 indicates 8 bits of the length field, and as another example, the value of 1 indicates 16 bits of the length field.

In addition, R is a reserved bit and is configured to “0” as an example.

As illustrated in FIG. 5, MAC CEs, for example MAC CE 1 and MAC CE 2, are placed together, and the MAC sub-PDU(s) including the MAC CE(s) are placed before the MAC sub-PDU including the MAC SDU and the MAC sub-PDU including padding. Here, the size of the padding may be zero.

Next, with reference to FIG. 6, an example of a message transmitted from the MAC layer to the physical layer in the uplink in a communication system according to various embodiments of the disclosure will be described.

FIG. 6 illustrates an example of a message transmitted from the MAC layer to the physical layer in the uplink in a communication system according to an embodiment of the present disclosure.

Referring to FIG. 6, an example of a message transmitted from the MAC layer to the physical layer in the uplink may be a uplink MAC PDU (UL MAC PDU). In FIG. 6, a MAC sub-PDU 610 including a MAC CE 1 may include an R/LCID subheader 612 and a fixed-sized MAC CE 614, and a MAC sub-PDU 620 including a MAC CE 2 may include an R/F/LCID/L subheader 622 and a variable-sized MAC CE 624. In addition, a MAC sub-PDU 600 including a MAC SDU may include an R/F/LCID/L subheader 602 and a MAC SDU 604.

As illustrated in FIG. 6, MAC CEs, for example MAC CE 1 and MAC CE 2, are placed together, and the MAC sub-PDU(s) including the MAC CE(s) are placed after the MAC sub-PDU including the MAC SDU, and placed before the MAC sub-PDU including padding. Here, the size of the padding may be zero.

In FIGS. 5 and 6, the LCID included in the subheader of the MAC layer, that is, the logical channel ID or extended logical channel ID (eLCID), may indicate the type of MAC SDU or MAC CE to be transmitted. The mapping of the index of the LCID and the type of MAC SDU or MAC CE may be illustrated, for example, as in Table 13, and the mapping of the index of the eLCID and the type of MAC SDU or MAC CE may be illustrated, for example, as in Table 14. In various embodiments of the disclosure, the LCID may indicate an instance of a logical channel of a MAC SDU, a type of MAC CE, or padding information of a downlink shared channel (DL-SCH) and an uplink shared channel (UL-SCH). One LCID is mapped per MAC subheader, and the LCID may be implemented with 6 bits, for example.

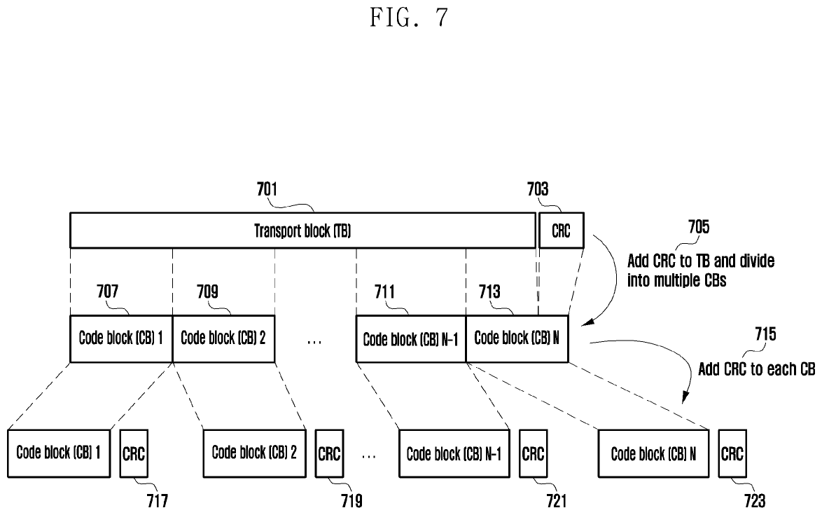

FIG. 7 illustrates an example of a process in which one transport block (TB) is divided into several code blocks (CB) and a CRC is added according to an embodiment of the present disclosure.

Referring to FIG. 7, a CRC 703 may be added to the last or first part of one transport block (TB) 701 to be transmitted in a uplink or downlink. The CRC 703 may have 16 bits or 25 bits, a pre-fixed number of bits, or a variable number of bits depending on channel conditions, etc., and may be used to determine whether a channel coding is successful. The block in which the CRC 703 is added to the TB 701 may be divided into several code blocks (CB) 707, 709, 711, and 713 (705). According to an embodiment of the disclosure, code blocks may be divided with a predetermined maximum size, and in this case, the last code block 713 may be smaller than the other code blocks 707, 709, and 711. However, it is not limited to the above example, and the length of the last code block 713 and the other code blocks 707, 709, and 711 may be made the same by inserting 0, a random value, or 1 into the last code block 713.

In addition, CRCs 717, 719, 721, and 723 may be added to the code blocks 707, 709, 711, and 713, respectively (715). The CRC may have 16 bits, 24 bits, or a pre-fixed number of bits, and may be used to determine whether a channel coding is successful.

TB 701 and a cyclic generator polynomial may be used to generate the CRC 703, and the cyclic generator polynomial may be defined in various ways. For example, when assuming a cyclic generator polynomial gCRC24A(D)=D24+D23+D18+D17+D14+D11+D10+D7+D6+D5+D4+D3+D+1, and L=24, for TB data a0, a1, a2, a3, . . . , aA−1, the CRC p0, p1, p2, p3, . . . , pL−1 is a value where a0DA+23+a1DA+22+ . . . +aA−1D24+p0D23+p1D22+ . . . +p22D1+p23 is divided by gCRC24A(D) and the remainder is 0, and p0, p1, p2, p3, . . . , pL−1 may be determined. In the above-mentioned example, the CRC length L is assumed to be 24, but the CRC length L may be determined to be various lengths such as 12, 16, 24, 32, 40, 48, and 64.

After the CRC is added to the TB through this process, the TB+CRC may be divided into N CBs 707, 709, 711, and 713. CRCs 717, 719, 721, and 723 may be added to each of the divided CBs 707, 709, 711, and 713 (715). The CRC added to the CB may have a different length than when generating the CRC added to the TB, or a different cyclic generator polynomial may be used to generate the CRC. In addition, the CRC 703 added to the TB and the CRCs 717, 719, 721, and 723 added to the code block may be omitted depending on the type of channel code to be applied to the code block. For example, when a low density parity check (LDPC) code rather than a turbo code is applied to a code block, CRCs 717, 719, 721, and 723 to be inserted per each code block may be omitted.

However, even when the LDPC is applied, CRCs 717, 719, 721, and 723 may be added to the code block. In addition, even when polar codes are used, the CRC may be added or omitted.

As described above in FIG. 7, the maximum length of a code block for the TB to be transmitted may be determined according to the type of channel coding applied, and the TB and the CRC added to the TB may be divided into code blocks according to the maximum length of the code block.

In a conventional LTE system, a CRC for CB is added to a divided CB, and the data bits and CRC of the CB are encoded with a channel code to determine the coded bits, and the number of rate-matched bits is determined for each coded bit as prearranged.

In the NR system, the size of TB (TBS) may be calculated through the following steps.

Step 1: calculate N′RE, which is the number of REs allocated to PDSCH mapping in one PRB within the allocated resources. N′RE may be calculated as N_{RE}′=N_{sc}^{RB}·N_{symb}^{sh}−N_{DMRS}^{PRB}−Nₒₕ^{PRB}. Here, N_{sc}^{RB} is 12, and N_{symb}^{sh} may indicate the number of OFDM symbols allocated to the PDSCH. N_{DMRS}^{PRB} is the number of REs in one physical resource block (PRB) occupied by DMRS of the same code division multiplexing (CDM) group. Nₒₕ^{PRB} is the number of REs occupied by overhead within one PRB configured as higher signaling, and may be configured to one of 0, 6, 12, or 18. After this, the total number of REs allocated to the PDSCH, NRE, may be calculated. NRE is calculated as min(156, N′RE)·nPRB, where nPRB represents the number of PRBs allocated to the terminal.

Step 2: the number of temporary information bits, Ninfo, may be calculated as NRE*R*Qm*v. Here, R is the code rate, Qm is the modulation order, and information on this value may be transmitted by using the DCI MCS bitfield and a prearranged table. In addition, v is the number of allocated layers. If Ninfo≤3824, TBS may be calculated through step 3 below. Otherwise, TBS may be calculated through step 4.

Step 3: N′info may be calculated through the formulas for

$${N}_{info}^{′} = max ( 24 , {2}^{n} \cdot ⌊ \frac{{N}_{info}}{2} ⌋ )$$

and n=max(3, └ log₂(N_{info})┘−6). TBS may be determined as the value closest to N′info among the values that are not smaller than N′info in Table 15 below.

TABLE 15

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Step 4: N′info may be calculated through the formulas for

$${N}_{info}^{′} = max ( 3840 , {2}^{n} \times round ( \frac{{N}_{info - 24}}{2} ) )$$

and n=└ log₂(N_{info}−24)┘−5. TBS may be determined through the N′info value and [pseudo-code 1] below. Below C corresponds to the number of code blocks included in one TB.

```
[Start Pseudo-code 1]
  if R ≤ 1/4
      $TBS = 8 \cdot C \cdot ⌈ \frac{{N}_{info}^{′} + 24}{8 \cdot C} ⌉ - 24 ,$
      $where C = ⌈ \frac{{N}_{info}^{′} + 24}{3816} ⌉$
    else
      if N_{info}^{′} > 8424
        $TBS = 8 \cdot C \cdot ⌈ \frac{{N}_{info}^{′} + 24}{8 \cdot C} ⌉ - 24 ,$
        $where C = ⌈ \frac{{N}_{info}^{′} + 24}{8424} ⌉$
      else
        $TBS = 8 \cdot ⌈ \frac{{N}_{info}^{′} + 24}{8} ⌉ - 24$
    end if
  end if
[End of Pseudo-code 1]
```

In the NR system, when one CB is input to an LDPC encoder, parity bits may be added and output. In this case, the amount of parity bits may vary depending on the LDCP base graph. A method of transmitting all parity bits generated by LDPC coding for a specific input may be called as full buffer rate matching (FBRM), and a method of limiting the number of parity bits that may be transmitted may be called as limited buffer rate matching (LBRM). When resources are allocated for data transmission, the LDPC encoder output is generated as a circular buffer, and the bits of the generated buffer are repeatedly transmitted as many as the allocated resources, and in this case, the length of the circular buffer may be referred to as Ncb.

If the number of all parity bits generated by LDPC coding is N, then Ncb=N in the FBRM method. In the LBRM method, Ncb is min(N,Nref), the Nref is given by

$$⌊ \frac{T B {S}_{L B R M}}{C \cdot {R}_{L B R M}} ⌋ ,$$

and RLBRM may be determined as ⅔. In order to obtain TBSLBRM, the method for obtaining TBS described above is used but the TBSLBRM is calculated by assuming the maximum number of layers and maximum modulation order supported by the terminal in the cell, assuming that the maximum modulation order Qm is 8 when at least one BWP is configured to use an MCS table supporting 256QAM in the cell and 6 (64QAM) when not configured, assuming that the code rate is the maximum code rate of 948/1024, assuming that the NRE is 156·nPRB, and assuming that nPRB is nPRB,LBRM. The nPRB,LBRM may be given in Table 16 below.

TABLE 16

| Maximum number of PRBs across all | |
|---|---|
| configured BWPs of a carrier | n_{PRB, LBRM} |
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

The maximum data rate supported by the terminal in the NR system may be determined through Equation 2 below.

$$\\ \begin{matrix}data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{PRB}^{BW ( j ) , μ} \cdot 12}{{T}_{s}^{μ}} \cdot ( 1 - {OH}^{( j )} ) ) & Equation 2\end{matrix}$$

In Equation 2 above, J is the number of carriers grouped by frequency aggregation, Rmax=948/1024, v_{Layers}^{(j)} may refer to the maximum number of layers, Qₘ^{(j)} to the maximum modulation order, f(j) to the scaling index, and μ to the subcarrier spacing. f(j) may be reported by the terminal as one of 1, 0.8, 0.75, and 0.4, and μ may be given in Table 17 below.

TABLE 17

| | Δf = | |
|---|---|---|
| μ | 2^{μ} · 15 [kHZ] | Cyclic prefix |
| 0 | 15 | Normal |
| 1 | 30 | Normal |
| 2 | 60 | Normal, Extended |
| 3 | 120 | Normal |
| 4 | 240 | Normal |

In addition, Tₛ^{u} is the average OFDM symbol length, Tₛ^{u} may be calculated as

$$\\ \frac{{10}^{- 3}}{14 \cdot {2}^{μ}} ,$$

and N_{PRB}^{BW(j),μ} is the maximum number of RBs in BW(j). OH(j) is an overhead value, which may be given as 0.14 in the downlink of FR1 (band below 6 GHz) and 0.18 in the uplink, and 0.08 in the downlink of FR2 (band above 6 GHz) and 0.10 in the uplink. Through Equation 2, the maximum data rate in the downlink in a cell with a 100 MHz frequency bandwidth at a 30 kHz subcarrier spacing may be calculated as Table 18 below.

TABLE 18

| | | | | | | | data |
|---|---|---|---|---|---|---|---|
| f^{(j)} | v_{Layers}^{(j)} | Qₘ^{(j)} | Rmax | N_{PRB}^{BW(j),μ} | Tₛ^{μ} | OH^{(j)} | rate |
| 1 | 4 | 8 | 0.92578125 | 273 | 3.57143E−05 | 0.14 | 2337.0 |
| 0.8 | 4 | 8 | 0.92578125 | 273 | 3.57143E−05 | 0.14 | 1869.6 |
| 0.75 | 4 | 8 | 0.92578125 | 273 | 3.57143E−05 | 0.14 | 1752.8 |
| 0.4 | 4 | 8 | 0.92578125 | 273 | 3.57143E−05 | 0.14 | 934.8 |

On the other hand, the actual data rate that may be measured in the terminal's actual data transmission may be the amount of data divided by the data transmission time. This may be the value of TBS divided by TTI length when transmitting one TB, or sum of TBS divided by the TTI length when transmitting two TBs. As an example, as assumed in Table 15, the maximum actual data rate in the downlink in a cell with a 100 MHz frequency bandwidth at a 30 kHz subcarrier spacing may be determined as illustrated in Table 19 below according to the number of allocated PDSCH symbols.

TABLE 19

| | | | | | | | | | TTI | |
|---|---|---|---|---|---|---|---|---|---|---|
| | | | | | | | | | length | data rate |
| N_{symb}^{sh} | N_{DMRS}^{PRB} | N′_{RE} | N _{RE} | N _{info} | n | N′_{info} | C | TBS | (ms) | (Mbps) |
| 3 | 8 | 28 | 7644 | 226453.5 | 12 | 225,280 | 27 | 225,130 | 0.107143 | 2,104.48 |
| 4 | 8 | 40 | 10920 | 323505.0 | 13 | 319,488 | 38 | 319,784 | 0.142857 | 2,238.49 |
| 5 | 8 | 52 | 14196 | 420556.5 | 13 | 417,792 | 50 | 417,976 | 0.178571 | 2,340.67 |
| 6 | 8 | 64 | 17472 | 517608.0 | 13 | 516,096 | 62 | 516,312 | 0.214286 | 2,409.46 |
| 7 | 8 | 76 | 20748 | 614659.5 | 14 | 622,592 | 74 | 622,760 | 0.2500000 | 2,491.04 |
| 8 | 8 | 88 | 24024 | 711711.0 | 14 | 704,512 | 84 | 704,904 | 0.285714 | 2,467.16 |
| 9 | 8 | 100 | 27300 | 808762.5 | 14 | 802,816 | 96 | 803,304 | 0.321429 | 2,499.17 |
| 10 | 8 | 112 | 30576 | 905814.0 | 14 | 901,120 | 107 | 901,344 | 0.357143 | 2,523.76 |
| 11 | 8 | 124 | 33852 | 1002865.5 | 14 | 999,424 | 119 | 999,576 | 0.392857 | 2,544.38 |
| 12 | 8 | 136 | 37128 | 1099917.0 | 15 | 1,114,112 | 133 | 1,115,048 | 0.428571 | 2.601.78 |
| 13 | 8 | 148 | 40404 | 1196968.5 | 15 | 1,212,416 | 144 | 1,213,032 | 0.464286 | 2.612.68 |
| 14 | 8 | 160 | 43680 | 1294020.0 | 15 | 1,277,952 | 152 | 1,277,992 | 0.500000 | 2.555.98 |

Through Table 18, the maximum data rate supported by the terminal may be identified, and through Table 16, the actual data rate according to the allocated TBS may be identified. In this case, the actual data rate may be greater than the maximum data rate depending on the scheduling information.

In wireless communication systems, especially NR systems, the data rate that the terminal is able to support may be agreed upon between the base station and the terminal. This may be calculated by using the maximum frequency band, maximum modulation order, and maximum number of layers supported by the terminal. However, the calculated data rate may be different from the value calculated from the transport block size (TBS) and transmission time interval (TTI) length of the transport block (TB) used for actual data transmission.

Accordingly, there may be cases where the terminal is allocated a TBS larger than the value corresponding to the data rate the terminal supports, and to prevent this, there may be restrictions on the TBS that may be scheduled depending on the data rate supported by the terminal.

Because the terminal is generally far away from the base station, the signal transmitted from the terminal is received by the base station after a propagation delay. The propagation delay is the value of the path through which radio waves are transmitted from the terminal to the base station divided by the speed of light, and may generally be the distance from the terminal to the base station divided by the speed of light. In an embodiment, for a terminal located 100 km away from a base station, the signal transmitted from the terminal is received by the base station after approximately 0.34 msec. Conversely, the signal transmitted from the base station is also received by the terminal after approximately 0.34 msec. As described above, the time for the signal transmitted from the terminal to arrive at the base station may vary depending on the distance between the terminal and the base station. Accordingly, when multiple terminals located in different locations transmit signals at the same time, the arrival times at the base station may all be different. In order to solve this problem and allow signals transmitted from multiple terminals to arrive at the base station simultaneously, the uplink signal transmission time for each terminal may be varied depending on the location. In 5G, NR and LTE systems, this is called timing advance (TA).

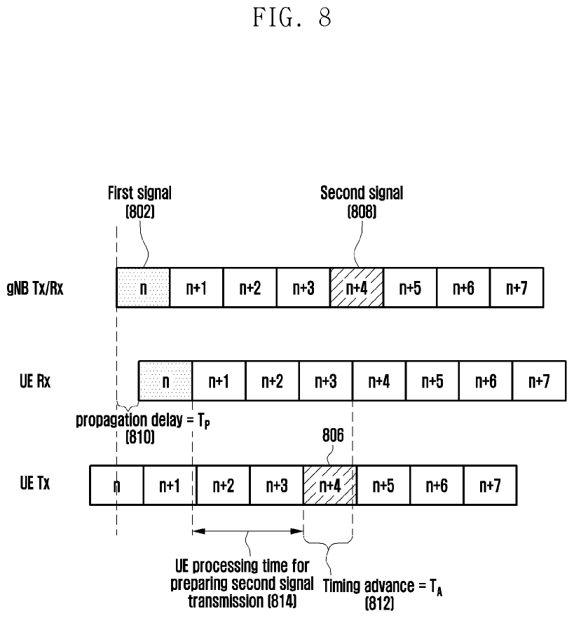

FIG. 8 illustrates the processing time of a terminal according to timing advance when the terminal receives a first signal and transmits a second signal in response to the first signal in a 5G or NR system according to an embodiment of the present disclosure.

When the base station transmits a first signal (uplink scheduling grant (UL grant) or downlink control signal and data (DL grant and DL data)) to the terminal in slot n 802, the terminal may receive the first signal in slot n 804. In this case, the terminal may receive the signal later than the time the base station transmitted the signal by the propagation delay time (Tp) 810. According to an embodiment, when the terminal receives the first signal in slot n 804, the terminal transmits the corresponding second signal (HARQ-ACK/NACK for uplink data or downlink data) in slot n+4 806. Even when the terminal transmits a signal to the base station, in order to arrive at the base station at a specific time, the terminal may transmit the second signal at timing 806, which is earlier than slot n+4 according to the standard of the signal received by the terminal by the timing advance (TA) 812. Accordingly, in this embodiment, the time that the terminal may prepare to receive uplink scheduling approval, transmit uplink data or receive downlink data, and transmit HARQ ACK or NACK may be the time corresponding to 3 slots minus the TA (814).

To determine the above-described timing, the base station may calculate the absolute value of the TA of the corresponding terminal. When the terminal initially accesses the base station, the base station may calculate the absolute value of TA by adding or subtracting the change in TA value transmitted through higher signaling from the TA value first transmitted to the terminal in the random access step. In the disclosure, the absolute value of TA may be the value obtained by subtracting the start time of the nth TTI received by the terminal from the start time of the nth TTI transmitted by the terminal.

On the other hand, one of the important criteria for cellular wireless communication system performance is packet data latency. For this purpose, in the LTE system, signals are transmitted and received in subframe units with a transmission time interval (hereinafter, TTI) of 1 ms. In an LTE system operating as described above, a terminal (short-TTI UE) with a transmission time interval shorter than 1 ms may be supported. On the other hand, in a 5G or NR system, the transmission time interval may be shorter than 1 ms. Short-TTI terminals are suitable for services such as Voice over LTE (VoLTE) services and remote control where latency is important. In addition, short-TTI terminals are a means of realizing the mission-critical Internet of Things (IoT) based on cellular.

In a 5G or NR system, when the base station transmits a PDSCH including downlink data, the DCI scheduling the PDSCH indicates the K1 value, which is a value corresponding to timing information at which the terminal transmits HARQ-ACK information of the PDSCH. HARQ-ACK information may be transmitted by the terminal to the base station when it is not indicated to be transmitted before symbol L1, including timing advance. That is, HARQ-ACK information may be transmitted from the terminal to the base station at a time equal to or later than symbol L1, including timing advance. When HARQ-ACK information is indicated to be transmitted before symbol L1 including timing advance, the HARQ-ACK information may not be valid HARQ-ACK information in HARQ-ACK transmission from the terminal to the base station.

Symbol L1 may be the first symbol in which a cyclic prefix (CP) starts after Tproc,1 from the last time point of the PDSCH. Tproc,1 may be calculated as in Equation 3 below.

T_{proc,1}=(N₁+d_{1,1})(2048+144)k2^{-u}·T_{c}. Equation 3

In Equation 3 described above, N1, d1,1, d1,2, k, μ, and TC be defined as follows.
When HARQ-ACK information is transmitted through the uplink control channel (PUCCH), d1,1=0, and when it is transmitted through the uplink shared channel, data channel (PUSCH), d1,1=1.
When the terminal receives a plurality of activated configuration carriers or carriers, the maximum timing difference between the carriers may be reflected in the second signal transmission.
In the case of PDSCH mapping type A, that is, when the first DMRS symbol location is the 3rd or 4th symbol of the slot, if the location index i of the last symbol of the PDSCH is less than 7, d1,2=7−i is defined.
In the case of PDSCH mapping type B, that is, when the first DMRS symbol location is the first symbol of the PDSCH, if the length of the PDSCH is 4 symbols, d1,2=3, and if the length of the PDSCH is 2 symbols, d1,2=3+d, and d is the number of symbols overlapping between the PDSCH and the PDCCH including the control signal for scheduling the PDSCH.
N1 is defined according to μ as illustrated in Table 20 below. μ=0, 1, 2, and 3 refers to subcarrier spacing of 15 kHz, 30 kHz, 60 kHz, and 120 kHz, respectively.

TABLE 20

PDSCH decoding time N₁[symbols]

| | No additional PDSCH | Additional PDSCH |
|---|---|---|
| μ | DMRS configured | DMRS configured |
| 0 | 8 | 13 |
| 1 | 10 | 13 |
| 2 | 17 | 20 |
| 3 | 20 | 24 |

The N₁ value provided in Table 20 above may be a different value depending on UE capability. T_{c}, Δfₘₐₓ, N_{f}, k, Tₛ, Δf_{ref}, and N_{f,ref} are defined as follows, respectively.
T_{c}=1/(Δf_{Max}·N_{f}), Δfₘₐₓ=480·10³ Hz, N_{f}=4096, k=Tₛ/T_{c}=64, Tₛ=1/(Δf_{Max}·N_{f,ref}), Δf_{ref}=15·10³, N_{f,ref}=2048.

In addition, in a 5G or NR system, when the base station transmits control information including uplink scheduling approval, the terminal may indicate a K2 value corresponding to timing information for transmitting uplink data or PUSCH.

When the PUSCH is not indicated to be transmitted before symbol L2, including timing advance, the terminal may transmit the PUSCH to the base station. That is, the PUSCH may be transmitted from the terminal to the base station at a time equal to or later than symbol L2, including timing advance. When the PUSCH is indicated to be transmitted before symbol L2, including timing advance, the terminal may ignore the uplink scheduling grant control information from the base station.

Symbol L2 may be the first symbol in which the CP of the PUSCH symbol that may be transmitted after Tproc,2 from the last point of the PDCCH including the scheduling grant starts. Tproc,2 may be calculated as in Equation 4 below.

T_{proc,2}=max((N₂+d_{2,1})(2048+144)·k2^{-u}·T_{c},d_{2,2}) Equation 4

In Equation 4 described above, N2, d2,1, k, μ, and TC be defined as follows.
When the first symbol among the PUSCH allocated symbols includes only DMRS, d2,1=0, otherwise, d2,1=1.
When the terminal is configured with a plurality of activated configuration carriers or carriers, the maximum timing difference between the carriers may be reflected in the second signal transmission.
N2 is defined according to as illustrated in Table 21 below. μ=0, 1, 2, and 3 refers to subcarrier spacing of 15 kHz, 30 kHz, 60 kHz, and 120 kHz, respectively.

TABLE 21

| | PUSCH preparation |
|---|---|
| μ | time N₂ [symbols] |
| 0 | 10 |
| 1 | 12 |
| 2 | 23 |
| 3 | 36 |

The N2 value provided in Table 21 above may be a different value depending on UE capability. Tc, Δfmax, Nf, k, Ts, Δfref, and Nf,ref are defined as follows, respectively.
T_{c}=1/(Δf_{Max}·N_{f}), Δfₘₐₓ=480·10³ Hz, N_{f}=4096, k=Tₛ/T_{c}=64, Tₛ=1/(Δf_{Max}·N_{f,ref}), Δf_{ref}=15·10³, N_{f,ref}=2048.

On the other hand, the 5G or NR system may configure a frequency band part (BWP) within one carrier and specify that a specific terminal transmit and receive within the configured BWP. This may be aimed at reducing power consumption of the terminal. The base station may configure multiple BWPs and change the activated BWP in control information. The time that the terminal may use when the BWP changes may be defined as in Table 22 below.

TABLE 22

| Frequency | | Type 1 | Type 2 |
|---|---|---|---|
| range | Scenario | delay (us) | delay (us) |
| 1 | 1 | 600 | 2000 |
| | 2 | 600 | 2000 |
| | 3 | 600 | 2000 |
| | 4 | 400 | 950 |
| 2 | 1 | 600 | 2000 |
| | 2 | 600 | 2000 |
| | 3 | 600 | 2000 |
| | 4 | 400 | 950 |

In Table 22, frequency range FR may refer to a frequency band below 6 GHz, and frequency range FR2 may refer to a frequency band above 6 GHz and may be classified as illustrated in Table 22 above. Typically, FR2 may refer to a high frequency band close to the mmWave band, and FR may refer to a relatively low frequency band compared to FR2. In the above-described embodiment, Type 1 and Type 2 may be determined according to UE capability. In the above-described embodiment, scenarios 1, 2, 3, and 4 are given in Table 23 below.

TABLE 23

| | Center frequency | Center frequency |
|---|---|---|
| | change | constant |
| Frequency bandwidth | Scenario 3 | Scenario 2 |
| change | | |
| Frequency bandwidth | Scenario 1 | Scenario 4, if subcarrier |
| constant | | spacing is changed |

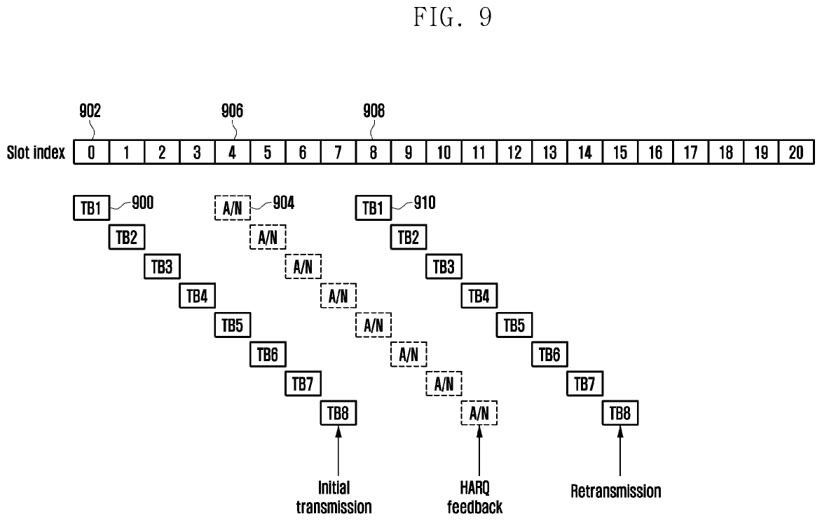

FIG. 9 illustrates an example of scheduling and transmitting data (e.g., TB) according to a slot, receiving HARQ-ACK feedback for the data, and performing retransmission according to the feedback. In FIG. 9, TB1 900 is initially transmitted in slot 0 902, and corresponding ACK/NACK feedback 904 is transmitted in slot 4 906. If the initial transmission of TB1 fails and NACK is received, retransmission 910 for TB1 may be performed in slot 8 908. The timing at which ACK/NACK feedback is transmitted and the timing at which retransmission is performed may be predetermined or may be determined according to values indicated in control information and/or higher layer signaling.

FIG. 9 illustrates an example of scheduled transmission from TB1 to TB8 sequentially according to slot, starting from slot 0. For example, this may be transmitted by assigning HARQ process IDs 0 to 7 to TB1 to TB8, respectively. If the number of HARQ process IDs that the base station and the terminal may use is only 4, it may not be possible to continuously transmit for 8 different TBs.

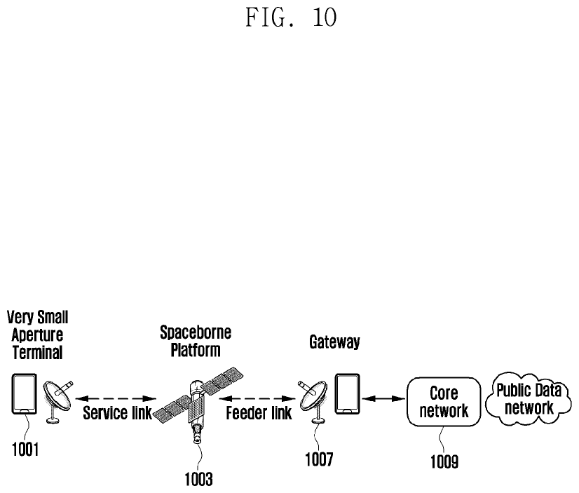

FIG. 10 illustrates an example of a communication system using a satellite according to an embodiment of the disclosure. For example, when the terminal 1001 transmits a signal to the satellite 1003 through a service link, the satellite 1003 transmits a signal to the base station 1005 through a feeder link, and the base station 1005 processes the received signal and transmits a signal including a request for follow-up operation to the terminal 1001, which may be transmitted again through the satellite 1003. Because the distance between the terminal 1001 and the satellite 1003 is long, and the distance between the satellite 1003 and the base station 1005 is also long, the time required to transmit and receive data from the terminal 1001 to the base station 1005 becomes long.

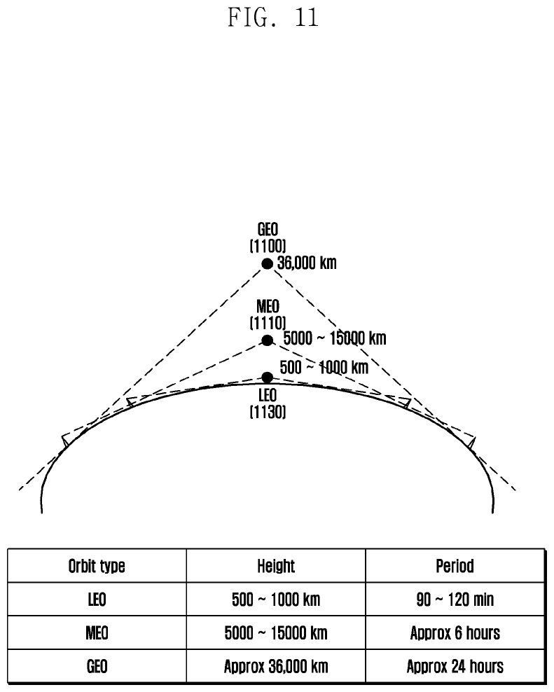

FIG. 11 illustrates the Earth orbital period of a communication satellite according to the altitude or height of the satellite according to an embodiment of the disclosure. Satellites for communication may be classified into low Earth orbit (LEO), middle Earth orbit (EO), and geostationary Earth orbit (GEO) depending on the satellite's orbit. Generally, the GEO 1100 refers to a satellite with an altitude of approximately 36,000 km, the MEO 1110 refers to a satellite with an altitude of 5,000 to 15,000 km, and the LEO may refer to a satellite with an altitude of 500 to 1,000 km. Of course, it is not limited to the above example.

According to an embodiment of the disclosure, the Earth's orbital period varies depending on each altitude, and for GEO 1100, the Earth's orbital period is approximately 24 hours, for MEO 1110, it is approximately 6 hours, and for LEO 1130, it is approximately 90 to 120 minutes. Low-Earth orbit (˜2,000 km) satellites may have an advantage over geostationary orbit (36,000 km) satellites in terms of propagation delay (this may be understood as the time taken for the signal transmitted from the transmitter to reach the receiver) and loss due to their relatively low altitude.

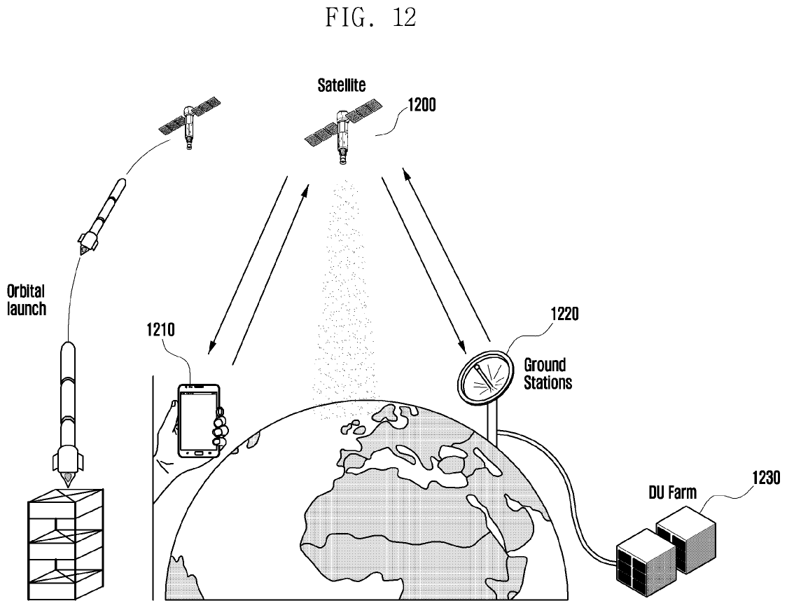

FIG. 12 illustrates satellite-to-terminal direct communication according to an embodiment of the present disclosure. A satellite 1200, located at an altitude of 100 km or more by a rocket, transmits and receives signals with a terminal 1210 on the ground, and also transmits and receives signals with a ground station 1220 connected to a DU farm 1230 on the ground.

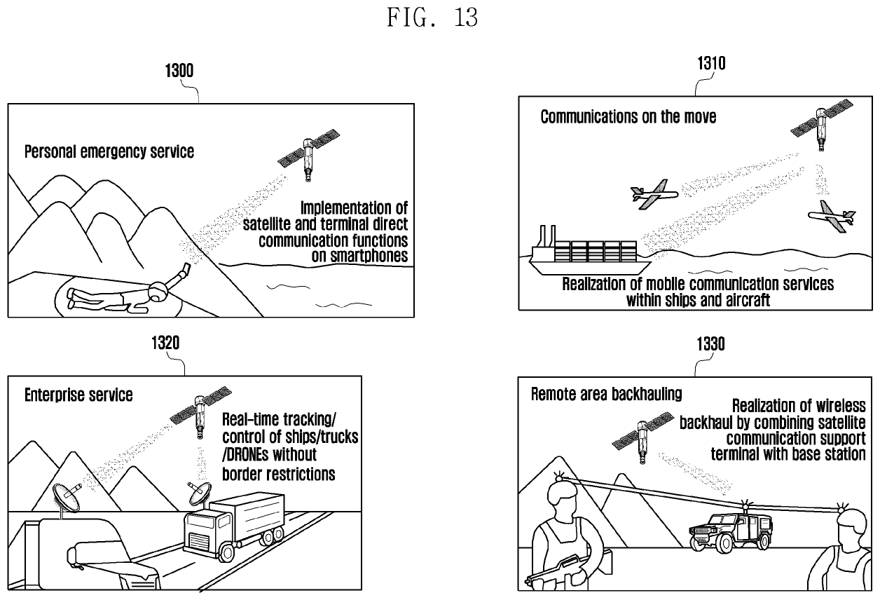

FIG. 13 illustrates a utilization scenario of satellite-to-terminal direct communication according to an embodiment of the present disclosure.

Satellite-to-device direct communication may support specialized communication services in a form that complements the coverage limitations of terrestrial networks. As an example, by implementing a satellite-to-device direct communication function in the user terminal, it is possible to transmit and receive emergency rescue and/or disaster signals for users in places other than terrestrial network communication coverage (1300), mobile communication services may be provided to users in areas where terrestrial network communication is not possible, such as ships and/or aviation (1310), it is possible to track and control the location of ships, trucks, and/or drones in real time without border restrictions (1320), and it is also possible to utilize satellite communication to function as a backhaul for the base station and perform the backhaul function when physically distant by supporting the satellite communication function in the base station (1330).

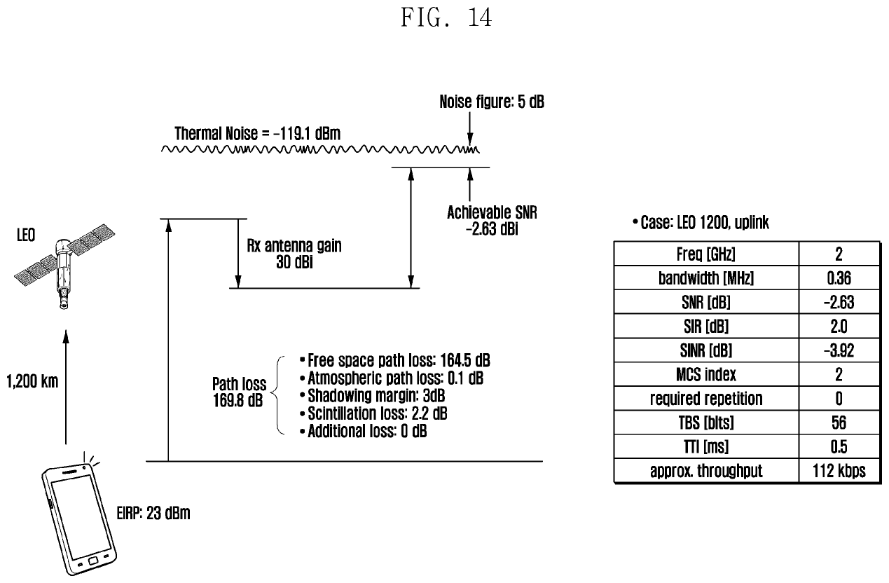

FIG. 14 illustrates an example of calculating an expected data throughput in the uplink when a LEO satellite at an altitude of 1200 km and a terminal on the ground perform direct communication according to an embodiment of the present disclosure.

In the uplink, when the transmission power effective isotropic radiated power (EIRP) of the terrestrial terminal is 23 dBm, the path loss of the wireless channel to the satellite is 169.8 dB, and the satellite reception antenna gain is 30 dBi, the achievable signal-to-noise ratio (SNR) is estimated to be −2.63 dB. In this case, path loss may include path loss in outer space, loss in the atmosphere, etc. Assuming the signal-to-interference ratio (SIR) is 2 dB, the signal-to-interference and noise ratio (SINR) is calculated to be −3.92 dB, and in this case, when 30 kHz subcarrier spacing and frequency resources of 1 PRB are used, it may be possible to achieve a transmission rate of 112 kbps.

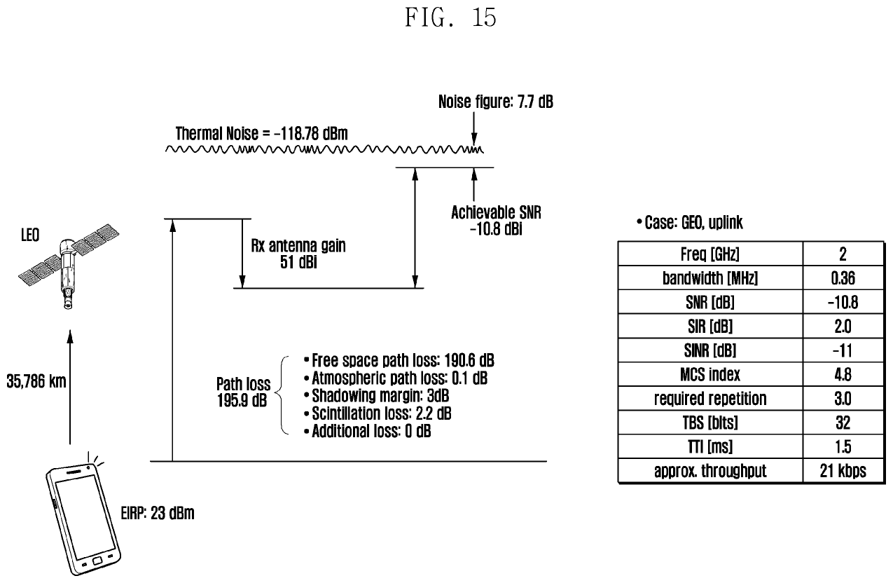

FIG. 15 illustrates an example of calculating an expected data throughput in the uplink when a GEO satellite at an altitude of 35,786 km and a terminal on the ground perform direct communication according to an embodiment of the present disclosure.

In the uplink, when the transmission power EIRP of the terrestrial terminal is 23 dBm, the path loss of the wireless channel to the satellite is 195.9 dB, and the satellite reception antenna gain is 51 dBi, the achievable SNR is estimated to be −10.8 dB. In this case, path loss may include path loss in outer space, loss in the atmosphere, etc. Assuming the SIR is 2 dB, the SINR is calculated to be −11 dB, and in this case, when 30 kHz subcarrier spacing and frequency resources of 1 PRB are used, it may be possible to achieve a transmission rate of 21 kbps, which may be the result of performing three repeated transmissions.

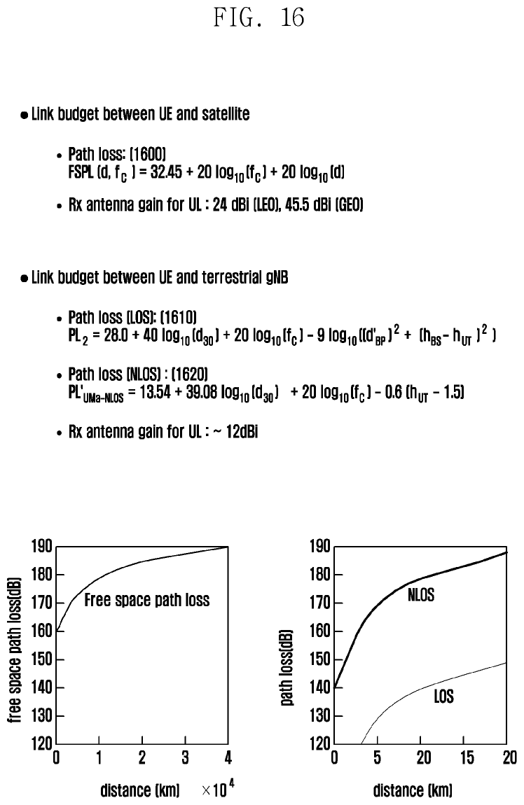

FIG. 16 illustrates path loss values according to a path loss model between a terminal and a satellite, and path loss according to a path loss model between a terminal and a terrestrial network communication base station according to an embodiment of the present disclosure.

In FIG. 16, d corresponds to the distance and fc is the frequency of the signal. In free space where communication between a terminal and a satellite is performed, the path loss (FSPL, 1600) is inversely proportional to the square of the distance, but the path loss (PL2, PL′Uma-NLOS, 1610, 1620) on the ground where air exists where communication between the terminal and the terrestrial gNB is performed may be inversely proportional to approximately the fourth power of the distance. d3D refers to the straight line distance between the terminal and the base station, hBS is the height of the base station, and hUT is the height of the terminal. d′BP=4×hBS×hUT×fc/c. fc is the center frequency in Hz, and c is the speed of light in m/s.

In satellite communications (or Non-Terrestrial Network, NTN), a Doppler shift, that is a frequency shift (offset) of the transmission signal, occurs as the satellite continuously moves rapidly.

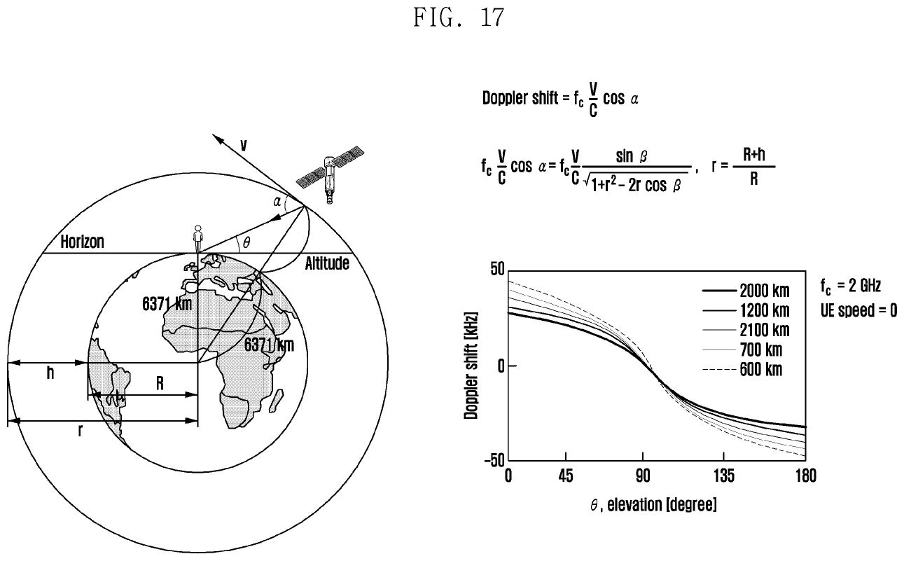

FIG. 17 illustrates the altitude and location of a satellite, and a formula and result for calculating the amount of Doppler shift experienced by a signal transmitted from a satellite depending on the location of the terminal user on the ground when the signal is received by the ground user, according to an embodiment of the present disclosure.

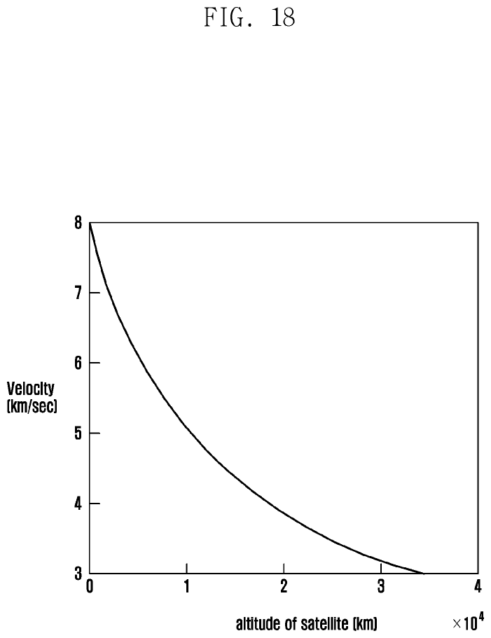

The Earth's radius is R, h is the altitude of the satellite, v is the speed at which the satellite orbits the Earth, and fc is the frequency of the signal. The speed of the satellite may be calculated from the satellite's altitude, which is the speed at which the gravitational force, which is the force with which the Earth pulls the satellite, and the centripetal force generated as the satellite orbits are equal, and this may be calculated as illustrated in FIG. 18.

FIG. 18 illustrates the speed of a satellite calculated from the altitude of the satellite according to an embodiment of the present disclosure.

As identified in FIG. 17, the angle α is determined by the elevation angle θ, so the value of Doppler shift is determined according to the elevation angle θ.

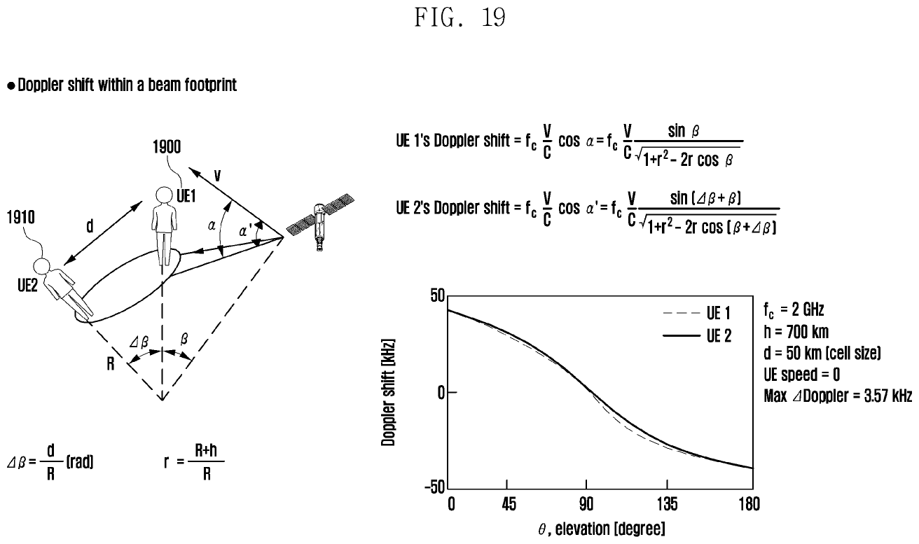

FIG. 19 illustrates the Doppler shift experienced by different terminals within one beam transmitted from a satellite to the ground according to an embodiment of the present disclosure.

In FIG. 19, the Doppler shift experienced by terminal 1 1900 and terminal 2 1910 according to the altitude angle θ is calculated. This is the result assuming a center frequency of 2 GHz, a satellite altitude of 700 km, a beam diameter of 50 km from the ground, and a terminal speed of 0. In addition, the Doppler shift calculated in this disclosure ignores the effect of the Earth's rotation speed, and this is because the effect is considered to be small because the Earth's rotation speed is slower than the satellite's speed.

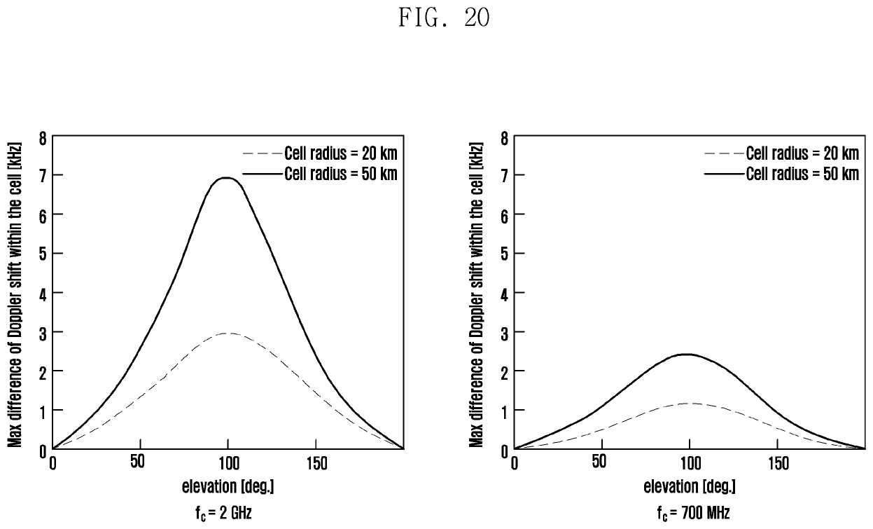

FIG. 20 illustrates the difference in Doppler shift occurring within one beam depending on the location of a satellite determined from the altitude angle according to an embodiment of the present disclosure.

It may be seen that the difference in Doppler shift within the beam (or cell) is the largest when the satellite is located directly above the beam, that is, when the elevation angle is 90 degrees. This may be because when the satellite is above the center, the Doppler shift values at one end and the other end of the beam have positive and negative values, respectively.

On the other hand, in satellite communication, because the satellite is far away from the user on the ground, a large delay time occurs compared to terrestrial network communication.

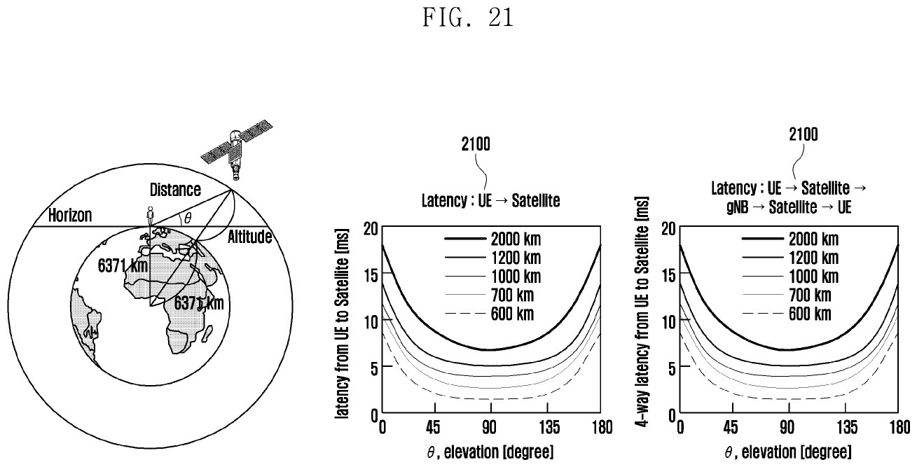

FIG. 21 illustrates the delay time from a terminal to a satellite and the round-trip delay time between the terminal-satellite-base station according to the location of the satellite determined according to the altitude angle according to an embodiment of the present disclosure.

The first graph 2100 illustrates the delay time from the terminal to the satellite, and the second graph 2110 illustrates the round-trip delay time between the terminal-satellite-base station. In this case, it is assumed that the delay time between the satellite and the base station is the same as the delay time between the terminal and the satellite.

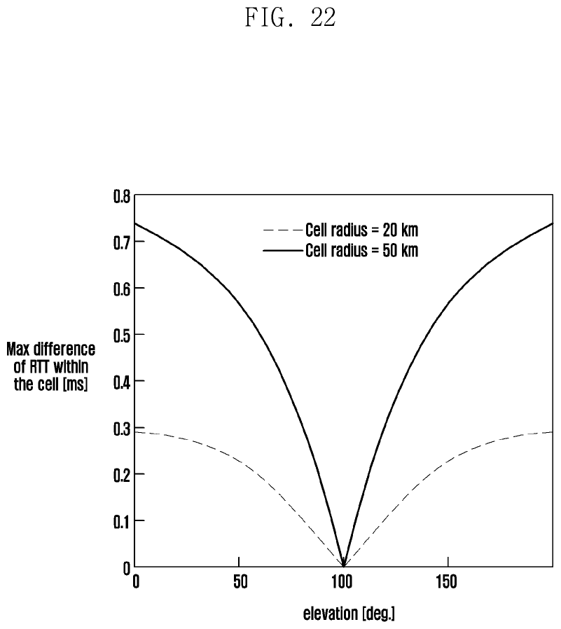

FIG. 22 illustrates the maximum difference value of the round-trip delay time that varies depending on the user's location within one beam according to an embodiment of the present disclosure.

For example, when the beam radius (or cell radius) is 20 km, the difference in round-trip delay time to the satellite experienced differently by terminals at different locations within the beam depending on the satellite's location may be considered to be about 0.28 ms or less.

In satellite communication, when a terminal transmits and receives signals to and from a base station, the signal may be transmitted through a satellite. That is, in the downlink, the satellite receives a signal transmitted from the base station to the satellite and then delivers the signal to the terminal, and in the uplink, the satellite receives a signal transmitted from the terminal and then delivers the signal to the base station. After receiving the signal, the satellite may only perform frequency shifting and then transmit the same, or it may be possible to perform signal processing such as decoding and re-encoding based on the received signal and transmit the same.

In case of LTE or NR, the terminal may access the base station through the following procedure.
Step 1: the terminal receives a synchronization signal (or synchronization signal block (SSB), which may include a broadcast signal) from the base station. The synchronization signal may include a primary synchronization signal (PSS), a secondary synchronization signal (SSS), and a physical broadcast channel (PBCH). The synchronization signal may include information such as slot boundary, frame number, downlink configuration, and uplink configuration of the signal transmitted from the base station. In addition, through the synchronization signal, the terminal may obtain subcarrier offset, scheduling information for system information transmission, etc.
Step 2: the terminal receives system information (system information block: SIB) from the base station. SIB may include information for initial access and random access. Information for performing random access may include resource information for transmitting the random access preamble.
Step 3: a random access preamble (or message 1, msg1) is transmitted to the random access resource configured in step 2. The preamble may be a signal determined based on the information configured in step 2 by using a predetermined sequence. The base station receives the preamble transmitted from the terminal. The base station attempts to receive the preamble configured from resources configured by the base station without knowing which terminal transmitted the preamble, and if reception is successful, the base station may know that at least one terminal transmitted the preamble.
Step 4: when the preamble is received in step 3, the base station transmits a random access response (RAR, or message 2, msg2) in response. The terminal that transmitted the random access preamble in step 3 may attempt to receive the RAR transmitted from the base station in this step. The RAR is transmitted on the PDSCH, and the PDCCH scheduling the PDSCH is transmitted together or in advance. A CRC scrambled with the RA-RNTI value is added to the DCI for scheduling the RAR, and the DCI (and CRC) is channel coded and then mapped to the PDCCH and transmitted. RA-RNTI may be determined based on the time and frequency resources at which the preamble in step 3 is transmitted.

The maximum time limit for the terminal that transmitted the random access preamble in step 3 to receive the RAR may be configured in the SIB transmitted in step 2. The maximum time limit may be configured to be limited, for example, up to 10 ms or 40 ms. That is, if the terminal that transmitted the preamble in step 3 does not receive the RAR within the time determined based on, for example, the configured maximum time of 10 ms, the terminal may transmit the preamble again. The RAR may include scheduling information that allocates resources for signals to be transmitted from the terminal in the next step, step 5.

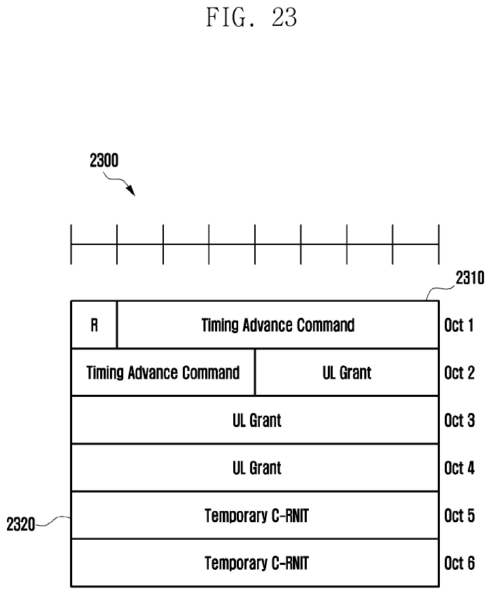

FIG. 23 illustrates an example of the information structure of RAR (MAC payload) according to an embodiment of the present disclosure.

This may be a MAC payload format (fallback RAR) of the Msg B. The RAR 2300 may be a MAC PDU, for example, and may also include information 2310 (e.g., timing advanced command field) on timing advance (TA) to be applied by the terminal and a temporary C-RNTI value 2320 to be used from the next step.
R field: a reserved bit, for example, may be configured to “0.”
Timing advanced command field 2310: the timing advance command field indicates an index value TA used to control the amount of timing adjustment that the MAC entity may apply. The size of the timing advance command field is, for example, 12 bits.
UL grant field: the UL Grant field indicates resources to be used in the uplink, and the size of the UL Grant field is, for example, 27 bits.
Temporary C-RNTI field 2320: the temporary C-RNTI field indicates a temporary identifier used by the MAC entity during random access, and the size of the temporary C-RNTI field may be 16 bits, for example.
Step 5: the terminal that received the RAR in step 4 transmits message 3 (msg3) to the base station according to the scheduling information included in the RAR. The terminal may transmit msg3 including its own unique ID value. The base station may attempt to receive msg3 according to the scheduling information the base station transmitted in step 4.
Step 6: the base station receives msg3, identifies the ID information of the terminal, generates message 4 (msg4) including the ID information of the terminal, and transmits the message 4 to the terminal. The terminal that transmitted msg3 in step 5 may then attempt to receive msg4 to be transmitted in step 6. After decoding, the terminal that has received Msg4 may compare the ID value included in msg4 with the ID value the terminal transmitted in step 5 to identify whether the msg3 the terminal transmitted has been received by the base station. After the terminal transmits msg3 in step 5, there may be a limit to the time until the terminal receives msg4 in this step, and this maximum time may also be configured from the SIB in step 2.

When the initial access procedure using the above steps is applied to satellite communication, the propagation delay time required in satellite communication may be a problem. For example, in step 3, the period (random access window) during which the terminal may transmit the random access preamble (or PRACH preamble) and receive RAR in step 4, that is, the maximum time it takes to receive, may be configured through ra-ResponseWindow, this maximum time may be configured to a maximum of about 10 ms in the conventional LTE or 5G NR system.

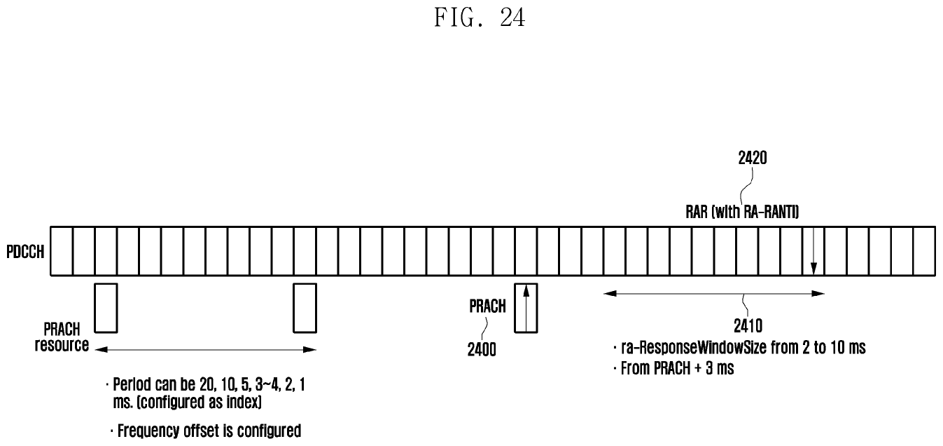

FIG. 24 illustrates an example of the relationship between PRACH preamble configuration resources and RAR reception time in an LTE system according to an embodiment of the present disclosure.

Referring to FIG. 24, in the case of LTE, a random access window 2410 starts 3 ms after a random access preamble (PRACH) is transmitted (2400), and when the terminal receives RAR within the random access window (2420), it may be determined that the transmission of the PRACH preamble is successful.

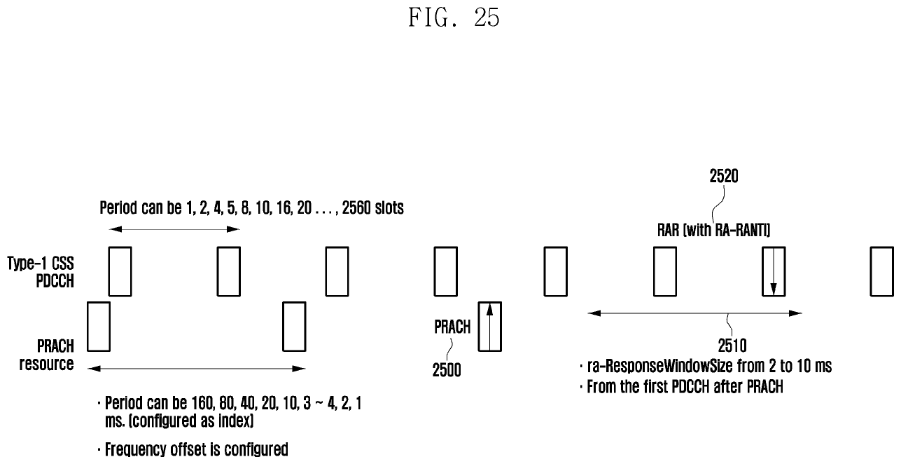

FIG. 25 illustrates an example of the relationship between PRACH preamble configuration resources and RAR reception time in a 5G NR system according to an embodiment of the present disclosure.

Referring to FIG. 25, in the case of NR, a random access window 2510 starts from the control information area for RAR scheduling that first appears after transmitting the random access preamble (PRACH) 2500. When the terminal receives the RAR within the random access window 2520, it may be determined that transmission of the PRACH preamble is successful.

As an example, TA for uplink transmission timing in the 5G NR system may be determined as follows. First, T_{c}=1/(Δfₘₐₓ·N_{f}), where Δfₘₐₓ=480·103 Hz and N_{f}=4096. In addition, k=Tₛ/T_{c}=64, Tₛ=1/(Δf_{ref}·N_{f,ref}), Δf_{ref}=15·103 Hz, and N_{f,ref}=2048, respectively.

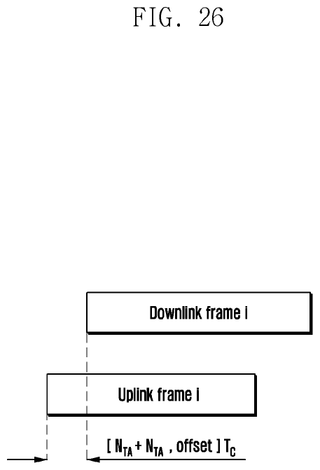

FIG. 26 illustrates an example of the timing of a downlink frame and an uplink frame of a terminal according to an embodiment of the present disclosure.

The terminal may perform uplink transmission by advancing the uplink frame by T_{TA}=(N_{TA}+N_{TA,offset})TC based on the downlink frame timing. In the above, the value of N_{TA} may be transmitted through RAR or determined based on MAC CE, and N_{TA,offset} may be configured for the terminal or determined based on a predetermined value.

The RAR of the 5G NR system may indicate a TA value, and in this case, the TA may indicate one of 0, 1, 2, . . . , 3846. In this case, if the subcarrier spacing (SCS) of RAR is 2^{μ}·15 kHz, N_{TA} may be determined as N_{TA}=T_{A}·16·64/2^{μ}. After the terminal completes the random access process, the change value of the TA may be indicated from the base station, and this may be indicated through MAC CE, etc. TA information indicated through MAC CE may indicate one value among 0, 1, 2, . . . , 63, which is added to or subtracted to or from the existing TA value and used to calculate a new TA value, and as a result, the TA value may be newly calculated as N_{TA_new}=T_{A_old}+(T_{A}−31)·16·64/2^{μ}. The TA value indicated in this way may be applied by the terminal to uplink transmission after a predetermined period of time.

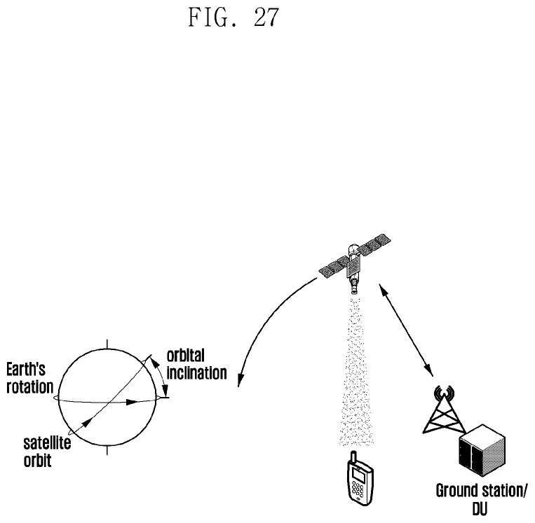

FIG. 27 illustrates an example of continuous movement of a satellite in a terminal located on or on the ground of the Earth as the satellite orbits around the Earth in a satellite orbit according to an embodiment of the present disclosure.

Because the distance between the terminal and the satellite varies depending on the elevation angle at which the terminal looks at the satellite, the propagation delay between the terminal, the satellite, and the base station varies.

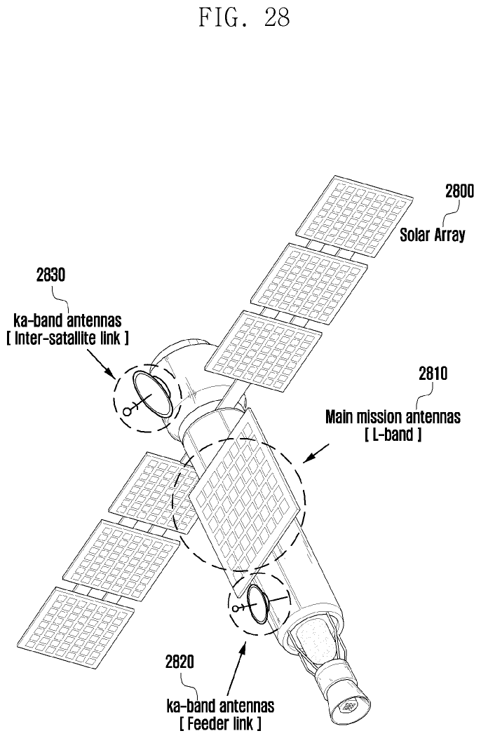

FIG. 28 illustrates an example of the structure of an artificial satellite according to an embodiment of the present disclosure.

The satellite may be composed of solar panels or solar arrays 2800 for photovoltaic or solar power generation, transmission/reception antennas (main mission antennas) 2810 for communication with a terminal, transmission/reception antennas (feeder link antennas) 2820 for communication with a ground station, transmission/reception antennas (inter-satellite link) 2830 for inter-satellite communication, a processor to control transmission and reception and perform signal processing, etc. Of course, it is not limited to the above example, and the artificial satellite may include more or less configurations than those illustrated in FIG. 28. In addition, according to an embodiment of the disclosure, if inter-satellite communication is not supported depending on the satellite, an antenna for transmitting and receiving inter-satellite signals may not be deployed. In FIG. 28, although it is illustrated that the L band of 1 to 2 GHz is used for communication with the terminal, it may also be possible to use high frequency bands such as K band (18 to 26.5 GHz), Ka band (26.5 to 40 GHz), and Ku band (12 to 18 GHz).

In addition, in various embodiments of the disclosure, the term “base station (BS)” may refer to transmit point (TP), transmit-receive point (TRP), enhanced node B (eNodeB or eNB), 5G base station (gNB), macrocell, femtocell, WiFi access point (AP), or any component (or set of components) configured to provide wireless access, such as other wireless enabled devices, based on the type of wireless communication system. The base station may provide one or more wireless protocols, for example, wireless access according to 5G 3GPP new radio interface/access (NR), long-term evolution (LTE), advanced LTE (LTE advanced: LTE-A), high speed packet access (HSPA), Wi-Fi 802.11a/b/g/n/ac, etc.

In addition, in various embodiments of the disclosure, the term “terminal” may refer to arbitrary components, such as “user equipment (UE),” “mobile station,” “subscriber station,” “remote terminal,” “wireless terminal,” “receive point,” or “user device.” For convenience, the term “terminal” is used in the disclosure, regardless of to refer to a device that accesses a base station, regardless of whether the terminal should be considered as a mobile device (such as a mobile phone or smartphone) or should be considered as a fixed device (such as a desktop computer or vending machine).

In addition, in various embodiments of the disclosure, the term “TA” may be used interchangeably with “TA information,” “TA value,” or “TA index.”

In various embodiments of the disclosure, data or control information transmitted from a base station to a terminal may be referred to as a first signal, and an uplink signal associated with the first signal may be referred to as a second signal. For example, the first signal may include DCI, UL grant, PDCCH, PDSCH, RAR, etc., and the second signal associated with the first signal may include PUCCH, PUSCH, msg 3, etc.

In addition, there may be an association between the first signal and the second signal. As an example, when the first signal is a PDCCH including a UL grant for uplink data scheduling, the second signal corresponding to the first signal may be a PUSCH including uplink data. On the other hand, the gap between the time points at which the first signal and the second signal are transmitted and received may be a value predetermined between the terminal and the base station. In contrast, the gap between the time points at which the first signal and the second signal are transmitted and received may be determined by an indication from the base station or by a value transmitted through higher signaling.

In direct terminal-satellite communication, because the distance between the terminal-satellite and satellite-base station is long and the satellite is constantly moving, a time offset occurs due to delay time, etc. when a signal transmitted by the base station or terminal is received by the terminal or base station. Accordingly, the disclosure provides a method and device in which a base station indicates time offset information and a terminal corrects the time offset accordingly, so that the time offset may be corrected. The embodiment below is described assuming communication between a terminal, a satellite, and a ground station, but communication between a satellite base station and a terminal is not excluded. In the disclosure, time offset may be used interchangeably with timing advance. The method and device provided in various embodiments of the disclosure may be applied to not only satellite communication systems but also terrestrial communication systems. In addition, the following embodiments may be operated in combination with each other.

In an embodiment of the disclosure, a method and device for the terminal itself to directly determine (e.g., calculate) the TAvalue and apply the determined TAvalue are described when the terminal transmits an uplink signal to a satellite or base station. In addition, an embodiment of the disclosure describes a method and device in which the base station or satellite instructs the terminal on the TA value to be applied when the terminal transmits an uplink signal to the satellite or base station, and thus the terminal transmits an uplink signal by applying the indicated TA value. In addition, an embodiment of the disclosure describes a method and device for adaptively determining a TA value to be applied when the terminal transmits an uplink signal to the satellite or base station. More specifically, an embodiment of the disclosure describes a method and device in which the terminal determines the TA value by itself, and as described in the disclosure, the base station or satellite indicates the terminal a TA value and the terminal determines the TA value by adaptively selecting one of the methods for applying the indicated TA value.

First, the terminal may compare the uplink transmission time with the downlink reception time for uplink synchronization, and advance the uplink transmission time by TTA compared to the downlink reception time based on the comparison result. TTA calculated for TA for satellite communication may be expressed as Equation 5 below.

T_{TA}=(N_{TA}+N_{TA,UE-specific}+N_{TA,common}+N_{TA,offset})×T_{c} Equation 5

In Equation 5, T_{c} may be given as T_{c}=1/(Δfₘₐₓ·N_{f}), and Δfₘₐₓ=480·103 Hz and N_{f}=4096. In Equation 5, N_{TA} may be a value determined based on the TA value included in the RAR or MAC CE received from the base station, and N_{TA,offset} may be a fixed or promised value in advance. In Equation 5, N_{TA,UE-specific} is the TA correction value measured by the terminal based on the location (or reference location) of the terminal itself and the satellite, N_{TA,common} may be a TA correction value configured or indicated by the base station by using higher signaling or physical layer signals.

Equation 5 may be a formula in which the parameters of N_{TA,UE-specific} and N_{TA,common} are added compared to Equation 6 below, which is a conventional TA application method.

T_{TA}=(N_{TA}+N_{TA,offset})×T_{c} Equation 6

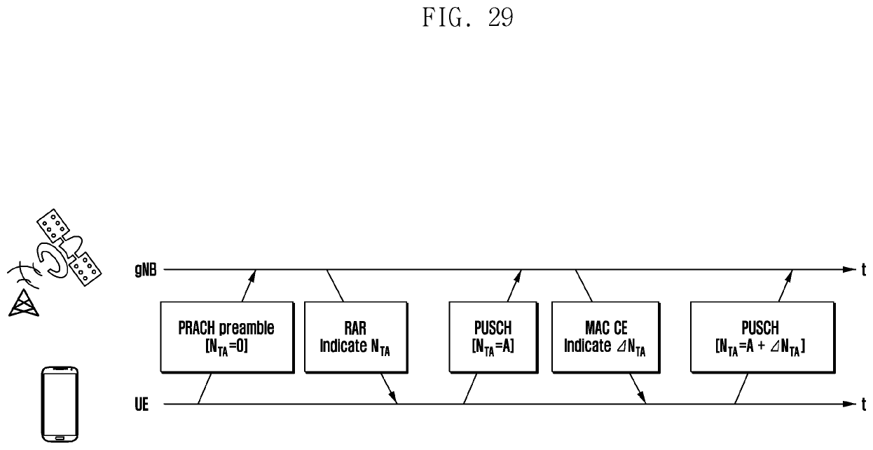

FIG. 29 illustrates an example of a process in which a terminal determines an N_{TA} from initial access according to an embodiment of the present disclosure.

Referring to FIG. 29, the terminal transmits a PRACH preamble to the base station with N_{TA}=0, and the base station transmits an RAR indicating N_{TA} to the terminal. Afterwards, the terminal transmits PUSCH by applying N_{TA}=A, and the base station transmits MAC CE indicating ΔN_{TA} to the terminal. Afterwards, the terminal may transmit PUSCH by applying N_{TA}=A+ΔN_{TA}.

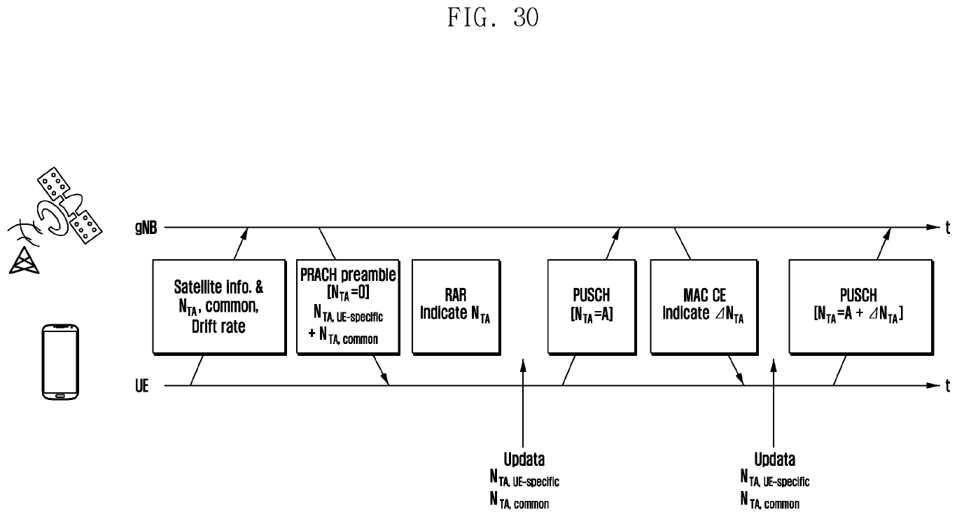

FIG. 30 illustrates an example of a process in which a terminal determines N_{TA}, N_{TA,UE-specific}, and N_{TA,common} from initial access, according to an embodiment of the disclosure.

Referring to FIG. 30, the base station transmits configuration information including satellite information, N_{TA,common}, and drift rate to the terminal. Afterwards, the terminal assumes N_{TA}=0 and transmits the PRACH preamble to the base station by applying N_{TA,UE-specific} measured by the terminal, and the configured N_{TA,common}. Afterwards, the base station transmits a RAR indicating N_{TA} to the terminal, and N_{TA,UE-specific} and N_{TA,common} may be updated. Afterwards, the terminal assumes N_{TA}=A and transmits PUSCH according to the T_{TA} calculated according to Equation 5, and the base station may transmit a MAC CE indicating ΔN_{TA} to the terminal. Afterwards, N_{TA,UE-specific} and N_{TA,common} may be updated, and the terminal may transmit PUSCH according to the T_{TA} calculated according to Equation 5 by applying the updated N_{TA,UE-specific} and N_{TA,common} by applying N_{TA}=A+ΔN_{TA}.

T_{TA} may be determined as N_{TA}=TA·16·64/2^{μ} based on TA=0, 1, 2, . . . , 3846 transmitted in RAR or msg B. In addition, TA=0, 1, 2, . . . , 63 is transmitted to MAC CE and may be updated as N_{TA_new}=TA_old+(TA−31)·16·64/2^{μ}. In addition, Δfₘₐₓ·N_{f}, TA value transmitted from RAR or msg B, or TA value transmitted from MAC CE, etc. may be changed depending on the communication system. In addition, when the terminal performs a TA update based on the TA transmitted from MAC CE, such as N_{TA_new}=T_{A_old}+(T_{A}−M)·16·64/2^{μ}, if the maximum value for TA is greater than 63, the M value may be greater than or equal to 31, and if the maximum value for TA is less than 63, the terminal may determine N_{TA_new}, which is an updated N_{TA} value, based on the M value less than or equal to 31.

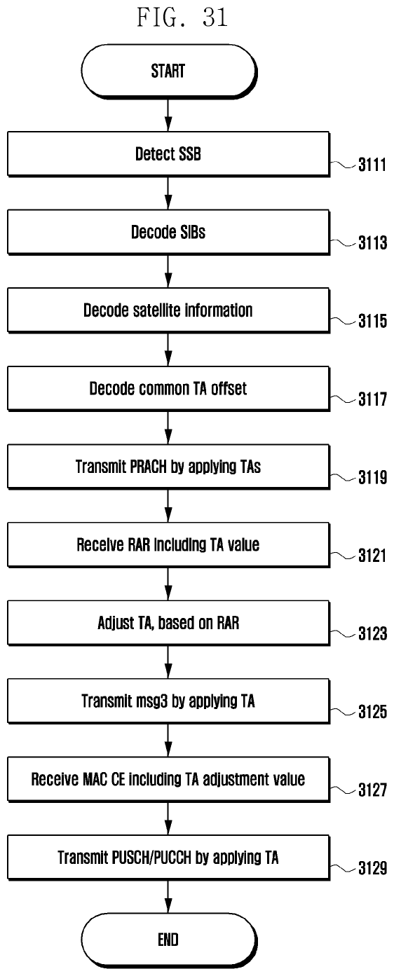

FIG. 31 illustrates another example of an operation process of a terminal in a communication system according to an embodiment of the present disclosure.

The terminal may perform an initial access procedure according to the process described in FIG. 31 and determine the TA after performing the initial access procedure, and this is explained in detail as follows.

First, in operation 3111, the terminal may detect a synchronization signal and PBCH block (SSB) received from the base station. In operation 3113, the terminal may decode the system information block (SIB) based on the detected SSBs. The terminal may detect information on random access channel (RACH) resources by decoding SIBs.

In operation 3115, the terminal may obtain (or decode) satellite information by decoding SIBs. According to an embodiment of the disclosure, satellite information may include at least one of various parameters such as satellite location information and the like. In operation 3115, the terminal may obtain a UE-specific TA correction value, for example, N_{TA,UE-specific}, based on the obtained satellite information and the location (or reference location) of the terminal and the satellite. In operation 3117, the terminal may obtain (or decode) a common TA offset, for example, N_{TA,common}, by decoding the SIBs.

In operation 3119, the terminal may calculate TAs based on N_{TA,UE-specific} and N_{TA,common}, and transmit PRACH to the base station by applying the calculated TAs. In operation 3121, the terminal may receive an RAR including a TA value in response to the PRACH transmission. In operation 3123, the terminal may adjust the TA based on the received RAR.

In operation 3125, the terminal may transmit msg3 to the base station by applying TA. The msg3 is a part of the random access procedure and may indicate a message transmitted on an uplink shared channel (UL-SCH) including a C-RNTI MAC CE or common control channel (CCCH) SDU, and may be the first scheduled transmission of a random access procedure. In operation 3127, the terminal may receive a MAC CE including a TA adjustment value from the base station. In operation 3129, the terminal may transmit PUSCH or/and PUCCH by applying TA based on the TA adjustment value included in the MAC CE.

The operation process of the terminal as described in FIG. 31, that is, the process of performing the initial access procedure and determining the TA after performing the initial access procedure, may be summarized as in Table 24 below when compared with the operation process of the terminal in other embodiments of the disclosure.

TABLE 24

| | Operation process of terminal |
|---|---|
| Operation process of terminal | based on FIG. 31 |
| 1. Detect SSB | 1. Detect SSB |
| 2. Decode SIBs (detect RACH resource | 2. Decode SIBs (detect RACH resource |
| information) | information) |
| 3. Transmit PRACH | 3. Decode satellite information (location |
| 4. Receive RAR including TA value | information, etc.), obtain N_{TA, UE-specific} |
| 5. Adjust TA based on RAR | 4. Decode common TA offset, obtain |
| 6. Transmit msg3 by applying TA | N_{TA, common} |
| 7. Receive MAC CE including TA | 5. Transmit PRACH by applying TAs |
| adjustment value | 6. Receive RAR including TA value |
| 8. Transmit PUSCH/PUCCH by applying | 7. Adjust TA based on RAR |
| TA based on TA adjustment value | 8. Transmit msg3 by applying TA |
| | 9. Receive MAC CE including TA |
| | adjustment value |
| | 10. Transmit PUSCH/PUCCH by applying |
| | TA |

In addition, in the operation process of the terminal described in FIG. 31, the order of some operations may be changed, and as an example, the order of decoding satellite information and decoding the common TA offset may be changed.

On the other hand, the operation process of a terminal in a communication system according to various embodiments of the disclosure is illustrated with reference to FIG. 31, but of course, various modifications may be made to FIG. 31. As an example, although successive steps are illustrated in FIG. 31, the steps described in FIG. 31 may overlap, may occur in parallel, may occur in a different order, or one or more steps may occur multiple times.

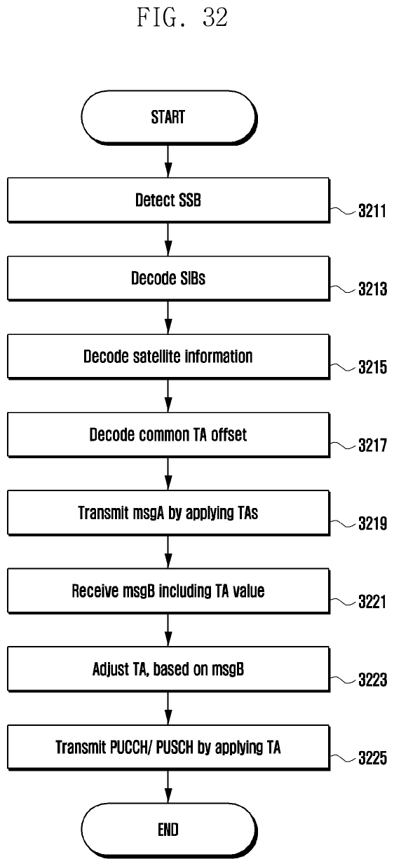

FIG. 32 illustrates another example of an operation process of a terminal in a communication system according to an embodiment of the present disclosure.

The terminal may perform an initial access procedure according to the process described in FIG. 32 and determine the TA after performing the initial access procedure, and this is explained in detail as follows. In particular, FIG. 31 illustrates the operation process of a terminal based on a random access procedure for a 4-step random access (RA) type, and the operation process of the terminal illustrated in FIG. 32 may be a terminal operation process based on a random access procedure for a 2-step RA type.

First, in operation 3211, the terminal detects an SSB received from the base station. In operation 3213, the terminal decodes the SIB based on the detected SSBs. The terminal may obtain information on RACH resources by decoding SIBs.

In operation 3215, the terminal may obtain (or decode) satellite information by decoding SIBs. According to an embodiment of the disclosure, satellite information may include at least one of various parameters such as satellite location information and the like. In operation 3215, the terminal may obtain a UE-specific TA correction value, for example, N_{TA,UE-specific}, based on the decoded satellite information and the location (or reference location) of the terminal and the satellite. In operation 3217, the terminal may obtain (or decode) a common TA offset, for example, N_{TA,common}, by decoding the SIBs. In operation 3219, the terminal calculates TAs based on N_{TA,UE-specific} and N_{TA,common}, and transmits msgA to the base station by applying the calculated TAs. According to one embodiment of the disclosure, msgA may be preamble and payload transmissions of a random access procedure for a 2-step random access (RA) type. In operation 3221, the terminal may receive msgB including a TA value from the base station. According to an embodiment of the disclosure, msgB is a response to msgA in a random access procedure for a two-step RA type, and may include response(s) to contention resolution, fallback indication(s), and backoff indication. In operation 3223, the terminal may adjust the TA based on the TA adjustment value included in the msgB. In operation 3225, the terminal may transmit the PUSCH and/or the PUCCH by applying adjusted TA.

The operation process of the terminal as described in FIG. 32, that is, the process of performing the initial access procedure and determining the TA after performing the initial access procedure, may be summarized as in Table 25 below when compared with the operation process of the terminal in other embodiments of the disclosure.

TABLE 25

| | Operation process of terminal |
|---|---|
| Operation process of terminal | based on FIG. 32 |
| 1. Detect SSB | 1. Detect SSB |
| 2. Decode SIBs (detect RACH resource | 2. Decode SIBs (detect RACH resource |
| information) | information) |
| 3. Transmit MsgA (PRACH + Msg3) | 3. Decode satellite information (location |
| 4. Receive MsgB including TA value | information, etc.), obtain N_{TA, UE-specific} |
| 5. Adjust TA based on MsgB | 4. Decode common TA offset, obtain |
| 6. Transmit PUCCH/PUSCH by applying | N_{TA, common} |
| TA | 5. Transmit MsgA by applying TAs |
| | 6. Receive MsgB including TA value |
| | 7. Adjust TA based on MsgB |
| | 8. Transmit PUCCH/PUSCH by applying |
| | TA |

In addition, in the operation process of the terminal described in FIG. 32, the order of some operations may be changed, and as an example, the order of decoding satellite information and decoding the common TA offset may be changed.

On the other hand, the operation process of a terminal in a communication system according to various embodiments of the disclosure is illustrated with reference to FIG. 32, but of course, various modifications may be made to FIG. 32. As an example, although successive steps are illustrated in FIG. 32, the steps described in FIG. 32 may overlap, may occur in parallel, may occur in a different order, or one or more steps may occur multiple times.

On the other hand, N_{TA,UE-specific} used in embodiments of the disclosure is a value calculated and applied by the terminal. Accordingly, the base station may not know the N_{TA,UE-specific} value calculated by the terminal. In addition, the N_{TA,UE-specific} value calculated by the terminal may change over time due to the movement of the satellite or terminal.

Accordingly, in embodiments of the disclosure, the base station may need to control the TA of the terminal in consideration of the N_{TA,UE-specific} values that may change over time, and therefore may need to configure the time at which the terminal updates the N_{TA,UE-specific} value. Accordingly, the terminal may update the N_{TA,UE-specific} value based on the following methods, for example, any one of methods 1-1 to 1-6, or a method of combining at least two of methods 1-1 to 1-6.
Method 1-1: the terminal always updates N_{TA,UE-specific} whenever a SIB including satellite information (for example, including satellite information, etc.) is received. Method 1-1 may be applied when the terminal determines that the SIB is received from the base station or when a paging signal indicating SIB update is received from the base station.
Method 1-2: the base station may separately indicate the change rate of TA, for example, N_{TA,UE-specific}, and may also configure a period and offset to recalculate the TA value according to the change rate of the TA, for example, to update the TA value. In this case, the terminal updates the TA, for example, N_{TA,UE-specific}, at a time determined according to the update cycle and offset, and the amount of TA updated by the terminal may be determined according to the change rate of the TA. In various embodiments of the disclosure, the base station may indicate the change rate of TA based on an explicit method or an implicit method.
Method 1-3: the base station may configure the update period and offset for the terminal to update N_{TA,UE-specific} based on the locations of the satellite and the terminal. In this case, the terminal may update the TA at the relevant time determined according to the update period and offset configured by the base station. In various embodiments of the disclosure, the base station may indicate the update period and offset based on an explicit method or an implicit method.
Method 1-4: in at least some cases of performing uplink transmission (for example, PUCCH/PUSCH, PRACH, SRS transmission, etc.), the terminal may always update and apply the N_{TA,UE-specific} at the relevant time (may be performed every time, at regular periods, or at irregular times), for example, at the relevant slot time.
Method 1-5: the terminal updates N_{TA,UE-specific} based on the time at which the TA command transmitted by the base station through MAC CE expires. As an example, the terminal updates N_{TA,UE-specific}, when the TA expires. Expiration of the TA command may refer to that the timer value has reached a specific time point based on a timer for the TA command. The timer for the TA command may be configured to timeAlignmentTimer, which may be a parameter for how long the uplink time synchronization is correct. Upon receiving a new TA command, the terminal may start or restart timeAlignmentTimer. When the timeAlignmentTimer expires, the terminal may empty the HARQ buffer and reconfigure RRC configurations, etc.
Method 1-6: a new timer timeAlignmentTimer_UEspecific related to N_{TA,UE-specific} is introduced, and the terminal may update NTA, UE-specific based on the new timer timeAlignmentTimer_UEspecific. The timeAlignmentTimer_UEspecific may be started or restarted when the terminal newly calculates N_{TA,UE-specific}, or transmits information on the N_{TA,UE-specific} to the base station. When the timeAlignmentTimer_UEspecific expires, the terminal may newly calculate and update the N_{TA,UE-specific}, configure the N_{TA,UE-specific} to 0, or perform PRACH transmission.

An embodiment provides a method and device for transmitting (reporting) the timing advance (TA) value that the terminal is applying or has applied to the base station or satellite. In this disclosure, a satellite may be an object located high above the ground, and may be a concept including an airplane, an airship, etc.

The terminal may perform an operation to transmit the TA value the terminal is applying to the base station. This may be to inform the base station of the applied TA value when the terminal applies the TA value without separate indications from the base station, or to identify or determine how the terminal is applying the TA value indicated by the base station. For example, this operation may be performed so that the newly connected satellite to the terminal may identify the TA value of the terminal when the satellite to which the terminal is connected changes. As an example, the terminal may independently apply the TA calculated based on the locations of the terminal and satellite.

The terminal may use one or a combination of at least two of the following methods to report the TA value to the base station.
Method 2-1: the base station may trigger TA value reporting of the terminal through DCI. The base station may trigger TA value reporting through some bitfield values of DCI or a combination of bitfield values. A field indicating a TA value reporting trigger is included in the DCI, and in this case, when the field of the received DCI is configured to a specific value, the terminal may understand that the TA value reporting has been triggered. Alternatively, when the value of one or more fields (for example, for other purposes) included in the DCI is configured to a predetermined value, the terminal may understand that TA value reporting has been triggered. The terminal may transmit the TA value at a specific time point based on the time point at which the DCI was received to the base station.
Method 2-2: the base station may trigger TA value reporting of the terminal through MAC CE. The base station may trigger TA value reporting by using some bit values of the MAC CE or bitfield values, and the terminal may transmit the TA value at the time of receiving the MAC CE or at a predetermined time after receiving the MAC CE to the base station.
Method 2-3: the base station may indicate which TA value the terminal may report through RRC configurations. As an example, the base station may determine at what time point the terminal may report the TA value by configuring a period and offset value for TA reporting and/or specific conditions for the terminal to report the TA value through higher signaling, and in this case, the reference TA value application time (that is, the time when the TA value to be reported is applied, may be referred to as the TA value reference point) may also be specified. The specific condition under which the terminal reports the TA value may be, for example, a case where the TA value is greater than or equal to a predetermined value, or a case where the distance between the terminal and the satellite is greater than or equal to a predetermined value, and the predetermined values may be configured through higher signaling, information transmitted from an SIB, etc., or may be fixed values.
Method 2-4: the terminal may report the TA value without a separate trigger from the base station. For example, method 4 may be that the terminal transmits information indicating the TA value to the base station according to a specific condition, and the specific condition may be predetermined, such as conditions for the time to perform TA value reporting or the result of comparison between the TA value applied by the terminal and a specific threshold value, etc. (without signaling such as DCI, MAC CE, RRC, etc. for trigger from base station).

According to an embodiment of the disclosure, when transmitting a TA value, the terminal may transmit the TA value by using a physical channel such as PUCCH, PUSCH, etc. or may transmit TA value information to the base station through higher signaling. When the terminal transmits TA value information by using a physical channel, resources to be used to report TA value information may be configured through higher signaling.

According to an embodiment of the disclosure, reporting the TA value may refer to reporting the TTA value or N_{TA,UE-specific} value in the above equation. Alternatively, the base station may configure which to report among TTA, and N_{TA,UE-specific} to the terminal through SIB or higher signaling.

The reference time for determining the TA value reported by the terminal and the time for reporting the TA value may be determined based on the time when the terminal performs TA value reporting, the time when TA value reporting is triggered, etc. For example, when the TA value reporting is triggered by DCI in slot n, the terminal may report the TA value applied or calculated in slot n-K, and it is possible for the terminal to report the TA value to the base station in slot n+N. K and N may be values determined depending on subcarrier spacing, UE capability, slot DL/UL configurations, and PUCCH resource configurations, respectively.

According to an embodiment of the disclosure, K may be 0. K=0 may refer to that the terminal reports the TA value based on the time when the TA value reporting triggering signal is received. In addition, K may be a value smaller than 0, and in this case, for example, the TA value at the time the terminal reports the TA value may be calculated in advance, report information may be generated, and then reported. In addition, K may be an integer value greater than 0. This may be that the terminal reports a TA value earlier than the time at which the terminal reports the TA value (for example, slot n+N), which may be reporting the TA value at an early time because the terminal needs time to encode the information to be reported and prepare for transmission.

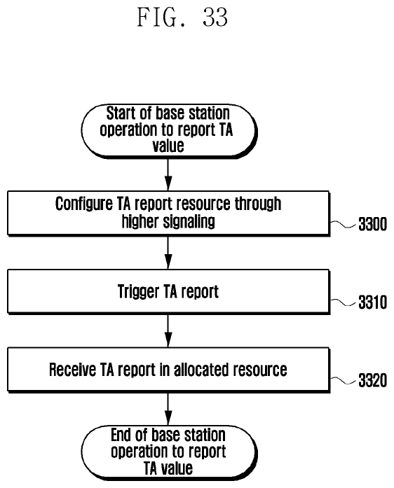

FIG. 33 illustrates an example of a base station operation for reporting the TA value of a terminal according to an embodiment of the present disclosure.

When reporting the TA value of the disclosure, the TA value applied by the terminal may be indicated in units of ms, slots, or symbols, or may be provided as information including values below the decimal point rather than integers. The report of the TA value of the disclosure may include the absolute value of TA, but may also include the TA value indicated by the previous base station or the relative TA value excluding the specified TA value or the amount of change in the TA value (this could be, for example, the amount of change in TA over a certain period of time).

According to an embodiment of the disclosure, the base station may transmit configuration information related to TA reporting through higher signaling (operation 3300). Configuration information related to the TA reporting may include, for example, at least one of the information for configuring TA reporting such as the period and offset at which TA reporting is performed, TA reporting trigger conditions, TA value reference point information, types of TA information to report, resource configuration information on which TA reporting is performed, etc. The base station may trigger a TA reporting to the terminal (operation 3310). As an example, this trigger may be performed through higher signaling or DCI of the specific content described above, but may also be omitted. The base station may receive the TA reporting transmitted from the terminal according to the transmitted configuration information (operation 3320).

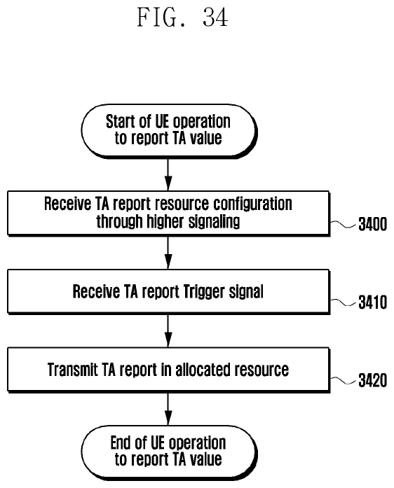

FIG. 34 illustrates an example of a terminal operation for reporting the TA value of a terminal according to an embodiment of the present disclosure.

When reporting the TA value of the disclosure, the TA value applied by the terminal may be indicated in units of ms, slots, or symbols, or may be provided as information including values below the decimal point rather than integers. The report of the TA value of the disclosure may include the absolute value of TA, but may also include the TA value indicated by the previous base station or the relative TA value excluding the specified TA value or the amount of change in the TA value (this could be, for example, the amount of change in TA over a certain period of time).

According to an embodiment of the disclosure, the terminal may receive configuration information related to TA reporting transmitted from the base station through higher signaling (operation 3430). The configuration information may include, for example, at least one of the information for configuring TA reporting such as the period and offset at which TA reporting is performed, TA reporting trigger conditions, TA value reference point information, types of TA information to report, resource configuration information on which TA reporting is performed, etc. The terminal may receive a signal triggering a TA reporting transmitted from the base station (operation 3440). As an example, this trigger may be performed through higher signaling or DCI of the specific content described above, but may also be omitted. The terminal transmits the TA reporting according to the received configuration information (3420). As an example, when receiving TA report resource information, the terminal transmits the TA reporting from the configured resource. Each step disclosed in FIGS. 33 and 34 may be applied in a changed order, and other steps may be added or omitted.

An embodiment provides a method for the terminal to calculate, determine, and report the N_{TA,UE-specific} explained through the embodiments described above. The N_{TA,UE-specific} value may be calculated based on the distance between the terminal and a non-terrestrial network (NTN) satellite. The terminal may calculate its own location by receiving signals from navigation satellites in a satellite navigation system, and navigation satellites may be different from NTN satellites. Of course, the terminal's calculation of its own location is not limited to the above method, and the terminal's location may be received from another entity.

According to an embodiment of the disclosure, the terminal may estimate the delay time between the satellite and the terminal based on its own location and the location of the satellite, and may perform uplink transmission by correcting the estimated delay time value by itself. As an example, a satellite transmits information on the satellite's location through broadcast information, and the terminal may receive information on the satellite's location transmitted from the satellite and compare the same with its own location. The terminal's own location may be determined by using one of several types of Global Positioning System (GPS) systems or information from a base station, independently or in a combined manner. Through the above comparison, the terminal may calculate the uplink transmission time by estimating the time it takes for radio waves to be transmitted to the satellite.

For example, if the terminal receives a signal in slot n through the downlink at a specific time and may perform uplink transmission corresponding to the signal in slot n+k, the uplink transmission may be transmitted 2*Td earlier than slot n+k. According to an embodiment of the disclosure, the delay time Td may be the delay time from the terminal to the satellite calculated using the location information of the satellite and the terminal, or a value corresponding thereto. The delay time Td may be the distance from the terminal to the satellite or the corresponding value divided by the speed of light, or a value corresponding thereto. As an example, the satellite's location may be a value calculated based on slot n+k in which the terminal performs uplink transmission. This is because the location of the satellite in slot n and the location of the satellite in slot n+k may vary depending on the movement of the satellite.

In a terrestrial network, a propagation delay of less than 1 ms occurs considering the distance to the base station of up to about 100 km, but in a satellite network, the distance to the satellite may be thousands of kilometers, and the distance from the satellite to the base station may also be thousands of kilometers, so the delay time may be much greater than in the case of the terrestrial network.

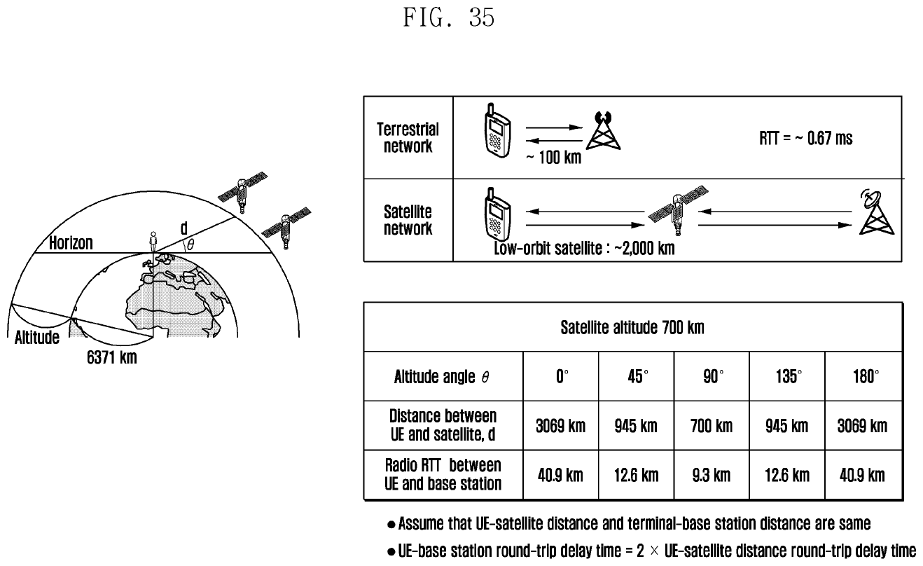

FIG. 35 illustrates an example of the difference in propagation delay time between a terrestrial network and a satellite network according to an embodiment of the present disclosure.

In satellite network communication, the delay time varies depending on the altitude and altitude angle of the satellite, and FIG. 35 illustrates the distance between the terminal and the satellite according to the altitude angle when the altitude of the satellite is 700 km, and the time it takes for the radio wave to travel back and forth. In the case of the satellite network, a low-orbit satellite was assumed, and it is illustrated that when the altitude angle is 0 to 180°, the radio round trip time (radio RTT, which may include the round-trip time it takes for a signal to be transmitted between transmitters and receivers, as well as processing time at the other node) may occur from 40.9 ms to 9.3 ms. According to an embodiment of the disclosure, the delay time is only an example and may vary depending on the altitude and orbit of the satellite, and for example, at high altitudes, the average delay time may increase further.

Because the maximum delay time in a terrestrial network is within 1 or 2 ms, the base station may match the slot timing for transmitting downlink and the slot timing for receiving uplink through timing advance provided by LTE and 5G NR systems (that is, the indices of the DL slot and the UL slot may match). That is, if the terminal performs uplink transmission ahead of the downlink timing by the timing advance value indicated by the base station, when the uplink signal transmitted from the terminal is received by the base station, the uplink timing coincides with the downlink timing of the base station. On the other hand, in a satellite network, it may be difficult for a base station to match the slot timing for transmitting downlink and the slot timing for receiving uplink through the timing advance provided in conventional LTE and 5G NR systems. This is because the propagation delay time occurring in the satellite network is large, on the order of tens of ms, and this propagation delay time is greater than the maximum value of timing advance provided by conventional LTE and 5G NR systems.

A satellite navigation system may also be called Global Navigation Satellite System (GNSS), and the GNSS may include, for example, GPS in the United States, GLONASS in Russia, Galileo in the EU, Beidou in China, etc. Of course, it is not limited to the above examples. The GNSS may include regional navigation satellite system (RNSS), and the RNSS may include, for example, IRNSS in India, QZSS in Japan, KPS in Korea, etc. On the other hand, signals transmitted from GNSS may include at least one of auxiliary navigation information, normal operation status of the satellite, satellite time, satellite ephemeris, satellite altitude, reference time, and information on various correction data.

On the other hand, in various embodiments of the disclosure, an NTN satellite may be a communication satellite that transmits signals for a terminal to connect to a base station. In addition, in various embodiments of the disclosure, the GNSS satellite may be a satellite that transmits signals of a satellite navigation system. On the other hand, the terminal may receive a signal from each of one or more GNSS satellites, calculate its own location based on signals received from each of one or more GNSS satellites, and also identify the reference time for each of one or more GNSS satellites. If the terminal may calculate its own location in multiple ways based on signals received from multiple GNSS satellites, the terminal may calculate its actual location based on the average of a plurality of locations, the location corresponding to the received signal with the strongest strength among the plurality of locations, or the average value of the plurality of locations (for example, a method of applying weight to locations corresponding to signals with strong signal strength) based on the signal strength. Here, the method by which the terminal calculates its own location based on signals received from a plurality of GNSS satellites may be implemented in various forms, and detailed descriptions thereof will be omitted.

In various embodiments of the disclosure, the time obtained from GNSS or the time of the base station transmitted by the base station may be, for example, based on coordinated universal time (UTC) time, which may be based on the time from 00:00:00 on Jan. 1, 1900 in the Gregorian calendar. This may vary depending on the type of GNSS system, and the reference time zone as illustrated in Table 26 below may be used.

```
TABLE 26
gnss-DayNumber
This field specifies the sequential number of days (with day count starting at 0) from the origin
of the GNSS System Time as follows:
  GPS, QZSS, SBAS - Days from January 6^{th} 1980 00:00:00 UTC (USNO);
  Galileo - Days from Galileo System Time (GST) start epoch, defined as 13 seconds
before midnight between 21^{st} August and 22^{nd} August
1999; i.e., GST was equal to 13 seconds at August 22^{nd} 1999 00:00:00 UTC;
  GLONASS - Days from December 31^{st} 1995 21:00:00 UTC (SU), which is local UTC
Moscow
                    January 1^{st} 1996 00:00:00, defined as UTC(SU) +
3 hours;
  BDS - Days from January 1^{st} 2006 00:00:00 UTC (NTSC).
  NavIC - Days from NavIC System Time start epoch, defined as 13 seconds before
midnight between 21st
  August and 22nd August 1999; i.e., NavIC System Time was equal to 00:00:00 at
August 21st, 1999
  23:55:47 UTC (BIPM).
```

In Table 26, NavIC may refer to NAVigation with Indian Constellation, QZS may refer to Quasi Zenith Satellite, QZSS may refer to Quasi-Zenith Satellite System, QZST may refer to Quasi-Zenith System Time, SBAS may refer to Space Based Augmentation System, and BDS may refer to Beidou Navigation Satellite System.

In addition, through a satellite, the base station may indicate the type of GNSS system that is the reference for location or time information used by the base station, and for example, an indicator as illustrated in Table 27 below may be used.

TABLE 27

| Value of gnss-TO-ID | Indication |
|---|---|
| 1 | GPS |
| 2 | Galileo |
| 3 | QZSS |
| 4 | GLONASS |
| 5 | BDS |
| 6 | NavIC |
| 7-15 | reserved |

As described above, the terminal may calculate the time it takes for a signal to be transmitted from the NTN satellite to the terminal based on the location of the terminal calculated by the terminal itself and the location of the NTN satellite received from the NTN satellite, and determine the TA value based on the calculated time. When determining the TA value, the terminal may also consider the distance from the NTN satellite to the base station on the ground, or the distance from the NTN satellite to another NTN satellite if the signal is transmitted to the base station on the ground through another NTN satellite.

In contrast, the terminal may obtain reference time information from the information transmitted from the GNSS satellite, compare the time information transmitted from the NTN satellite with the reference time information obtained from the GNSS satellite, and calculate the time (propagation delay) required from the NTN satellite to the terminal based on the comparison result.

The location and time information of the NTN satellite may be transmitted from the base station to the terminal through SIB. This may be transmitted directly from the NTN satellite.

When the distance between the terminal and the satellite or corresponding value of the distance is dUE,sat (unit km), and the speed of light is vc (unit km/sec), N_{TA,UE-specific} may be determined based on dUE,sat/vc (unit sec). For example, N_{TA,UE-specific} may be determined and applied as

$$\\ {N}_{TA , UE ‐ specific} = ⌊ \frac{{d}_{UE , sat}}{{v}_{c}} \cdot \frac{1}{{T}_{c}} ⌋ ,$$

and this is a method that may be determined as N_{TA,UE-specific} by integerizing the

$$\\ \frac{{d}_{UE , sat}}{{v}_{c}} \cdot \frac{1}{{T}_{c}}$$

value. Additionally, the terminal may determine the N_{TA,UE-specific} and report the N_{TA,UE-specific} information to the base station by combining at least one of the three methods below.
Method 3-1: the terminal may set N_{TA,UE-specific}=(D+a)/T_{C}. D is an integer, and a is a decimal greater than or equal to 0 and less than 1. Here,

$$\\ D = ⌊ \frac{{d}_{UE , sat}}{{v}_{c}} ⌋ and a = \frac{{d}_{UE , sat}}{{v}_{c}} - ⌊ \frac{{d}_{UE , sat}}{{v}_{c}} ⌋ .$$

Method 3-1 may be a method of dividing the propagation delay between the terminal and the satellite into integer and decimal parts and reporting only integers or values corresponding thereto, or reporting integers and decimals or values corresponding thereto, respectively. By using this method, the number of bits used to report propagation delay may be reduced. Here, the decimal part was described above as an integer multiple of Tc, but it may be determined to be a multiple of 16·64/2^{μ}. In the above, may refer to the subcarrier spacing of the current carrier, BWP, or related CORESET. Alternatively, it may be a value used for transmitting and receiving signals such as PDSCH or PUSCH. Here, μ=0, 1, 2, 3, 4, and 5 may be values corresponding to subcarrier spacings of 15 kHz, 30 kHz, 60 kHz, 120 kHz, 240 kHz, and 480 kHz, respectively. Alternatively, μ may be configured through higher signaling from the base station for N_{TA,UE-specific} determination. Alternatively, μ may be used as a fixed value, and as an example, it may be fixed to one of 0, 1, 2, 3, 4, or 5, such as μ=5.
Method 3-2: the terminal may determine that N_{TA,UE-specific} is a multiple of 16·64/2^{μ}. The N_{TA,UE-specific} may be determined as

$$\\ {N}_{TA , UE ‐ specific} = ⌊ \frac{{d}_{UE , sat}}{{v}_{c}} \cdot \frac{1}{16 \cdot 64 \cdot {T}_{c} / {2}^{μ}} ⌋ \cdot 16 \cdot 64 / {2}^{μ} .$$

In the disclosure, └X┘ may refer to the largest integer not greater than x, which may refer to rounding the number down to an integer unit, that is, discarding the decimal value. Of course, it is not limited to the above example, and instead of rounding down using └X┘ in the disclosure, rounding up or rounding off to the decimal places may be used. In the above, μ may refer to the subcarrier spacing of the current carrier, BWP, SIB, or related CORESET. Here, μ=0, 1, 2, 3, 4, and 5 may be values corresponding to subcarrier spacings of 15 kHz, 30 kHz, 60 kHz, 120 kHz, 240 kHz, and 480 kHz, respectively. Alternatively, μ may be configured through higher signaling from the base station for N_{TA,UE-specific} determination. Alternatively, μ may be used as a fixed value, and as an example, it may be fixed to μ=5 to be used. Alternatively, which may be used for N_{TA,UE-specific} calculations, may be configured separately by the base station through SIB or higher signaling.
Method 3-3: N_{TA,UE-specific}=N_{A,UE-specific}·16·64/2^{μ}, and the N_{A,UE-specific} may be set as an integer that makes N_{A,UE-specific} closest to d_{UE,sat}/(v_{c}·T_{c}). Alternatively, the N_{A,UE-specific} may be set as the minimum integer that satisfies

$$\\ {N}_{TA , UE ‐ specific} \geq \frac{{d}_{UE , sat}}{{v}_{c} \cdot {T}_{c}} ,$$

or the N_{A,UE-specific} may be set as the maximum integer that satisfies

$$\\ {N}_{TA , UE ‐ specific} \leq \frac{{d}_{UE , sat}}{{v}_{c} \cdot {T}_{c}} .$$

Method 3-4: depending on the base station configurations, the terminal may set N_{TA,UE-specific}=0. This may be because the propagation delay occurring in the link (may be called a service link) between the terminal and the satellite has little difference among terminals within the coverage of a specific beam of the satellite, so uplink time synchronization may be achieved by using the conventional TA mechanism and N_{TA,common}. The base station may configure, through an SIB, whether the terminal configures the N_{TA,UE-specific} value to N_{TA,UE-specific}=0, or uses the N_{TA,UE-specific} value calculated based on the location of the satellite and the terminal and the speed of light according to the GNSS signal. As another example, the base station may configure, through an SIB or separate RRC signaling, whether the terminal continuously use the N_{TA,UE-specific} value calculated based on the time point at which the PRACH preamble is transmitted based on the location of the satellite and the terminal and the speed of light according to the GNSS signal until there is a separate instruction or configuration, or whether the terminal uses the newly calculated N_{TA,UE-specific} values at each uplink transmission time. That is, in Equation 5 above, the N_{TA,UE-specific} value may be determined as follows.

N_{TA,UE-specific} is UE self-estimated TA to pre-compensate for the service link delay if configured, and N_{TA,UE-specific} is 0 otherwise.

The methods of determining N_{TA,UE-specific} based on the distance (or its corresponding value) between the terminal and the satellite and the speed of light in Methods 3-1 to 3-4 are only examples, and more various methods may exist. For example, in general, when defining the N_{TA,UE-specific} value as an integer or an expression based on an integer value, it may be expressed as

$$\\ ⌊ \frac{{h}_{sat}}{{v}_{c}} \cdot \frac{1}{{T}_{c}} \cdot \frac{1}{K} ⌋ \cdot K or D = ⌊ \frac{{d}_{UE , sat}}{{v}_{c}} \cdot \frac{1}{K} ⌋ \cdot K ,$$

and the like to express the N_{TA,UE-specific} value as a multiple of a specific integer or rational number value K. Here, K may be a predetermined value or a value determined by signaling parameters. Method 2 refers to the case where K=16·64/2^{μ}, and as such, K may be determined according to at least one of system parameters such as or T_{c}. This method has the advantage of being able to express more diverse values with signaling of the same bit, although the granularity of N_{TA,UE-specific} values is somewhat sparse. In addition, instead of the rounding down calculation such as └X┘ used in each of the above methods, the values may be determined based on the rounding up (┌X┐) or rounding off (Round (x)) calculation in the decimal place.

An embodiment provides a method in which the base station transmits the N_{TA,common}, explained through the embodiments described above, to the terminal, and the terminal calculates and applies the same.

The following are methods for the base station to transmit the N_{TA,common} information to the terminal with configuration and indication, and at least one or more of these methods may be applied in combination.
Method 4-1: the base station may configure one offset value to the terminal through RRC signaling. The value configured through RRC signaling is called N_{A,common}, and the N_{TA,common} may be determined based on the N_{A,common}.
Method 4-2: the base station may indicate one offset value to the terminal through MAC CE. The value configured through MAC CE is called N_{A,common}, and the N_{TA,common} may be determined based on the N_{A,common}. This method has the advantage of allowing the base station and the terminal to clarify the time point to apply N_{TA,common}, compared to the case of using method 4-1 above. As an example, the N_{TA,common} may be applied after a predetermined period of time based on the time of receiving the MAC CE or transmitting the ACK for receiving the MAC CE. As an example, the base station may transmit N_{A,common} in msec units through MAC CE 8 bits and indicate from 0 ms to 255 ms. In this case, The N_{A,common} is determined as N_{A,common} N_{TA,common}=T_{A,common}/(1000·Tc).
Method 4-3: the base station may configure one or more offset values to the terminal through higher layer signaling. Alternatively, these values may be preconfigured. These configured values become candidate values for T_{A,common}, and the base station may indicate one of them through MAC CE.
Method 4-4: the base station may configure one offset value to the terminal through an SIB. The value configured through the SIB is called TA,common, and the N_{TA,common} may be determined based on the T_{A,common}. By using the N_{TA,common} value, the terminal calculates and applies TA when transmitting the PRACH preamble during the initial access process. Afterwards, ΔT_{A,common} is indicated to the terminal through MAC CE, and the terminal may use this to calculate the amount of change in N_{TA,common}, and calculate like N_{TA,common}(new)=N_{TA,common}(Old)+(ΔT_{A,common}−x)·y. In the above, x and y may be determined according to the number of bits and units for transmission of ΔN_{A,common}. For example, N_{TA,common}(new)=N_{TA,common}(old)+(ΔT_{A,common}−M)·16·64/2^{μ}. Here, the M value may be 31, and if the maximum value of ΔT_{A,common} that may be indicated through MAC CE is greater than 63, the M may be a value greater than or equal to 31. If the maximum value of ΔT_{A,common} is less than 63, the M may be less than or equal to 31.
Method 4-5: the base station may indicate one offset value to the terminal through MAC CE. The configured value is called T_{A,common}, and the N_{TA,common} may be determined based on the T_{A,common}. This method has the advantage of clarifying the timing of application of N_{TA,common} between the base station and the terminal, compared to the method 4-1. As an example, the N_{TA,common} may be applied after a predetermined period of time based on the time of receiving the MAC CE or transmitting the ACK for receiving the MAC CE. As an example, the base station may transmit TA,common in units of 16·64·Tc/2^{μ} sec through approximately 19 or 24 bits of MAC CE. In this case, The N_{TA,common} is determined as N_{TA,common}=T_{A,common}·16·64/2^{μ}. The number of bits of MAC CE may be other than the above example.
Method 4-6: the base station may indicate one offset value to the terminal through MAC CE. The configured value is called T_{A,common}, and N_{TA,common} may be determined based on the altitude of the satellite. This method has the advantage of reducing the number of bits that may be transmitted compared to the case of using method 4-5 above. As an example, the base station may transmit T_{A,common} in units of 16·64·Tc/2^{μ} sec through MAC CE about 16 bits. In this case, the N_{TA,common} is determined as

$$\\ {N}_{TA , common} = \frac{{h}_{sat}}{{v}_{c}} \cdot \frac{1}{{T}_{c}} + {T}_{A , common} \cdot 16 \cdot 64 / {2}^{μ} .$$

In the above, hₛₐₜ may be the altitude of the satellite. This may refer to that when the satellite is at a specific altitude, the minimum distance between the terminal and the satellite is a specific altitude, so the base station signals only the remaining additional distance through T_{A,common}. The number of bits of MAC CE may be other than the above example.

In the above formula, the

$$\\ \frac{{h}_{sat}}{{v}_{c}} \cdot \frac{1}{{T}_{c}}$$

value may be defined by integerization or rationalization through a method similar to the embodiment described above. For example, in the embodiment described above, in addition to integerization or rationalization using rounding down calculations such as

$$\\ ⌊ \frac{{h}_{sat}}{{v}_{c}} \cdot \frac{1}{{T}_{c}} ⌋ or ⌊ \frac{{h}_{sat}}{{v}_{c}} \cdot \frac{1}{{T}_{c}} \cdot \frac{1}{K} ⌋ \cdot K ,$$

various integerization or rationalization methods may be applied based on the hₛₐₜ value instead of the dUE,sat value. Of course, integerization or rationalization similar to the above description may be applied to the entire

$$\\ \frac{{h}_{sat}}{{v}_{c}} \cdot \frac{1}{{T}_{c}} + {T}_{A , common} \cdot 16 \cdot 64 / {2}^{μ}$$

value. For example, it may be defined as

$$\\ {N}_{TA , common} = \{ ⌊ \frac{{h}_{sat}}{{v}_{c}} \cdot \frac{1}{{T}_{c} \cdot 16 \cdot 64 / {2}^{μ}} ⌋ + {T}_{A , common} \} \cdot 16 \cdot 64 / {2}^{μ} ,$$

and in this case, it may be the same way as considering K=16·64/2^{μ} in

$$\\ ⌊ \frac{{h}_{sat}}{{v}_{c}} \cdot \frac{1}{{T}_{c}} \cdot \frac{1}{K} ⌋ \cdot K .$$

In addition, the calculation used for integerization or rationalization may be applied not only to rounding down, but also to applying various other operations such as rounding up and rounding off.
Method 4-7: the base station may transmit the N_{TA,common} value and the change rate information of N_{TA,common} at the time received through SIB. The N_{TA,common} value and N_{TA,common} change rate information may be transmitted through RRC signaling to a specific terminal rather than SIB, and the transmission method may vary depending on the status of the terminal (RRC_idle, RRC_inactive, RRC_connected).

The N_{TA,common} change rate information may be transmitted through SIB through one, two, or three parameters. As an example, if change rate information is transmitted through one parameter A, the time when the N_{TA,common} is transmitted through the SIB is called t1, and t2 is the time when uplink transmission is performed, N_{TA,common}(t2), which is the N_{TA,common} to be applied by the terminal at t2, may be calculated as N_{TA,common}(t2)=N_{TA,common}(t1)+(t2−t1)·A. In this case, the units of t1 and t2 may be msec and the units of A may be Tc/msec. That is, A may indicate how many Tc the N_{TA,common} value changes per 1 msec. As another example, if change rate information is transmitted through two parameters A and B, the time when the N_{TA,common} is transmitted through the SIB is called t1, and t2 is the time when uplink transmission is performed, N_{TA,common}(t2), which is the N_{TA,common} to be applied by the terminal at t2, may be calculated as N_{TA,common}(t2)=N_{TA,common}(t1)+(t2−t1)2·B+(t2−t1)·A (when the change rate information is transmitted through n parameters, it is also possible to express the difference (t2−t1) between the two points in the form of an nth-order polynomial). In this case, the units of t1 and t2 may be msec, the units of A may be T_{c}/msec, and the units of B may be T_{c}/msec\hat{ }2. That is, A may indicate how many T_{c} the N_{TA,common} value changes per 1 msec, and B may indicate how many T_{c} the change rate of the N_{TA,common} value changes per 1 msec.

An embodiment provides a method and device in which a base station transmits K_{offset}, which is a parameter for determining the timing at which the terminal transmits a second signal with respect to the first signal transmitted from the base station, to the terminal.

While transmitting the first signal, the base station may indicate the time that the terminal transmits the corresponding second signal by using higher signaling and DCI. For example, while transmitting a PDSCH, HARQ-ACK feedback for this may be indicated by an HARQ-ACK timing-related indicator in the bit field of the DCI that schedules the PDSCH. However, in satellite communication, the delay time between the terminal and the base station is very large, so the offset value indicated in the conventional DCI may not be able to indicate the correct timing. Accordingly, the base station may transmit an additional timing offset, Koffset value, to the terminal through SIB, and the terminal may determine the transmission timing of the second signal (uplink transmission) by adding the offset Koffset.

When the terminal is in the RRC_connected state after initial access, the base station may update the Koffset value to the terminal through RRC signaling. However, when updates are performed only through RRC signaling, the base station and the terminal may have different Koffsets during the time period during which RRC reconfiguration occurs. In this case, correct transmission and reception of the second signal may not occur. In order to eliminate such ambiguous time periods, the base station may configure a plurality of Koffset values to the terminal and indicate one of the configured Koffset values through the MAC CE. Accordingly, the terminal may apply the updated Koffset value from a determined time point after receiving the MAC CE.

As an example, through RRC signaling, candidate Koffset values may be configured according to the index, as illustrated in Table 28 below.

TABLE 28

| index | K_offset |
|---|---|
| 0 | 100 |
| 1 | 120 |
| 2 | 140 |
| 3 | 160 |
| 4 | 180 |
| 5 | 200 |
| 6 | 220 |
| 7 | 240 |

Table 28 is an example of configuring Koffset at regular intervals through 8 indexes, and various other configurations are also possible. If the values of index i consist of 2M (M is an integer such as 2, 3, 4, . . . ) such as 0, 1, 2, . . . , 2M−1, and the Koffset value for index i is Koffset(i), for i>0, it may be defined to have uniformly spaced values, such as Koffset(i)=Koffset(0)+(i−1)*A (A is a positive constant). Of course, the M value may be variable depending on the system configurations, and the A value may also be configured variably depending on the M value. When the maximum value of Koffset excluding the reserved field is Koffset(imax), there may be a relationship of A=(Koffset(imax)−Koffset(0))/imax.

Of course, this is just an example configured with uniform difference values, and in general, it may not be composed of uniform difference values as a whole. For example, depending on the range of the index, different values may be configured as follows (the im value may simply be configured to 2M−1, or typically any other integer value.).

1≤i<im,

Koffset(i)=Koffset(0)+(i−1)*A1

im≤i≤i max,

Koffset(i)=Koffset(im)+(i−im)*A2

A1 and A2 are different constants that are positive, and A1=(Koffset(im)−Koffset(0))/im, A2=(Koffset(imax)−Koffset(im))/(imax−im).

Afterwards, the base station transmits the index to the terminal through MAC CE in slot n, and the terminal may transmit the second signal by applying the Koffset indicated in slot n+k. According to an embodiment of the disclosure, the value of k may be configured or determined according to the subcarrier spacing.

Terminals that support a non-terrestrial network (NTN) may also operate in a terrestrial network (TN). When the wireless access method operating in the terrestrial network (e.g., 3GPP NR) and the wireless access method operating in the satellite network (e.g., 3GPP LTE NB-IoT) are different, the terminal may operate by turning on only one wireless access method because it is impossible to turn on heterogeneous wireless access methods at the same time or because turning them on at the same time is disadvantageous in terms of power consumption. Turning on a wireless access may refer to running at least one of a chip or hardware device or software device that supports the wireless access. In this situation, the terminal may need a method to determine whether the network to access is NTN or TN.

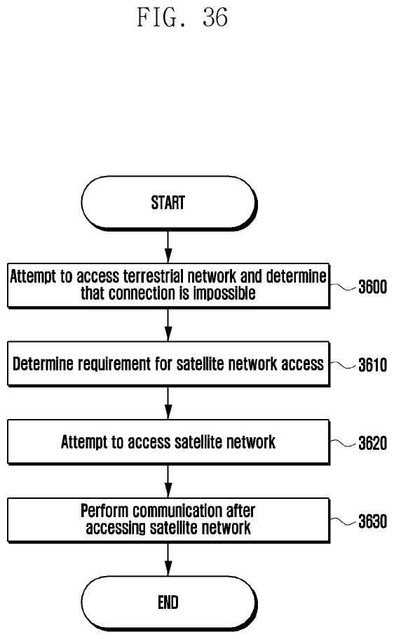

FIG. 36 illustrates a flowchart for a terminal to access a satellite network according to an embodiment of the present disclosure.

In operation 3600, the terminal may attempt to access the terrestrial network, but determine that access to the terrestrial network is impossible. For example, it may be assumed that the terminal preferentially uses a wireless access method related to the terrestrial network. In this situation, when the synchronization signal and/or reference signal transmitted from the terrestrial network is not searched, the terminal may turn off the wireless access method for the terrestrial network and attempt to access the wireless access method for the satellite network.

In operation 3610, the terminal may determine the requirements for satellite network access. For example, the terminal may decide whether to use a wireless access method for the satellite network, based on information related to the requirements for satellite network access.

As an example, in a situation where the terminal has hardware capable of receiving GPS signals, the wireless access method for the satellite network may be turned on only when the GPS signal is captured, and the wireless access method for the satellite network may not be turned on when the GPS signal is not captured. For example, the terminal may determine that the GPS signal is captured only when the terminal's GPS signal reception strength is a certain threshold or higher and/or it is possible to determine the location information of the terminal within a certain error range through the GPS signal.

In another example, the terminal user may independently decide whether to use the wireless access method for the satellite network through the terminal, and the condition(s) for activating the terminal so that the terminal user may decide whether to use a wireless access method for the satellite network may include a case where a terrestrial network signal for the terminal is not obtained and/or a GPS signal is obtained. If the condition(s) are not satisfied, it may be impossible for the terminal user to turn on the wireless access method for the satellite network.

When the wireless access method for the satellite network is turned on, in operation 3620, the terminal may access the satellite network, and when the terminal completes the initial access and receives related high-level information from the satellite network, the terminal may transmit and receive control and data information to the satellite in operation 3630.

Although the above explanation was for a case where the wireless access method for the terrestrial network and the wireless access method for the satellite network are different, there may be situations where the wireless access method for the terrestrial network and the satellite network are the same. In this case, the operations and condition determination described above may not be necessary.

One method to distinguish between the terrestrial network and the satellite network may be to determine whether satellite-related information is included through system information (or system information block; may be referred to as SIB) received by the terminal. Examples of the satellite-related information may include satellite location and speed information and/or the effective time of the satellite information. When the satellite-related information is not included in the system information, the terminal may determine that that the wireless access method for the terrestrial network is used. A base station or a base station connected to a ground station may distinguish whether the terminal accessing the network is a terminal accessed the terrestrial network or a terminal accessed the satellite network through at least one of time resources, frequency resources, code, preamble, or sequence through which the terminal performs initial access. For example, when terminal A performs the initial access through resource 1 and terminal B performs the initial access through resource 2, the base station may determine that the terminal A performed initial access through the terrestrial network and the terminal B performed initial access through the satellite network. In this case, the base station may distinguish in advance between initial access resources for the terrestrial network and initial access resources for the satellite network. Additionally, the base station may distinguish between terminals with different capabilities in a similar manner as above, even if the terminals access the same satellite network.

The terminal may perform initial access to access a satellite network or a terrestrial network.

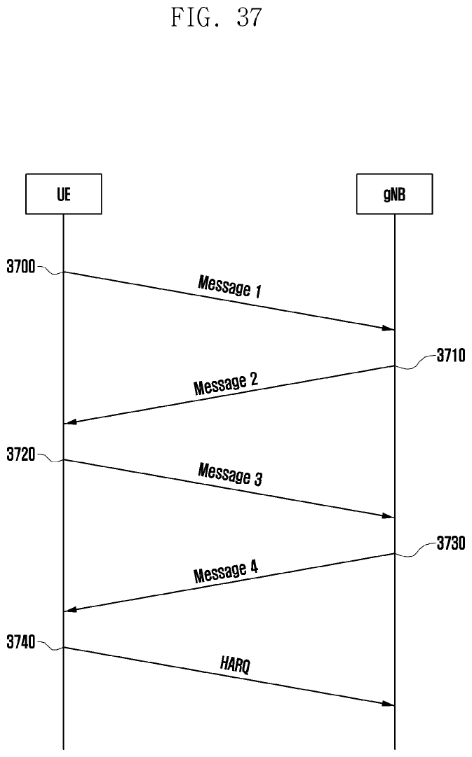

FIG. 37 illustrates an initial access process according to an embodiment of the present disclosure.

In operation 3700, the terminal may determine resource information for transmitting message 1 (or physical random access channel (PRACH)), based on system information received from the base station or satellite before performing initial access and transmit message 1 from the resource.

In operation 3710, the terminal may receive message 2 (or random access response) from the base station or satellite. Specifically, the terminal may receive DCI scrambled with random access (RA)-RNTI from the base station or satellite through PDCCH, and receive message 2 from the PDSCH resource indicated through the DCI.

In operation 3720, the terminal may transmit message 3 to the base station or satellite through PUSCH using the resources indicated through the information included in message 2.

In operation 3730, the base station or satellite may transmit message 4 to the terminal through PDSCH, and the PDSCH may be scheduled through DCI scrambled by temporary cell (TC)-RNTI in the PDCCH. Alternatively, the corresponding PDSCH may be scheduled through DCI scrambled with cell (C)-RNTI in the PDCCH. In addition, a PUCCH resource containing HARQ-ACK information for reporting to the base station or satellite whether demodulation/decoding of the corresponding PDSCH was successful may also be indicated through the DCI.

In operation 3740, the terminal may transmit HARQ-ACK information about whether demodulation/decoding of the PDSCH is successful to the base station or satellite using the PUCCH resource indicated through the DCI.

One of the main characteristics of the satellite network compared to the terrestrial network is that the distance between the transmitting and receiving ends is very long, which means that the reception strength of the signal transmitted by the transmitting end at the receiving end is likely to be very low. Therefore, in the case of the satellite network, a technology to increase the reception strength through repeated transmission of the same information may be needed. In general, the transmission power of the terminal is much lower than that of the satellite, so the reception strength is likely to be much lower from the perspective of the uplink than the downlink. Therefore, a method is needed to support the repeated PUCCH transmission including the HARQ-ACK information for PDSCH that contains message 4 information. To support the PUCCH repeated transmission, at least one or a combination of the following methods may be considered.
Method 7-1: information related to the PUCCH repeated transmission may be transmitted through a higher layer signal (e.g., RRC message), and the terminal may perform the PUCCH repeated transmission including HARQ-ACK information for PDSCH that contains message 4 information.

The information related to the PUCCH repeated transmission may be transferred to terminals performing the initial access in various forms. For example, the information related to the PUCCH repeated transmission may be transferred by being included in a higher layer signal group or message containing NTN-related information. Additionally, information on the single number or multiple numbers for repeated transmissions may be transferred to the terminal. For example, when a single element of information for repeated transmissions is transferred and the corresponding value is 4, the terminal may perform the PUCCH repeated transmission over 4 slots, including HARQ-ACK information for the PDSCH that contains message 4 information. In this case, the repeatedly transmitted PUCCHs may have the same start symbol and the same symbol length for each slot. In this case, the PUCCH format to which repeated transmission is applied may be applicable only to specific PUCCH formats. For example, the terminal may perform repeated transmission only on PUCCH format 1, and the terminal may perform single transmission on PUCCH format 0 even when the repeated transmission value is transferred as a higher layer signal.

For another example, when multiple elements of information for repeated transmissions are transferred through the higher layer signal and the corresponding values are {1, 2, 4, 8}, one of the plurality of repeated transmission numbers may be determined according to the specific value of a field included in the DCI. This DCI schedules the PUCCH including the HARQ-ACK information for the PDSCH that contains message 4 information. For example, [Table 29] is an example of fields included in the DCI format according to an embodiment. This DCI format schedules the PUCCH including the HARQ-ACK information for the PDSCH that contains message 4 information. In this case, the number of repeated transmissions may be additionally informed through at least one field. For example, in [Table 29], one value among {1, 2, 4, 8} may be indicated to the terminal by using 2 most significant bits (MSBs) of the 3-bit PUCCH resource indicator. The information provided by the existing 3-bit PUCCH resource indicator may be maintained, and additional repeated transmission information may be indicated. For example, the number of PUCCH repeated transmissions may be added and configured for each index in the PUCCH resource information in Table 31 described later. Alternatively, a new table including the number of PUCCH repeated transmissions, such as the PUCCH resource information in Table 31, may be configured as a higher layer signal.

```
TABLE 29
  DCI format for scheduling message 4 PDSCH and corresponding HARQ-
ACK PUCCH
  Identifier for DCI formats - 1 bit
  Frequency domain resource assignment
  Time domain resource assignment - 4 bits
  VRB-to-PRB mapping - 1 bit
  Modulation and coding scheme - 5 bits
  New data indicator - 1 bit
  Redundancy version - 2 bits
  HARQ process number - 4 bits
  Downlink assignment index - 2 bits, reserved
  TPC command for scheduled PUCCH - 2 bits
  PUCCH resource indicator - 3 bits
```

According to an embodiment of the disclosure, the terminal may receive higher layer signal information related to the repeated transmission of the PUCCH including the HARQ-ACK information for the PDSCH that contains message 4 information only in the satellite network. For example, when information related to the repeated transmission of PUCCH including HARQ-ACK information for PDSCH that contains message 4 information is not configured as the higher layer signal, the terminal may determine that the terrestrial network is used. Alternatively, the higher layer signal information related to the PUCCH repeated transmission including the HARQ-ACK information for PDSCH that contains message 4 information may be applied equally regardless of satellite network and terrestrial network.

Even if a terminal is accessed a satellite network, there may be terminals that may perform the PUCCH repeated transmission, while there may be terminals that cannot perform repeated PUCCH transmission. Therefore, the base station or satellite may need to distinguish these terminals in advance. For example, when the base station or satellite transmits a higher layer signal containing information about whether to repeatedly transmit the PUCCH containing the HARQ-ACK information for the PDSCH containing message 4 information, information allocating separate message 1 resources (e.g., at least one of time resources, frequency resources, codes, preambles, or sequences) for terminals that receive the corresponding information and attempt to perform the repeated PUCCH transmission may be additionally included in the higher layer signal. Through this, the base station or satellite may determine that the terminals that have performed message 1 access through the separate message 1 resource are terminals that may perform the PUCCH repeated transmission including the HARQ-ACK information for PDSCH that contains message 4 information. Alternatively, when message 3 is transmitted through PUSCH, the message 3 may include information indicating whether the terminal is capable of performing the PUCCH repeated transmission including the HARQ-ACK information for the PDSCH that contains message 4.
Method 7-2: the information related to the PUCCH repeated transmission may be transferred through the higher layer signal and the repeated transmission field in DCI, and the terminal may perform the repeated transmission of PUCCH including the HARQ-ACK information for the PDSCH that contains message 4 information.

For example, when the terminal receives information that the repeated transmission of a PUCCH including the HARQ-ACK information for a PDSCH that contains message 4 information is performed through the higher layer signal, the terminal may determine the DCI format for scheduling the PDSCH containing message 4 information and the PUCCH containing HARQ-ACK information therefor as illustrated in Table 30. Compared to Table 29, if the PUCCH resource indicator consists of 3 bits in Table 29, a 1-bit PUCCH resource indicator and a 2-bit PUCCH repetition factor may be included in Table 30.

When there is no separate higher layer signal, the 2-bit PUCCH resource factor may indicate one value among the PUCCH repetition number of {1,2,4,8}. Alternatively, when separate information related to the number of PUCCH repeated transmissions is configured through the higher layer signal, the PUCCH resource factor may be determined according to the information. For example, information related to the number of PUCCH repeated transmissions is transmitted through the higher layer signal, such as {first repeated transmission value, second repeated transmission value, third repeated transmission value, fourth repeated transmission value}, at least one of the four values configured as the higher layer signal may be indicated to the terminal by the 2-bit PUCCH repetition factor in the corresponding DCI format. The method is only an example, and the size of the PUCCH resource factor may be 1 bit or 3 bits. In this case, a total of 2 or 8 repetitive transmission values may be indicated, respectively.

```
TABLE 30
  DCI format for scheduling message 4 PDSCH and corresponding HARQ-ACK
PUCCH
  Identifier for DCI formats - 1 bit
  Frequency domain resource assignment
  Time domain resource assignment - 4 bits
  VRB-to-PRB mapping - 1 bit
  Modulation and coding scheme - 5 bits
  New data indicator - 1 bit
  Redundancy version - 2 bits
  HARQ process number - 4 bits
  Downlink assignment index - 2 bits, reserved
  TPC command for scheduled PUCCH - 2 bits
  PUCCH resource indicator - 1 bits
  PUCCH repetition factor - 2 bits
```

Table 31 below describes the PUCCH resource and format mapped to the PUCCH resource indicator in the DCI format composed of Table 29. In addition to the 3-bit information of the PUCCH resource indicator, one of the 16 PUCCH indexes in Table 31 may be indicated to the terminal by additionally using the CCE index information in the PDCCH region in which the DCI was received.

In Table 30, because there is a 1-bit PUCCH resource indicator, the terminal may additionally use the CCE index information in the PDCCH region in which the DCI was received to indicate one of the four PUCCH Indexes in Table 31 to the terminal. Unlike TN, in NTN, the distance between the transmitter and receiver is very long, so when transmitting PUCCH, it may be advantageous to transmit PUCCH including as many symbols as possible within the slot. Therefore, the four PUCCH indexes may correspond to indexes {12, 13, 14, 15} in Table 31. That is, one value among indexes {12, 13, 14, 15} in Table 31 may be indicated to the terminal through the 1-bit PUCCH resource indicator and CCE index information. This is only an example, and other combinations other than indexes {12, 13, 14, 15} may be selected, or which combination of the 16 Indexes may be determined through the upper layer signal. In this case, when determining the format of the DCI that the terminal searches for to receive the message 4 PDSCH, different DCI formats may be determined depending on the TN and NTN. For example, the terminal may determine the format of the DCI that the terminal searches for as the DCI format in Table 29 when operating in TN, and determine as the DCI format in Table 30 when operating as NTN.

TABLE 31

| | | | | PRB | |
|---|---|---|---|---|---|
| | PUCCH | First | Number of | offset | Set of initial |
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0,6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}┘ | {0, 3, 6, 9} |

As another method, the base station or satellite may use a downlink assignment index consisting of 2 bits to indicate to the terminal one value among the values {1, 2, 4, 8} through which PUCCH is repeatedly transmitted. The reason to consider the downlink assignment index is because it is a field that is not used in DCI, which schedules message 4 in the terrestrial network. Alternatively, the base station or satellite may use 2 bits of the 4-bit HARQ process number to indicate to the terminal one value among the repeatedly transmitted PUCCH values {1, 2, 4, 8}, and indicate one of the information in HARQ process numbers 1 to 4 with only the remaining 2 bits of information. The reason for considering the HARQ process number is that when scheduling message 4 in the terrestrial network, there is no need for the terminal to operate a large number of HARQ processes. Alternatively, the base station or satellite may use 2 bits of the 5-bit MCS information to indicate to the terminal one value among the repeatedly transmitted PUCCH values {1, 2, 4, 8}, and indicate one of the information in MCS indexes 1 to 8 with only the remaining 3 bits of information. The reason for considering MCS is that when scheduling message 4 in a terrestrial network, unlike TN, NTN basically has a very low signal-to-noise ratio at the receiving end, so MCS with low code rate and modulation order is likely to be selected. The above descriptions may be applied in situations where the terminal is determined to be operating as NTN, and may be interpreted as existing fields in TN. The above descriptions are only examples and specific bit fields in Table 29 or Table 30 may be used.
Method 7-3: when the terminal performs repeated transmission of message 3, the terminal may repeatedly transmit the PUCCH including the HARQ-ACK information for message 4 PDSCH. Before repeatedly transmitting the message 3 PUSCH, the terminal may inform the base station or satellite whether to perform repeated transmission of message 3 PUSCH through PRACH resource selection for message 1 transmission. If the terminal requests the base station or satellite to perform the repeated transmission of message 3 PUSCH by selecting a specific PRACH resource for message 1 transmission, the base station or satellite may inform whether message 3 PUSCH may be repeatedly transmitted by using 2 bits of MSB information in the MCS field in message 2 information.

Table 32 is an example of a method for indicating whether message 3 PUSCH is repeatedly transmitted or the number of repeated transmissions using 2 bits of MSB information in the MCS field. For example, when there is a separate higher layer signal configuration for whether message 3 PUSCH is repeatedly transmitted or the number of repeated transmissions, the 2-bit MSB of the MCS field may indicate one value among the higher layer signal information configured for each codepoint. If there is no separate higher layer signal configuration for repeated transmission of message 3 PUSCH or the number of repeated transmissions, the terminal may apply the default value, and the 2-bit MSB of the MCS field may indicate one of the values 1, 2, 3, and 4 as an example in Table 32.

TABLE 32

| numberOfMsg3Repetitions | | numberOfMsg3Repetitions | |
|---|---|---|---|
| is configured | | is not configured | |
| Codepoint | K | Codepoint | K |
| 00 | First value of | 00 | 1 |
| | numberOfMsg3Repetitions | | |
| 01 | Second value of | 01 | 2 |
| | numberOfMsg3Repetitions | | |
| 10 | Third value of | 10 | 3 |
| | numberOfMsg3Repetitions | | |
| 11 | Fourth value of | 11 | 4 |
| | numberOfMsg3Repetitions | | |

Similarly, as illustrated in the example in Table 32, the terminal may indicate the number of repeated transmissions of PUCCH including the HARQ-ACK information for message 4 PDSCH according to the code point indicated through the 2-bit MSB of the MCS field. For example, when the codepoint is 00, the number of repeated PUCCH transmissions may be 1, when the codepoint is 01, the number of repeated PUCCH transmissions is 2, when the codepoint may be 10, the number of repeated PUCCH transmissions may be 4, and when the codepoint is 11, the number of PUCCH repeated transmissions may be configured to 8. This method may be applied only in cases where there is no higher layer signal indicating the PUCCH repeated transmission. If there is a higher layer signal related to the PUCCH repeated transmission, the terminal may apply the number of PUCCH repeated transmissions configured as the higher layer signal for each codepoint. Alternatively, if the number of repeated transmissions of message 3 PUSCH is 2, 4, or 8 or more with a separate upper layer signal configuration, the number of PUCCH repeated transmissions including the HARQ-ACK information for message 4 PDSCH may be selected as at least one of 2, 4, or 8.
Method 7-4: when the terminal performs repeated transmission of message 1 or repeated transmission of message 3, the PUCCH including the HARQ-ACK information for message 4 PDSCH may be repeatedly transmitted. The higher layer signal configurations related to repeated transmission of message 1 and information related to repeated transmission of message 3 may be transmitted as separate higher layer signals or may be transmitted as the same higher layer signal.

When the terminal performs at least one of the repeated transmission of message 1 and the repeated transmission of message 3, the terminal may perform the PUCCH repeated transmission including the HARQ-ACK information for message 4 PDSCH, and at least one or a combination of the methods described in Methods 7-1 to 7-3 above may be applied as the method for the PUCCH repeated transmission including the HARQ-ACK information for message 4 PDSCH. For example, if the terminal does not perform both the repeated transmission of message 1 and the repeated transmission of message 3, the terminal may not perform the PUCCH repeated transmission including the HARQ-ACK information for message 4 PDSCH. Alternatively, the terminal may determine whether to repeatedly transmit PUCCH including the HARQ-ACK information for message 4 PDSCH depending on the resource (e.g., time resource, frequency resource, code, preamble, or sequence) area selected when transmitting message 1.

Alternatively, when the terminal performs both the repeated transmission of message 1 and the repeated transmission of message 3, the terminal may perform the PUCCH repeated transmission including the HARQ-ACK information for message 4 PDSCH, and at least one or a combination of the methods described in Methods 7-1 to 7-3 above may be applied as a method for the PUCCH repeated transmission including the HARQ-ACK information for message 4 PDSCH. For example, when the terminal does not perform both the repeated transmission of message 1 and the repeated transmission of message 3 or only one, the terminal may not perform the PUCCH repeated transmission including the HARQ-ACK information for message 4 PDSCH.

Alternatively, when the terminal performs the repeated transmission of message 1 or the repeated transmission of message 3, the number of repeated transmissions of PUCCH including the HARQ-ACK information for message 4 PDSCH may depend on whether only the repeated transmission of message 1 is performed, only the repeated transmission of message 3 is performed, or both the repeated transmission of message 1 and the repeated transmission of message 3 are performed. For example, when only the repeated transmission of message 1 is performed, the number of the repeated transmissions of PUCCH including the HARQ-ACK information for message 4 PDSCH may be 2, when only the repeated transmission of message 1 is performed, the number of the repeated transmissions of PUCCH including the HARQ-ACK information for message 4 PDSCH may be 4, and when both the repeated transmission of message 1 and the repeated transmission of message 3 are performed, the number of the repeated transmissions of PUCCH including the HARQ-ACK information for message 4 PDSCH may be 8. The above PUCCH repetition transmission number values are only examples, and the PUCCH repetition transmission number values may be different, and some values may be the same. Additionally, the values of the number of PUCCH repeated transmissions may be configured in advance by a higher layer signal, and when there is no higher layer signal, default values (e.g., {1, 2, 4, 8}) may be used.

An embodiment describes a method for supporting frequency hopping when the terminal repeatedly transmits PUCCH including the HARQ-ACK information for message 4 PDSCH. When a terminal operating in a satellite network is configured to perform frequency hopping for the PUCCH repeated transmission between slots according to higher layer signal configurations, the terminal may perform frequency hopping per slot. When the slot indicated to the terminal for the first repetition of PUCCH transmission is “slot 0” and the terminal transmits PUCCH in a slot equal to the number of PUCCH repetition transmissions, each subsequent slot may be counted in the number of PUCCH repetition transmissions regardless of whether the terminal actually transmits PUCCH in that slot. In this case, the terminal may transmit the PUCCH in the even numbered slot including “slot 0” among the plurality of slots for repeated PUCCH transmission, starting from the first PRB configured by the first higher layer signal information, and transmit PUCCH in an odd-numbered slot among a plurality of slots for repeated PUCCH transmission, starting from the second PRB provided by the second higher layer signal information.

The higher layer signal information may be terminal common information or terminal specific information, and when the higher layer signal information is not configured for the terminal, a default value may be used.

Alternatively, when the first higher layer signal information and the second higher layer signal information include a plurality of PRB values, the base station or satellite may indicate one PRB value to the terminal through an L1 signal (e.g., DCI).

Alternatively, only frequency start information (A_hop) for PUCCH resources transmitted in the even (or odd) slot may be provided to the terminal through the higher layer signal or L1 signal, and frequency start information for PUCCH resources transmitted in slots with odd (or even) numbers may have a relationship of (A_hop+X) mod (UL_BWP). Here, X may mean the offset value representing the frequency difference from A_hop, and UL_BWP may mean the size of the uplink BWP (e.g., the number of PRBs) through which the PUCCH including HARQ-ACK information for the PDSCH that contains message 4 information is transmitted. The values of X and UL_BWP may be transferred separately or together to the terminal as separate upper layer signals. Alternatively, when there is no separate higher layer signal for the values of X and UL_BWP, default values may be applied. For example, when there is no separate higher layer signal for the X, X may have one of the following values: floor(UL_BWP/2), ceiling(UL_BWP/2), or round (UL_BWP/2).

When the terminal performs repeated transmission of PUCCH including the HARQ-ACK information for message 4 PDSCH, the frequency hopping information may be transferred to the terminal using the higher layer signal and/or L1 signal.

Specifically, in a higher layer signal group or message containing satellite network information, the frequency hopping information applied during repeated PUCCH transmission including the HARQ-ACK information for message 4 PDSCH, may be included. Alternatively, in the higher layer signal group or message containing satellite network information, it may be indicated whether the frequency hopping information applied during the PUCCH repeated transmission including the HARQ-ACK information for message 4 PDSCH is included in the DCI format for scheduling PUCCH including HARQ-ACK information for message 4 PDSCH. In this case, a new field for indicating frequency hopping information may be added in the DCI format of Table 29 or Table 30, or frequency hopping information may be indirectly indicated by utilizing a field in the existing DCI format. For example, the frequency hopping information may be indirectly indicated depending on whether the HARQ process number in the existing DCI format is even or odd. Alternatively, 1 bit may be used to indicate frequency hopping information in fields that are not used in terrestrial networks, such as downlink assignment index (DAI). Alternatively, in fields that are not used in terrestrial networks, such as DAI, 1 bit may be used to indicate frequency hopping information, and the remaining 1 bit may be used to indicate whether to repeatedly transmit PUCCH including the HARQ-ACK information for message 4 PDSCH or to indicate the number of repeated transmissions, similar to what was explained in the embodiment described above.

Without configuring higher layer signal information, the terminal may determine that the relevant DCI format is configured as in the above-described example when receiving the higher layer signal information related to the satellite network (e.g., satellite orbit or speed information, etc.). Alternatively, when frequency hopping information is provided only as a higher layer signal and repeated PUCCH transmission including the HARQ-ACK information for message 4 PDSCH is scheduled, the terminal may assume that frequency hopping is always operated.

As another embodiment, the terminal may or may not perform frequency hopping when repeatedly transmitting PUCCH including the HARQ-ACK information for message 4 PDSCH. For example, when transmitting only one PUCCH including the HARQ-ACK information for message 4 PDSCH, the terminal may perform intra-slot frequency hopping, and when transmitting the PUCCH including the HARQ-ACK information for message 4 PDSCH repeatedly two or more times, the terminal may not perform frequency hopping. As another example, when transmitting only one PUCCH including the HARQ-ACK information for message 4 PDSCH, the terminal may perform intra-slot frequency hopping, and when transmitting PUCCH including the HARQ-ACK information for message 4 PDSCH repeatedly two or more times, the terminal may perform inter-slot frequency hopping. As further another example, when transmitting only one PUCCH including the HARQ-ACK information for message 4 PDSCH, the terminal may perform intra-slot frequency hopping, and even when transmitting PUCCH including the HARQ-ACK information for message 4 PDSCH repeatedly two or more times, the terminal may perform the intra-slot frequency hopping. In other words, the terminal may perform the intra-slot frequency hopping regardless of the number of repetition times of the PUCCH including the HARQ-ACK information for message 4 PDSCH. As further another example, it may be determined in advance whether to perform intra-slot frequency hopping, to perform inter-slot frequency hopping, or not to perform frequency hopping depending on the number of slots through which the PUCCH including the HARQ-ACK information for message 4 PDSCH is transmitted. Alternatively, a frequency hopping method according to the number of transmissions may be configured by the higher signal separately provided from the base station.

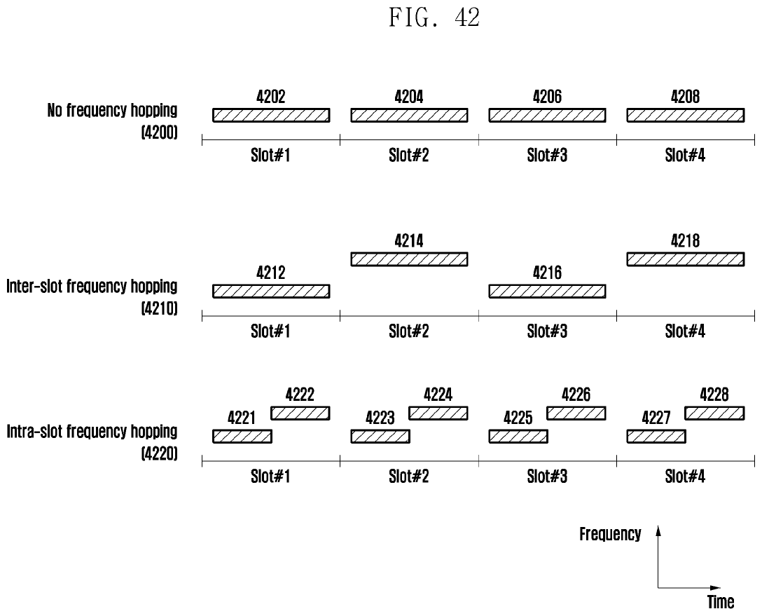

FIG. 42 illustrates various frequency hopping methods according to an embodiment of the present disclosure.

Referring to FIG. 42, for example, not performing frequency hopping (4200) may mean that the frequency resources of the PUCCH used for repeated transmission are the same. For example, when PUCCHs 4202, 4204, 4206, and 4208 are repeatedly transmitted over four slots (slots #1 to #4), all repeated PUCCHs may be transmitted through the same frequency resource.

As an example, performing the inter-slot frequency hopping (4210) may mean that PUCCHs transmitted for each slot are transmitted through different frequency resources. For example, when PUCCH is repeatedly transmitted in four different slots, PUCCHs 4212 and 4216 transmitted in slots #1 and #3 may be transmitted and received through the first frequency resource, and PUCCHs 4214 and 4218 transmitted in slots #2 and #4 may be transmitted and received through the second frequency resource. In other words, the inter-slot frequency hopping may mean that PUCCHs are repeatedly transmitted through different frequencies on a slot-by-slot basis. Therefore, the inter-slot frequency hopping may be used when the number of PUCCH repeated transmissions is two or more.

As an example, performing the intra-slot frequency hopping (4220) may mean that PUCCHs transmitted within one slot are transmitted through different frequency resources. For example, when transmitting PUCCH resources consisting of multiple (e.g., 14) symbols, the first X (e.g., 7) symbols may be transmitted and received through the first frequency resource (or the first hop), and the remaining Y (e.g., 7) symbols may be transmitted and received through the second frequency resource (or second hop). For example, PUCCH 4221 and 4222 transmitted in slot #1 may be transmitted through different frequency bands. If the time resource of the PUCCH transmitted by the terminal has an even number of symbols, the PUCCH may be divided into the same number of symbols and intra-slot hopping may be performed. Alternatively, if the time resource of the PUCCH transmitted by the terminal has an odd number of symbols, one of the two PUCCHs divided by the intra-slot frequency hopping within one slot may have one more symbol than the other PUCCH. However, the above description is only an example, and when the time resource of the PUCCH transmitted by the terminal has an even number of symbols, the PUCCH may be divided into different numbers of symbols and intra-slot hopping may be performed, and when the time resource of the PUCCH transmitted by the terminal has an odd number of symbols, one PUCCH may have two or more symbols more than another PUCCH. In FIG. 42, when the PUCCH is repeatedly transmitted over four slots, the first PUCCHs 4221, 4223, 4225, and 4227 may be transmitted and received through the first frequency resource, and the second PUCCHs 4222, 4224, 4226, and 4228 may be transmitted and received through the second frequency resource.

Although the above description is limited to PUCCH transmission including HARQ-ACK information for message 4 PDSCH, the disclosure is not limited to thereto, and the description may also be applied to the default PUCCH transmission-related operation that operates after the terminal initial accesses and before receiving separate PUCCH-related higher signal configuration information. Alternatively, the description may also be applied to operations related to PUCCH transmission provided by the terminal through control information received through the terminal common control channel.

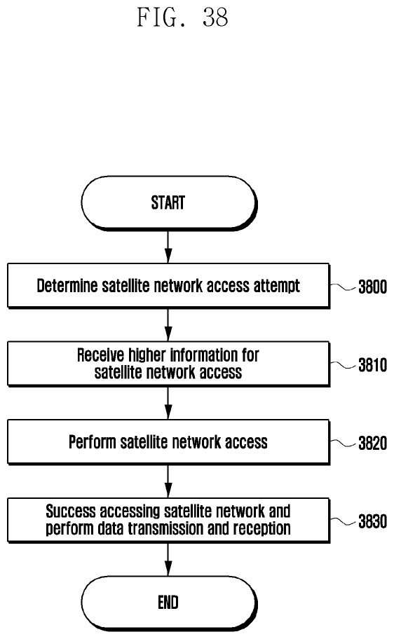

FIG. 38 illustrates a flowchart illustrating an operation in which a terminal performs repeated PUCCH transmission including HARQ-ACK information for message 4 PDSCH or frequency hopping according to an embodiment of the present disclosure.

In operation 3800, the terminal may determine whether to attempt to access the satellite network. When the terminal decides to access the satellite network, in operation 3810, the terminal may receive higher level information for satellite network access from the base station or satellite. Operation 3810 may be applied only when the satellite network and the terrestrial network use different wireless access technologies according to the sixth embodiment described above. Operation 3810 may be omitted depending on the terminal. In operation 3820, the terminal may apply higher signal information for satellite network access to perform satellite network access according to the information. Operation 3810 may perform initial access according to at least one of the methods described in the embodiments described above, or some or all combinations thereof. After the initial access is successfully performed, in operation 3830, the terminal may determine that it has successfully accessed the satellite network and transmit and receive control and data information for data transmission and reception with the base station or satellite.

In the above, for convenience of explanation, the embodiments of the disclosure have been separately described, but it is also possible to combine at least two or more embodiments because each embodiment includes operations related to each other. In addition, the methods of each embodiment are not mutually exclusive, and it is possible for one or more methods to be performed in combination.

The transmission and reception methods of the base station, satellite, and terminal or transmitter and receiver to perform the above embodiments of the disclosure are illustrated, and to perform these methods, the receivers, processors, transmitters and receivers of the base station, satellite, and terminal may each operate according to the embodiment.

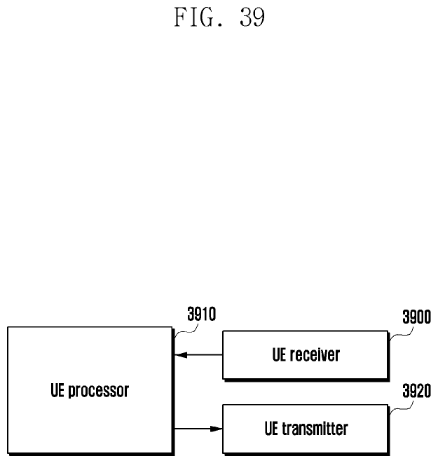

FIG. 39 illustrates the internal structure of a terminal according to an embodiment of the present disclosure.

As illustrated in FIG. 39, the terminal of the disclosure may include a terminal receiver 3900, a terminal transmitter 3920, and a terminal processor 3910. Of course, it is not limited to the above example, and the terminal may include more or fewer configurations. In addition, the terminal receiver 3900, the terminal transmitter 3920, and the terminal processor 3910 may be composed of one chip.

The terminal receiver 3900 and the terminal transmitter 3920 may be collectively referred to as the transceiver in the embodiment of the disclosure. The transceiver may transmit and receive signals to and from a base station or satellite. Signals transmitted and received by the terminal may include control information and data. To this end, the transceiver may be composed of an RF transmitter that up-converts and amplifies the frequency of the transmitted signal, and an RF receiver that amplifies the received signal with low noise and down-converts the frequency. Of course, the components of the transmitter and receiver are not limited to the RF transmitter and RF receiver. In addition, the transceiver may receive a signal through a radio channel and output the signal to the terminal processor 3910, and transmit the signal output from the terminal processor 3910 through the radio channel.

The terminal processor 3910 may control a series of processes so that the terminal may operate according to the embodiment of the disclosure described above. For example, the terminal receiver 3900 may receive signals from a satellite or terrestrial base station and signals from GNSS, and the terminal processor 3910 may transmit and receive signals to and from the base station according to the method described in the disclosure. Afterwards, the terminal transmitter 3920 may transmit a signal by using the determined time point. In the disclosure, the terminal processor 3910 may be defined as a circuit, an application-specific integrated circuit, or at least one processor. Of course, it is not limited to the above examples.

According to an embodiment of the disclosure, the terminal may include a memory (not illustrated). The memory may store programs and data necessary for the operation of the terminal. In addition, the memory may store control information or data included in signals obtained from the terminal. The memory may be composed of storage media such as ROM, RAM, a hard disk, a CD-ROM, and a DVD, or a combination of storage media.

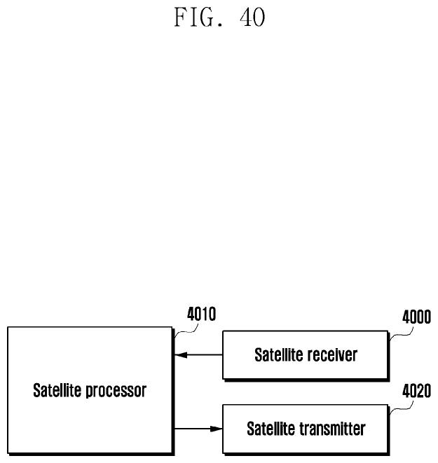

FIG. 40 illustrates the internal structure of a satellite according to an embodiment of the present disclosure.

As illustrated in FIG. 40, the satellite of the disclosure may include a satellite receiver 4000, a satellite transmitter 4020, and a satellite processor 4010. In the above, the receiver, the transmitter, and the processor may include a plurality of units. That is, the satellite may include a receiver and a transmitter for transmitting and receiving signals to and from a terminal, and a receiver and a transmitter for transmitting and receiving signals to and from a base station (and a receiver and a transmitter for transmitting and receiving signals to and from other satellites). Of course, it is not limited to the above example, and the satellite may include more or fewer configurations. In addition, the satellite receiver 4000, the satellite transmitter 4020, and the satellite processor 4010 may be composed of one chip.

The satellite receiver 4000 and the satellite transmitter 4020 may be collectively referred to as the satellite transceiver in the embodiment of the disclosure. The transceiver may transmit and receive signals to and from a terminal and a base station. The signals may include control information and data. To this end, the transceiver may be composed of an RF transmitter that up-converts and amplifies the frequency of the transmitted signal, and an RF receiver that amplifies the received signal with low noise and down-converts the frequency. Of course, the components of the transceiver are not limited to the RF transmitter and RF receiver. In addition, the transceiver may receive a signal through a radio channel and output the signal to the satellite processor 4010, and transmit the signal output from the satellite processor 4010 through the radio channel. The satellite processor 4010 may include a compensator (pre-compensator) for correcting frequency offset or Doppler shift, and may include a device that may track location from GPS or the like. In addition, the satellite processor 4010 may include a frequency shift function that may shift the center frequency of the received signal. The satellite processor 4010 may control a series of processes so that the satellite, base station, and terminal may operate according to the embodiment of the disclosure described above.

For example, the satellite receiver 4000 may receive the PRACH preamble from the terminal, transmit the corresponding RAR back to the terminal, and determine to transmit TA information to the base station. Afterwards, the satellite transmitter 4020 may transmit the corresponding signals at a determined time point. In the disclosure, the satellite processor 4010 may be defined as a circuit, an application-specific integrated circuit, or at least one processor. Of course, it is not limited to the above examples.

According to an embodiment of the disclosure, the satellite may include a memory (not illustrated). The memory may store programs and data necessary for the operation of the satellite. In addition, the memory may store control information or data included in signals obtained from the satellite. The memory may be composed of storage media such as ROM, RAM, a hard disk, a CD-ROM, and a DVD, or a combination of storage media.

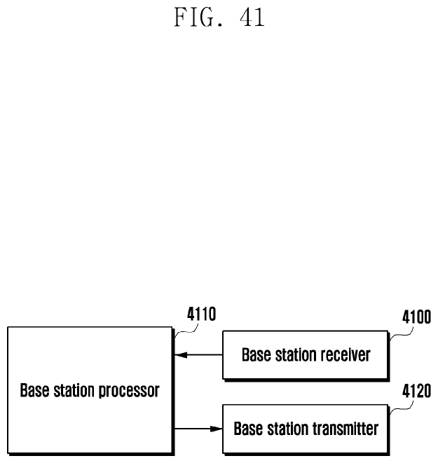

FIG. 41 illustrates the internal structure of a base station according to an embodiment of the present disclosure.

As illustrated in FIG. 41, the base station of the disclosure may include a base station receiver 4100, a base station transmitter 4120, and a base station processor 4110. The base station may be a terrestrial base station or part of a satellite. The base station receiver 4100 and the base station transmitter 4120 may be collectively referred to as the transceiver in the embodiment of the disclosure. The transceiver may transmit and receive signals to and from a terminal. Signals transmitted and received with a terminal, another base station, or a satellite may include control information and data. To this end, the transceiver may be composed of an RF transmitter that up-converts and amplifies the frequency of the transmitted signal, and an RF receiver that amplifies the received signal with low noise and down-converts the frequency. Of course, the components of the transmitter and receiver are not limited to the RF transmitter and RF receiver. In addition, the transceiver may receive a signal through a radio channel and output the signal to the base station processor 4110, and transmit the signal output from the base station processor 4110 through the radio channel. The base station processor 4110 may control a series of processes so that the base station may operate according to the embodiment of the disclosure described above. For example, the base station processor 4110 may transmit RAR including TA information. In the disclosure, the base station processor 4110 may be defined as a circuit, an application-specific integrated circuit, or at least one processor. Of course, it is not limited to the above examples.

According to an embodiment of the disclosure, the base station may include a memory (not illustrated). The memory may store programs and data necessary for the operation of the base station. In addition, the memory may store control information or data included in signals obtained from the base station. The memory may be composed of storage media such as ROM, RAM, a hard disk, a CD-ROM, and a DVD, or a combination of storage media.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. Moreover, other variants of the above embodiments, based on the technical idea of the embodiments, may be implemented in LTE and 5G systems.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information on a set of one or more numbers for a physical uplink control channel (PUCCH) repetition;
receiving, from the base station, downlink control information (DCI) scheduling a physical downlink shared channel (PDSCH);
receiving, from the base station, the PDSCH based on the DCI;
determining a plurality of slots for the PUCCH repetition based on the configuration information in case that the set of one or more numbers comprises a single value or based on the configuration information and the DCI in case that the set of one or more numbers comprises more than one value; and
transmitting, to the base station, a PUCCH including hybrid automatic repeat request-acknowledgement (HARQ-ACK) information for the PDSCH over the determined plurality of slots.

2. The method of claim 1, wherein, in case that the set of one or more numbers comprises more than one value, a downlink assignment index included in the DCI indicates a number of the plurality of slots from among the set of one or more numbers.

3. The method of claim 1, wherein the DCI is scrambled by a temporary cell-radio network temporary identifier (TC-RNTI).

4. The method of claim 1, wherein the PDSCH includes a message 4 in case that a random access procedure is performed with the base station.

5. The method of claim 4, further comprising: before receiving the DCI, transmitting, to the base station, a message 3 during the random access procedure, wherein the message 3 includes information indicating that the terminal supports a repetition of PUCCH with HARQ-ACK information for the message 4.

6. A method performed by a base station in a wireless communication system, the method comprising:
transmitting configuration information on a set of one or more numbers for a physical uplink control channel (PUCCH) repetition;
transmitting, to a terminal, downlink control information (DCI) scheduling a physical downlink shared channel (PDSCH);
transmitting, to the terminal, the PDSCH according to the DCI; and
receiving, from the terminal, a PUCCH including hybrid automatic repeat request-acknowledgement (HARQ-ACK) information for the PDSCH over a plurality of slots for the PUCCH repetition according to the configuration information in case that the set of one or more numbers comprises a single value or according to the configuration information and the DCI in case that the set of one or more numbers comprises more than one value.

7. The method of claim 6, wherein, in case that the set of one or more numbers comprises more than one value, a downlink assignment index included in the DCI indicates a number of the plurality of slots from among the set of one or more numbers.

8. The method of claim 6, wherein the DCI is scrambled by a temporary cell-radio network temporary identifier (TC-RNTI).

9. The method of claim 6, wherein the PDSCH includes a message 4 in case that a random access procedure is performed with the terminal.

10. The method of claim 9, further comprising: before transmitting the DCI, receiving, from the terminal, a message 3 during the random access procedure, wherein the message 3 includes information indicating that the terminal supports a repetition of PUCCH with HARQ-ACK information for the message 4.

11. A terminal in a wireless communication system, the terminal comprising:
a transceiver; and
a controller configured to:
receive, from a base station via the transceiver, configuration information on a set of one or more numbers for a physical uplink control channel (PUCCH) repetition,
receive, from the base station via the transceiver, downlink control information (DCI) scheduling a physical downlink shared channel (PDSCH),
receive, from the base station via the transceiver, the PDSCH based on the DCI,
determine a plurality of slots for the PUCCH repetition based on the configuration information in case that the set of one or more numbers comprises a single value or based on the configuration information and the DCI in case that the set of one or more numbers comprises more than one value, and
transmit, to the base station via the transceiver, a PUCCH including hybrid automatic repeat request-acknowledgement (HARQ-ACK) information for the PDSCH over the determined plurality of slots.

12. The terminal of claim 11, wherein, in case that the set of one or more numbers comprises more than one value, a downlink assignment index included in the DCI indicates a number of the plurality of slots from among the set of one or more numbers.

13. The terminal of claim 11, wherein the DCI is scrambled by a temporary cell-radio network temporary identifier (TC-RNTI).

14. The terminal of claim 11, wherein the PDSCH includes a message 4 in case that a random access procedure is performed with the base station.

15. The terminal of claim 14, wherein the controller is further configured to: before receiving the DCI, transmit, to the base station via the transceiver, a message 3 during the random access procedure, wherein the message 3 includes information indicating that the terminal supports a repetition of PUCCH with HARQ-ACK information for the message 4.

16. Abase station in a wireless communication system, the base station comprising:
a transceiver; and
a controller configured to:
transmit, via the transceiver, configuration information on a set of one or more numbers for a physical uplink control channel (PUCCH) repetition,
transmit, to a terminal via the transceiver, downlink control information (DCI) scheduling a physical downlink shared channel (PDSCH),
transmit, to the terminal via the transceiver, the PDSCH according to the DCI, and
receive, from the terminal via the transceiver, a PUCCH including hybrid automatic repeat request-acknowledgement (HARQ-ACK) information for the PDSCH over a plurality of slots for the PUCCH repetition according to the configuration information in case that the set of one or more numbers comprises a single value or according to the configuration information and the DCI in case that the set of one or more numbers comprises more than one value.

17. The base station of claim 16, wherein, in case that the set of one or more numbers comprises more than one value, a downlink assignment index included in the DCI indicates a number of the plurality of slots from among the set of one or more numbers.

18. The base station of claim 16, wherein the DCI is scrambled by a temporary cell-radio network temporary identifier (TC-RNTI).

19. The base station of claim 16, wherein the PDSCH includes a message 4 in case that a random access procedure is performed with the terminal.

20. The base station of claim 19, wherein the controller is further configured to: before transmitting the DCI, receive, from the terminal via the transceiver, a message 3 during the random access procedure, wherein the message 3 includes information indicating that the terminal supports a repetition of PUCCH with HARQ-ACK information for the message 4.
